(19) United States
(12) Patent Application Publication
(10) Pub. No.: US 2016/0055196 A1
(43) Pub. Date: Feb. 25, 2016

(54) METHODS AND SYSTEMS FOR IMPROVED DOCUMENT COMPARISON

(71) Applicant: CONTEXTUAL SYSTEMS PTY LTD, Victoria (AU)

(72) Inventors: Matt COLLINS, Brighton, Victoria (AU); Amelia CUSS, Brighton, Victoria (AU); Yuri FELDMAN, Brighton, Victoria (AU); Nicholas LAVER, Brighton, Victoria (AU); Daniel MATTHEWS, Brighton, Victoria (AU); Jaiden MISPY, Brighton, Victoria (AU); James PAYOR, Brighton, Victoria (AU); Benjamin STOTT, Brighton, Victoria (AU); Ben TONER, Brighton, Victoria (AU); Niel VAN DER WESTHUIZEN, Brighton, Victoria (AU); Yujin WU, Brighton, Victoria (AU); Dawson XU, Brighton, Victoria (AU)

(21) Appl. No.: 14/784,710

(22) PCT Filed: Apr. 15, 2014
(86) PCT No.: PCT/AU2014/000433

§ 371 Date: Oct. 15, 2015

(30) Foreign Application Priority Data
Apr. 15, 2013 (AU) 2013901300
Sep. 20, 2013 (AU) 2013903635

(51) Int. Cl. G06F 17/30

(52) U.S. Cl. CPC G06F 17/30368; G06F 17/30598; G06F 17/30011; G06F 17/30345; G06F 17/30876

(57) ABSTRACT

A method for placing a document into a document family, the method including the steps of: determining at least one score associated with one or more document families, each score indicating a level of similarity between the document and the associated document family; in response to identifying at least one threshold document family, the or each threshold document family corresponding to a document family with at least one associated score meeting a predefined threshold: placing the document into the, or one of the, threshold document families; in response to identifying that each score fails to meet a predefined threshold: creating a new document family; and placing the document into the new document family.

### FIELD OF THE INVENTION

The invention generally relates to computer implemented methods and systems for the comparison of related documents.

### BACKGROUND TO THE INVENTION

It is common that, when preparing a document, several iterations of the document are produced. Such iterations may have been modified by different parties, for example in the case of a legal document, legal representatives of different parties may take turns at modifying aspects of the document. In another example, a team preparing a tender may take turns at working on a document. There are many other reasons why two (or more) documents may be created which comprise similar parts and dissimilar parts.

One current technique for comparing two documents is to simply produce hard copies of each document, and to have an editor review both to identify parts of each document which are different. Other techniques utilise computers to facilitate comparison of the documents. Microsoft Word, for example, has a compare feature which will produce a composite document showing deletions and additions between two documents. Such current computerised comparison techniques can produce technically correct indications of changes which nonetheless are non-ideal for use by a human reader.

Also, current methods for collaborative document construction utilise change tracking, such as track changes of Microsoft Word. However, such mechanisms rely upon users accurately turning on and maintaining correct use of the functionality provided. Furthermore, current systems cannot accurately reconstruct edit histories when the change tracking functionality has not been used, or has not consistently been used.

Also, it is known to provide a comparison between two documents. Typically, such a comparison involves a side-by-side display, and will allow a user to move one document and have the other document move in turn. Changes between the two documents are typically displayed using mark-up in the form of different coloured regions, strike-outs, and underlined regions. Current systems require that an analysis of the two documents is performed (sometimes referred to as diffing), before being able to show the comparison. For multiple version of a document, diffing must be performed on each possible pair of documents in order to provide a useful comparison. Further, it is resource and time consuming to quickly move between corresponding portions of each document.

### SUMMARY OF THE INVENTION

Embodiments of the present invention aim to provide a ‘diff’ of two documents. In the present context, a diff is a document or other record with information allowing for the construction, display, and/or recording of differences between a first document and a second document. The diff will, in general and unless otherwise stated, indicate changes that have occurred from the first document to the second document, and therefore the term ‘first document’ is used herein interchangeably with ‘original document’ and the term ‘second document’ is used herein interchangeably with ‘new document’. Furthermore, it is envisaged that in at least some embodiments the first document and second document will be presented simultaneously on a display or printout such that the first document and second document appear next to one another, and therefore the term ‘first document’ is also used herein interchangeably with ‘left document’ and the term ‘second document’ is also used herein interchangeably with ‘right document’, though it is understood that any relative positioning of the documents can be used. It is understood that such labels for each document are for convenience, and it may be that the ‘original document’ and ‘new document’ do not in fact have a sequential relationship.

The diff can correspond to a new document in the same format as the first document and second document (for example, the diff, first document, and second document can be rich text format files). The diff can also, or instead, correspond to a plain-text, binary, or any other suitable format file.

As used herein, a ‘text region’ is a portion of the text of a document which is selected based on criteria. In some embodiments, ‘text regions’ can be paragraphs, sentences, words, and/or individual characters. In other embodiments, a ‘text region’ may be determined based on a predefined rule, for example strings of characters between common words, for example the word ‘the’. A ‘text region’ will contain text from one of the documents in a sequential manner, such that the order of the characters is retained.

As a diff is a comparison between two documents (or portions of two documents), there will be text regions in each document which are identical, and others which are not. Where there is a text region in the first document that is identical to, and associated with, a text region in the second document, this text region is termed a ‘matching text region’. The opposite situation, where there is a text region in the first document which is non-identical to a text region in the second document (or, it is identical to a text region in the second document, but not associated with it as explained herein), the text region is termed a ‘non-matching text region’.

The terms ‘matching text’ and ‘non-matching text’ refer to matching and non-matching characters.

It is possible to have divisions of text regions. As an illustrative example, a text region may comprise one or more sentences. A natural division of a sentence is a word, and therefore for text regions which correspond to sentence(s), a ‘text sub-region’ comprises one or more words. In this way, one text region can comprise one or more text sub-regions. Similar to above, a text sub-regions can be matching or non-matching.

When a document is modified, it is entirely feasible that portions of the document will not be deleted or added to, but instead moved. This can result in uncertainty when determining which text regions are matching between the two documents. To overcome this, it is, in embodiments, necessary to apply predetermined criteria for deciding which text regions to record as matching text regions. Example rules include determining the combination of text regions which will provide for a maximum number of matching text within the matching text regions, or to maximise the number of individual matching text regions. Text regions which are not included based on the applied rules are considered non-matching text regions.

‘Mark-up text’ corresponds to a particular representation of non-matching regions, where each character is shown as either deleted or inserted, or in some embodiments, moved. A ‘DelIns’ referred to herein corresponds to a portion of a diff indicating a deletion and/or insertion. A ‘DelIns’ can therefore correspond to non-matching text present in one or both documents in a particular location.

Typically, and as used herein, the diff can be represented as a diff data structure, which comprises a plurality of data elements. Each data element is either an equal data element, containing content which is the same in each document (i.e. content corresponding to matching text) or a DelIns data element, containing content which has been removed from the first document and/or content that has been added to the second document (i.e. content corresponding to non-matching text). The data elements of the diff data structure have an associated ordering, such as being arranged in a sequence.

As used herein, a “document family” is a collection of one or more documents, such as: text documents; rich text documents; spreadsheets; presentations (such as those produced using Microsoft Powerpoint); images; email messages; and any other suitable document. For a family of two or more documents, the documents of the family include the property of being modified versions of one another. A “structured document family” generally includes at least one initial document, and possibly one or more further documents corresponding to modifications and/or mergers of other documents within the structured document family, such that all documents within the document family are linked, through modifications, to a least one initial document. It will be understood that documents can be collections of documents, or representations of a collection of documents. An example of the later case is where a document corresponds to the content of a directory of a file system.

According, therefore, to an aspect of the present invention, there is provided a method for identifying differences between a first document and a second document, the method comprising the steps of: identifying a first matching text region and a second matching text region, each matching text region corresponding to a text region within the first document and an identical text region within the second document, wherein there is a first non-matching text region located between the corresponding text regions of the first document and a second non-matching text region located between the corresponding text regions of the second document; identifying two or more matching text sub-regions, each matching text sub-region corresponding to a text sub-region within the first non-matching text region and an identical text sub-region within the second non-matching text region, wherein between each matching text sub-region and an adjacent matching text sub-region, there is an unmatched text sub-region located between the corresponding text regions of one or both of the first document and second document; and between adjacent matching text sub-regions, recording changes between text present in the first document and text present in the second document.

‘Identical’ as used herein, unless otherwise stated, is taken to mean identical in substance. Therefore, two text regions can be identical despite format of the text within the regions or the way in which it is stored or presented.

According to another aspect, there is provided a method for identifying differences between a first document and a second document, the method comprising the steps of: identifying a sequence of three or more matching text regions, each matching text region corresponding to a text region within the first document and an identical text region within the second document, wherein for each adjacent pair of matching text regions there is a first non-matching text region located between the corresponding text regions of the first document and a second non-matching text region located between the corresponding text regions of the second document, and for each adjacent pair of matching text regions: identifying two or more matching text sub-regions, each matching text sub-region corresponding to a text sub-region within the first non-matching text region and an identical text sub-region within the second non-matching text region, wherein between each matching text sub-region and an adjacent matching text sub-region, there is an unmatched text sub-region located between the corresponding text regions of one or both of the first document and second document; and between adjacent matching text sub-regions, recording changes between text present in the first document and text present in the second document.

The above mentioned aspects may be used in preparing a diff for subsequent use. The diff comprises the record of changes between text present in the first document and text present in the second document. The diff will in general further comprise a record of text which has remained unchanged, i.e. matching text.

It may be that a plurality of diffs between various documents already exist, and it would therefore be desirable to utilise these existing two or more diffs to create a new diff. Such a situation may exist where a first diff exists between a first document and a second document, and a second diff exists between the second document and a third document, and it is desired to provide a third diff corresponding to a duff between the first document and the third document, without resorting to creating the third diff through a full comparative analysis between the first and third documents.

In light of this, according to another aspect of the present invention, there is provided a method for preparing a diff between a first document and a third document, wherein there is provided a first diff data structure, corresponding to a diff between the first document and a second document, and a second diff data structure, corresponding to a diff between the second document and a third document, the method comprising the steps of:
a) identifying an equal data element in the first diff data structure having content equal to an equal data element in the second diff data structure, and recording said content as a first equal data element in a new diff data structure;
b) identifying a next equal data element of the first diff data structure having content equal to a next equal data element of the second diff data structure, and recording said content as a subsequent equal data element to the first equal data element in the new diff data structure; and
c) recording a DelIns data element in the new diff data structure between the first equal data element and the subsequent equal data element, said DelIns data element recording a deletion of the intervening content between the equal data element and the next equal data element of the first diff data structure and an insertion of the intervening content between the equal data element and the next equal data element of the second diff data structure.

Preferably, steps (a) to (c) of the previously described method are repeated in sequence until a complete diff between the first document and the third document is created. For example, each time step (a) is repeated, the method moves to the next equal data element of the first and second diff data structures meeting the requirement of step (a).

The method is advantageous in that it allows for the construction of a diff between two documents, without requiring the full comparative analysis between the two documents. Instead, the existing diff data between the documents and other documents can be utilised to quickly and efficiently prepare a diff. One envisaged application of said method is to allow a user to quickly move between different iterations of family, and having changes between the different iterations shown, without necessitating a full comparative analysis between each of the documents in the family.

Preferably, the method comprises the further step of performing a diff on each of the DelIns data elements of the new diff data structure, wherein the deletion content of a DelIns is diffed with the insertion content of the DelIns. The further step advantageously allows for the identification of further equal regions within the DelIns data element.

Optionally, each sub-region comprises one or more text units, and each region comprises a predetermined minimum number of sub-regions. A text unit may be a character, and in this case a sub-region is a word and a region is a sentence. In an alternative option, each sub-region comprises one or more text units, and each region comprises a plurality of sub-regions, and each region is separated by a preselected text string. The preselected text string may correspond to a commonly occurring word within the two documents.

In an embodiment, the method further comprises a step of removing formatting associated with the text of each document to facilitate identification of matching text regions and non-matching text regions.

It can be advantageous to provide an indexed diff data structure, wherein the diff includes indexes to both documents associated with the diff. In light of this, according to a further aspect of the present invention, there is provided a method for creating an indexed diff data structure, the method comprising the steps of
creating a diff data structure by diffing a first document and a second document, wherein the diff data structure comprises a sequence of data elements, each data element selected from an equal data element and a DelIns data element; and
for each data element:
   determining a first position within the first document associated with the data element;
   determining a second position within the second document associated with the data element;
   recording the first and second position within the data structure such that they are associated with the data element.

Optionally, the step of creating a diff data structure includes the requirement that the diff data structure comprises a sequence of alternating equal data elements and DelIns data elements.

The indexed diff data structure is particularly suitable for identifying a corresponding region in one of the documents associated with the diff, when a region is the other document is selected. In particular, the indexed data structure advantageously reduces the delay between selection of a region in one document, and the identification (and optionally, display) of the corresponding region in the other document. An example embodiment utilising an indexed diff is where a user is able to select a region of a first document, and have a pop-up or other display show the equivalent region in an associated document. This embodiment may also advantageously utilise the method of determining a new diff based on a plurality of existing diffs in order to quickly allow a user to cycle through changes made to a selected region of a document through a number of iterations of changes to the document.

In light of this, according to a further aspect of the present invention, there is provided a method for identifying a corresponding region in a second document, said corresponding region corresponding to a selected region in a first document, comprising the steps of:
providing an indexed diff data structure having a plurality of diff data elements, the diff data structure corresponding to an indexed diff between the first document and the second document, wherein each diff data element is associated with a first position in the first document and a second position in the second document, and wherein each diff data element is one of an equal diff data element and a DelIns diff data element;
identifying a selected region having a beginning part and an end part in the first document;
identifying a first diff data element associated with the beginning part of the selected region, and a second diff data element associated with the end part of the selected region;
identifying a first closest equal diff data element associated with the beginning part and a second closest equal diff data element associated with the end part; and
determining a corresponding region in the second document having a beginning part associated with the first closest equal diff data element and an end part associated with the second closest equal diff data element.

Preferably, at least one of the first diff data element and the second diff data element is a DelIns diff data element, and the step of identifying a closest equal diff data element includes the step of expanding the selected region such that both the beginning part and the end part are associated with equal diff data elements. Preferably, where the first diff data element is an equal diff data element, the first closest equal diff data element is the first diff data element. Also preferably, where the second diff data element is an equal diff data element, the second closest equal diff data element is the second diff data element.

Aspects of the invention are directed towards modifying a diff, such as a diff or indexed diff, created according to the previous aspects. It is a desirable outcome that a modified diff, when presented to a user, is easier to read or review. It is also a desirable outcome that a modified diff more closely resembles how a human editor of a document would edit, or did edit, a document.

In light of this, according to an aspect of the invention, there is provided a method for identifying and removing a spurious match from a diff of two documents, the diff comprising a plurality of DelIns, wherein each DelIns has an associated length, and wherein adjacent DelIns are separated by a finite distance (for example, two adjacent DelIns may be separated by an equal region), the method comprising: identifying a first DelIns and a second DelIns where a length of one or both of the first DelIns and the second DelIns is greater than a distance between the first and second DelIns; replacing the first DelIns, the second DelIns, and the intervening region with a derived DelIns. There is also provided, according to a related aspect, a document comprising mark-up text, wherein mark-up text is located within a plurality of spaced apart mark-up regions, wherein for any two different mark-up regions, a distance between the two mark-up regions is greater than the length of one or both of the mark-up regions.

Further aspects of the invention are directed towards presenting comparisons of two documents. The presentation desirably allows for ease of comparison, for example by presenting similar regions of the two documents in a side-by-side arrangement. Therefore, according to another aspect of the invention, there is provided a method for constructing an alignment block, the alignment block comprising a first sub-block associated with a first document and a second sub-block associated with a second document, the method comprising: identifying a first sequence of one or more text regions comprising text within the first document and a second sequence of one or more text regions comprising text within the second document, wherein each sequence comprises matching text and wherein each of the first sequence and second sequence comprise a minimum number of text regions such that the same matching text is present within the first sequence and the second sequence, and wherein at least one of the first sequence and the second sequence further comprises non-matching text; and adding the first sequence to the first sub-block and the second sequence to the second sub-block.

It may be a requirement that the text within each sub-block is located within a text region. This corresponds to the idea that each sub-block contains a whole number of text regions, and no other text. Each text region may correspond to a paragraph. This may be advantageous for many common document types, such as those prepared according to a generally accepted layout, e.g. those that follow normal English layouts.

Optionally, the method further comprises the step of: extending the smaller of the first sub-block and the second sub-block using a padding to reduce or eliminate a size difference between the first sub-block and the second sub-block. The size difference in this case may be the difference in height of the sub-blocks. For example, if one sub-block contains fewer lines of text than the other, it may have extra lines added (at the end of the text contained within) until it contains an equal number of lines to the other.

According to another aspect, there is provided a method for presenting a comparison of a first document and a second document, each document comprising matching text and non-matching text, the method comprising the steps of:
constructing a sequence of alignment blocks, each alignment block comprising a first sub-region and a second sub-region forming a sub-region pair, and each alignment block comprising one of:
a) a first sequence of one or more text regions comprising text within the first document and a second sequence of one or more text regions comprising text within the second document, wherein each sequence comprises matching text and wherein each of the first sequence and second sequence comprise a minimum number of text regions such that the same matching text is present within the first sequence and the second sequence, and wherein at least one of the first sequence and the second sequence further comprises non-matching text;
b) a first sequence of one or more text regions comprising text within the first document and/or a second sequence of one or more text regions comprising text within the second document, wherein each sequence comprises only non-matching text, and wherein the, or each, sequence comprises a maximum number of text regions; and
c) a first sequence of one or more text regions comprising text within the first document and a second sequence of one or more text regions comprising text within the second document, wherein each sequence comprises only matching text, and wherein each of the first sequence and second sequence comprise a maximum number of text regions,
for each alignment block, extending a smaller of the first sub-block and the second sub-block using a padding to reduce or preferably eliminate any size difference between the first sub-block and the second sub-block,
presenting the alignment blocks in sequence such that the arrangement of text in each sub-block in the sequence corresponds to the arrangement of text in the first document and second document.

In an embodiment, the method further comprises the step of marking non-matching text in each sub-block such that, when presented, the non-matching text is differentiable from the matching text. Such marking could be highlighting or underlining the non-matching text. The presentation step may correspond to printing the alignment blocks in sequence or, alternatively, the presentation step may correspond to displaying the alignment blocks in sequence on a monitor. Preferably, the first sub-block of a sub-block pair is arranged adjacent with the second sub-block of the pair.

According to another aspect of the present invention, there is provided a method for presenting for comparison of a first document and a second document, the method comprising the steps of presenting a portion of the first document alongside a portion of the second document; and scrolling the first document and the second document, such that relative alignment of the documents is maintained by dynamically changing the scroll rate of one document with respect to the other document, wherein the scroll rate is selected such that, as the first and second documents are scrolled, matching text in each document is presented simultaneously.

Also provided, according to an aspect, is a method for presenting for comparison of a first document and a second document on a display, the method comprising the steps of: presenting, within a first region of the display, a portion of the first document; simultaneously presenting, within a second region of the display, a portion of the second document; determining an alignment region within the display; and scrolling the first document and the second document, wherein the scroll rate of the first document and/or the second document is dynamically adjusted such that when matching text of the first document is present within the alignment region, the corresponding matching text of the second document is present within the alignment region.

Preferably, the first region and the second region are arranged to allow a side-by-side comparison of the first document and the second document. For example, the first region and the second region are horizontally aligned within the display. Optionally, non-matching text of the first document and the second document is marked, for example highlighted or underlined.

According to an aspect of the present invention, there is provided a computer implemented display means adapted to present a first display region arranged adjacent with a second display region, the first display region configured for displaying all or a portion of a first document and the second display region configured for displaying all or a portion of a second document, wherein: the first document comprises matching text regions and deleted text regions but not inserted text regions and; the second document comprises matching text regions and inserted text regions but not deleted text regions, wherein text of the deleted text regions of the first document is marked in the first display region and wherein text of the inserted text regions of the second document is marked in the second display region. According to an aspect of the present invention, there is provided a method for improving a diff, the method comprising the steps of: identifying each partially modified word within the diff meeting a predetermined condition; and replacing each identified partially modified word with a derived totally modified word. Optionally, the predetermined condition comprises there being an equal or greater number of changed characters within the partially modified word than of unchanged characters. Alternatively, the predetermined condition optionally comprises there being a greater number of changed characters within the partially modified word than of unchanged characters.

Additionally, according to an aspect of the invention, there is provided a method for identifying moves of text from a first document to a second document, the method comprising the steps of: diffing to identify deletions of text and insertions of text; identifying a deleted text region which matches an inserted text region; and recording the deleted text region and the inserted text region as moved regions.

According to another aspect of the invention, there is provided a method for identifying copies of text from a first document to a second document, the method comprising the steps of: diffing to identify insertions of text; identifying a matching text region within the first document which matches an inserted text region within the second document; and recording the inserted text region as a copied region.

According to another aspect of the invention, there is provide a method for identifying redundant text from a first document to a second document, the method comprising the steps of: diffing to identify deletions of text; identifying a deleted text region of the first document which matches a matching text region of the second document; and recording the deleted text region as a redundant region.

Preferably, in any of the previous three aspects, the identifying step comprises application of a predetermined rule. The predetermined rule may be that the number of characters each text region is equal to a predetermined minimum number of characters.

According to another aspect of the present invention, there is provided a method for presenting for comparison of a first document and a second document, the first document and second comprising a region of moved text, the method comprising the steps of presenting a portion of the first document, said portion comprising the region of moved text; identifying the location of the region of moved text within the second document; and presenting a portion of the second document, the portion comprising the region of moved text, such that the moved region is displayed simultaneously in each of the portion of the first document and the portion of the second document.

This aspect may be particularly suitable after performing the method of any one of the preceding three aspects. It is understood that the aspect may be suitable for copied or redundant text as well as moved text.

Preferably, the presenting of each portion comprising presenting on a screen. The region of moved text may be displayed in the second portion in a separate window to other text of the second document. In one or both of the portion of the first document and the portion of the second document, the text of the region of moved text may be marked. For example by highlighting or by underlining. The portion of the second document may be displayed by scrolling the second document.

According to an aspect of the present invention, there is provided a method for placing a document into one of a plurality of document families, the method including the steps of determining at least one score associated with each document family, each score indicating a level of similarity between the document and the associated document family; identifying at least one threshold document family, the or each threshold document family corresponding to a document family with at least one associated score meeting a predefined threshold; and placing the document into the, or one of the, threshold document families.

According to an aspect of the present invention, there is provided a method for placing a document into a new document family, the method including the steps of determining at least one score associated with one or more document families, each score indicating a level of similarity between the document and the associated document family; identifying that each score fails to meet a predefined threshold; creating a new document family; and placing the document into the new document family.

According to an aspect of the present invention, there is provided a method for placing a document into a document family, the method including the steps of: determining at least one score associated with one or more document families, each score indicating a level of similarity between the document and the associated document family; in response to identifying at least one threshold document family, the or each threshold document family corresponding to a document family with at least one associated score meeting a predefined threshold: placing the document into the, or one of the, threshold document families; and in response to identifying that each score fails to meet a predefined threshold: creating a new document family; and placing the document into the new document family.

Preferably, in particular in respect of the first and third aspects, the, or each, document family is structured document family, and including the further steps of: when placing the document into a threshold document family, identifying an existing document within the a threshold document family, or a merger of two or more existing documents within the threshold document family, as being a closest match to the document; and attaching the document to the closest match.

According to an aspect of the present invention, there is provided a method for adding newly created documents to a document family, including the steps of: maintaining a watch for newly created or newly edited documents; and in response to identifying a newly created or newly edited document, placing the document into a document family or a structured document family using any one of the previous aspects.

According to an aspect of the present invention, there is provided a processing server including: a processor; at least one memory device operatively associated with the processor; interfacing means for communicating with one or more client devices, configured for receiving a document, wherein the memory device further includes instructions which, when executed by the processor, implements the method of at least one of the previous aspects.

According to an aspect of the present invention, there is provided a processing server, including: a processor; at least one memory device operatively associated with the processor, and including a family database; and interfacing means for communicating with one or more client devices, wherein the memory includes instructions which, when executed by the processor, implement the method of: maintaining the family database, said family database including records associated with one or more document families, each record including identifying information identifying one or more documents of the associated document family; receiving, via the interfacing means, a document; determining at least one score associated with one or more document families, each score indicating a level of similarity between the document and the associated document family; in response to identifying at least one threshold document family, the or each threshold document family corresponding to a document family with at least one associated score meeting a predefined threshold: placing the document into the, or one of the, threshold document families; in response to identifying that each score fails to meet a predefined threshold: creating a new document family; and placing the document into the new document family.

According to an aspect of the present invention, there is provided a processing server, including: a processor; at least one memory device operatively associated with the processor, and including a family database for storing records associated with one or more document families, each record including identifying information identifying one or more documents of the associated document family; and interfacing means for communicating with one or more client devices, wherein the memory includes instructions which, when executed by the processor, implements the method of: receiving, via the interfacing means, a plurality of documents; providing an initial document; attaching one of the plurality of documents to the initial document; for each remaining document: identifying one of the initial document, a previously attached document, or a merger of two or more previously attached documents, as being the closest match to the document; and attaching the document to the closest match, in response to all of the documents being attached to a corresponding closest match, removing the initial document, storing within the family database the one or more resulting structured document families.

According to an aspect of the present invention, there is provided a method for presenting changes between a base document and a latest document, wherein there is one or more intermediate documents, the method including the steps of: identifying a collection of documents, said collection including the base document, latest document, and the one or more intermediate documents; identifying the base document; identifying the latest document; identifying and creating a chronological sequence, wherein the first document of the sequence is the base document, and the last document of the sequence is the latest document, and the one or more intermediate documents are arranged between said base document and latest document; identifying changes between adjacent pairs of documents; creating a changes document including indication of changes made between each pair of documents, wherein the changes are represented in respect of the base document, such that the changes document corresponds in content to the latest document.

According to an aspect of the present invention, there is provided a method for notifying a user of changes between an incoming document and a previous document, wherein the incoming document is a modification of the previous document, and wherein the incoming document includes: one or more first modified regions, corresponding to modifications of the previous document, wherein the one or more first modified regions are marked as modified; and one or more second modified regions, corresponding to modifications of the previous document, wherein the one or more first modified regions are not marked as modified, the method including the steps of: comparing the incoming document to the previous document to identify changes made between the documents; identifying the presence of the one or more second modified regions; and notifying the user of the presence of the one or more second modified regions.

A score, or a plurality of scores, associated with a document family, corresponds to the level of similarity between the document and the document family. In embodiments, scores are numerical values which are determined based on an analysis between content of the document and/or metadata associated with the document. In example embodiments, where the content of the documents is substantially comprised of text, a score can be proportional to the amount of similar text within the document and one or more documents of the document family. A score for an entire document family may be dependent on a subset of the documents within a family. In embodiments, it may be that the most similar document within the family to the document being assessed is solely relied upon to determine the document family score.

The score can also be determined by, or modified by, properties of the documents. For example, documents of a first content type, for example images, and documents of an unrelated second content type, for example text, may be scored always as being dissimilar, thus reducing or eliminating the chance of such documents being placed in the same document family. The score can be determined based on a number of properties of the documents, and these individual properties can be suitably weighted using predefined weightings (which may be changed over time) such that properties more likely to correlate with document similarity are given a higher weight.

Thresholds represent the requirements for a document to be considered part of a document family. In general, a score associated with a document family must meet a particular threshold before it can be considered potentially part of the document family. Where more than one document family meets the threshold, the document will, in embodiments, be placed in the best scoring (that is, most similar) document family. In some embodiments, a score is represented by a numerical value, and a threshold represents or corresponds to a minimum value that must be obtained by a score. Thresholds may be predefined, and may also be changeable under different circumstances.

When a document is attached to one or more other documents, in general, the meaning of attached corresponds with “associated with”, such that one document is recorded as being a modification of the other document.

In some instances, the addition of a document to a document family or structured document family appears to link two or more separate document families or structured document families. In these instances, it may be preferable to treat the two or more separate document families or structured document families as a single document family or structured document family. This may occur when the document has similar associated scores with two or more other documents or (structured) document families.

It is understood that the various aspects of the invention can be used in conjunction, such as in sequence. The methods herein described are preferably implemented using computing systems or devices, such as computer servers accessible by a client device over the network.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIG. 1 is a schematic representation of a system suitable for implementing embodiments of the invention;

FIG. 2 is a symbolic representation of a processing server suitable for use with embodiments of the invention;

FIG. 3 is a representation of a plurality of documents;

FIG. 4a shows a computer network for implementing embodiments of the invention;

FIG. 4b shows another computer arrangement for implementing embodiments;

FIG. 4c shows another computer arrangement for implementing embodiments;

FIG. 5a shows an overview of a process incorporating embodiments of the invention;

FIG. 5b shows an overview of a process incorporating embodiments of the invention;

FIG. 6 shows an overview of a method for generating a diff;

FIG. 7a shows a detailed view of a method for generating a diff;

FIG. 7b shows a method for rendering moves;

FIG. 8a shows a network based method for showing a diff to a user;

FIG. 8b shows logic for diffing and presenting documents in a text editor such as Microsoft Word;

FIG. 9 shows logic for matching position of two documents when scrolling;

FIG. 10 shows logic for displaying a move;

FIG. 11 shows alignment logic;

FIG. 12a shows logic for outputting non-matching blocks;

FIG. 12b shows a method for outputting matching blocks;

FIG. 13 shows a side-by-side display of two documents;

FIG. 14a shows a diff algorithm;

FIG. 14b shows a clean-up algorithm;

FIG. 14c shows an algorithm for removing spurious matches;

FIG. 14d shows an algorithm for removing spurious matches in pseudo-code;

FIG. 15 shows a move algorithm;

FIG. 16 shows two documents presented side-by-side;

FIG. 17a shows two documents presented side-by-side with a move;

FIG. 17b shows two documents presented side-by-side but aligned with a pop-up showing a move;

FIG. 18a shows a move between two documents not aligned;

FIG. 18b shows the two documents of FIG. 18a with alignment of the move;

FIG. 19a shows a method for identifying a corresponding region in a document;

FIG. 19b shows a selected region corresponding to both the first and last characters associated with Eq diff elements;

FIG. 19c shows a selected region corresponding to the a character associated with an Eq diff element and a last character associated with a DelIns diff element;

FIG. 19d shows a selected region corresponding to both a first character and a last character associated with DelIns diff elements;

FIG. 20 shows a modified data structure;

FIG. 21a shows a comparison of two documents;

FIG. 21b shows another comparison of two documents;

FIG. 22 shows an example where diffs exist between adjacent documents, and it is desired to determine a diff between two non-adjacent documents;

FIG. 23a shows an Eq data element in diff and an Eq data element in another diff corresponding to the same text;

FIG. 23b shows a data element of one diff being an Eq data element, and the corresponding data element in another diff being a DelIns data element;

FIG. 23c shows two data elements being DelIns data elements;

FIG. 23d shows the case where one DelIns reverses the effect of another DelIns;

FIG. 24a shows an unmodified diff;

FIG. 24b shows a further modified diff;

FIG. 24c shows two modified diffs;

FIG. 25 shows the documents of FIG. 3 placed into document families;

FIG. 26 shows a method for indexing a document;

FIG. 27 shows a method for placing a document into a document family;

FIG. 28 shows a structured document family;

FIG. 29a shows two structured document families with different histories;

FIG. 29b shows a method for placing documents into structured document families;

FIG. 29c shows the result of the method of FIG. 6b;

FIG. 30a shows two structured document families linked by an empty node;

FIG. 30b shows two structured document families separated after removal of the empty node;

FIG. 31 shows a method for watching for new documents;

FIG. 32a shows a webmail based implementation of embodiments

FIG. 32b shows a method for using embodiments in an email system;

FIG. 33 shows a method for using embodiments in an email list system;

FIG. 34 shows a method for alerting a user that unmarked changes exist in a document;

FIG. 35 shows an extended diff embodiment;

FIG. 36 shows a HTML table structure;

FIG. 37 shows an aligned document;

FIG. 38 shows another aligned document;

FIG. 39a shows a webmail based implementation of embodiments;

FIG. 39b shows a webmail based implementation of embodiments;

FIG. 40a shows a comparison of two documents;

FIG. 40b shows a method for generating a diff; and

FIG. 40c shows a modified data structure.

### DESCRIPTION OF PREFERRED EMBODIMENT

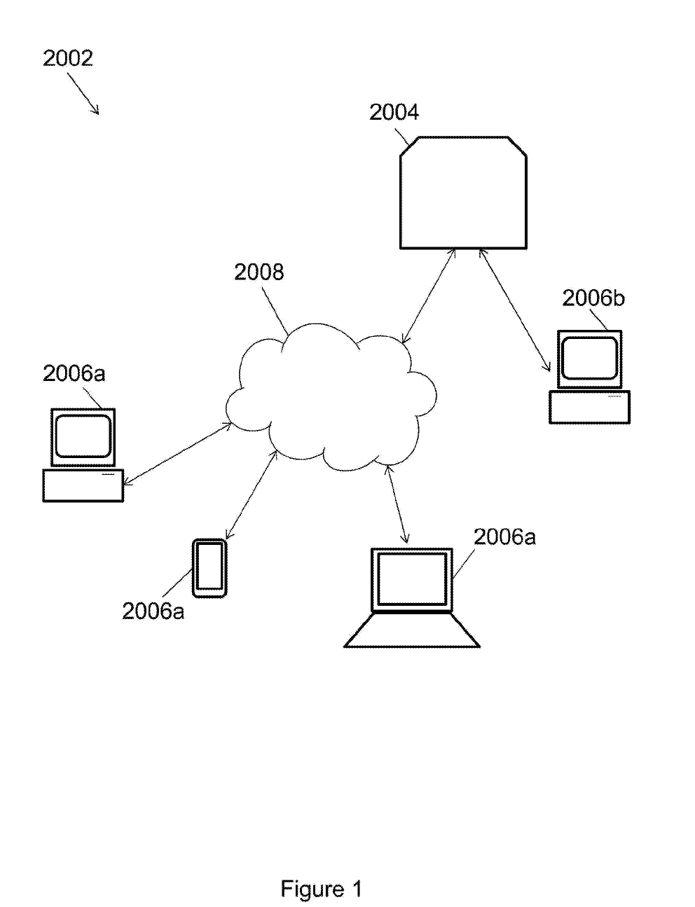

Referring to FIG. 1, there is shown a system 2002 suitable for implementing embodiments of the invention. The system 2002 includes a processing server 2004, one or more client devices 2006, and a network 2008. As shown, the processing server 2004 is in communication with the one of more client devices 2006, either via the network 2008 in the case of client devices 2006a or through a direct connection in the case of client devices 2006b. Direct connection in the present case includes arrangements where a client device 2006b is the same physical device as the processing server 2004, or connected through direct means such as USB, Firewire, Wi-Fi wireless, etc. Furthermore, the network 2008 can include sub-networks which are in communication. An example of such an arrangement is where the network 2008 is the Internet, and the sub-networks are local intranets connected to the Internet. Client devices 2006a can be in network communication with the processing server 2004 by being located in the same sub-network as the processing server 2004, or via a connection between sub-networks. In an example, the processing server 2004 is a “cloud” server, and client devices 2006a communicate with the processing server 2004 via the Internet (network 2008).

As used herein when referring to the figures, a reference number (such as “2006” in FIG. 1) refers to the general feature of the figure (in FIG. 1, “2006” refers to client devices in general). A general feature may include specific features, which will be distinguished based on an appended lowercase letter (such as “a”). Specific features may be distinguishable based on particular properties (such as the different client devices 2006a and 2006b of FIG. 1), or simply due to being different instances of the same general feature.

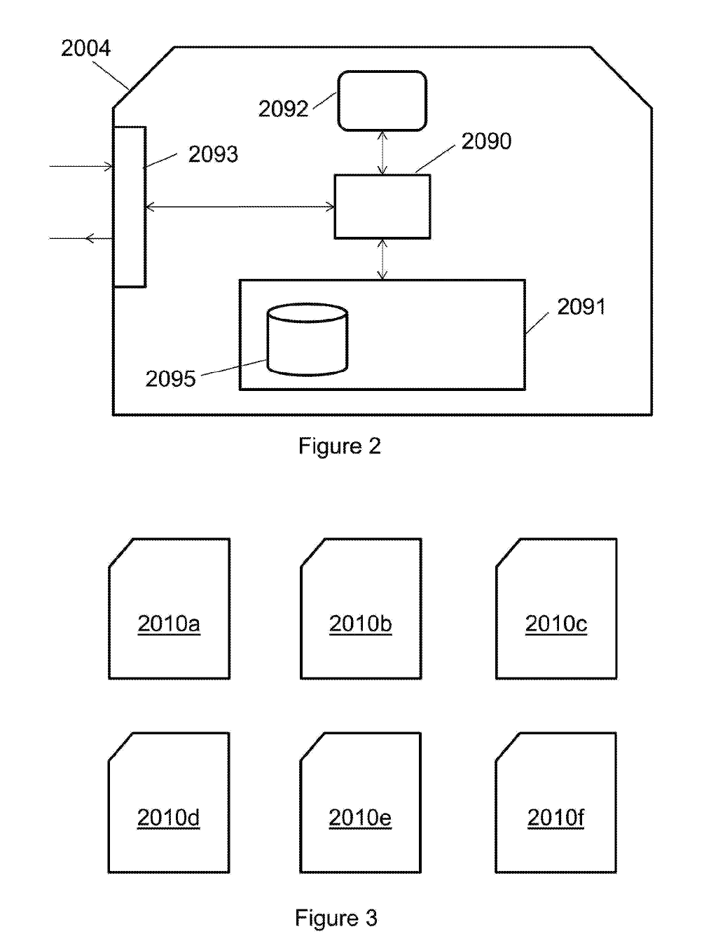

FIG. 2 shows features of a processing server 2004 suitable for implementing embodiments of the invention. The processing server 2004 includes a processor 2090, preferably a microprocessor. It is understood that the processor 2090 may correspond to a plurality of microprocessors. The processor 2090 is interfaced to, or otherwise operably associated with, a non-volatile memory/storage 2092. The non-volatile storage 2092 may be a hard-disk drive, and/or may include solid state non-volatile memory, such as read-only memory (ROM), flash memory, or the like. Furthermore, according to some embodiments, all or a part of the non-volatile storage device 2092 is located in a network accessible storage, or is accessed remotely to the processing server 2004. The processor 2090 is also interface to volatile storage 2091, such as random access memory (RAM), which contains program instructions and transient data relating to the operation of the processing server 2004. In a conventional configuration, the storage device 2092 maintains known program and data content relevant to the normal operation of the processing server 2004. For example, the storage device 2092 may contain operating system programs and data, as well as other executable application software necessary to the intended functions of the processing server 2004. It is the execution of said application software causes the processing server 2004 to implement methods embodying the invention. The processing server 2004 is configured for maintaining a database 2095, shown in FIG. 2 as corresponding to a location within the volatile memory 2091. It is understood that the database 2095 can instead, or simultaneously, be maintained within the non-volatile memory 2092, or another memory which may be accessible by the processing server 2004.

The processing server 2004 of FIG. 2 also includes a network interface 2093, which is configured for receiving and sending network data to an attached network, such as the Internet. The network interface 2093 is in communication with the processor 2090.

It is understood that the embodiments described herein may be particularly applicable to client devices 2006 suitable for text processing, such as computers running text editing software such as Microsoft Word. It is not intended, however, that the disclosure herein be limited to client devices 2006 with particular features, and that client devices 2006 may include: desktop computers; laptops and notebooks; netbooks; tablets; mobile phones; and other suitable devices.

It is also understood that the embodiments described herein may be particularly applicable to processing servers 2004 implemented as stand-alone computers or server farms. However, it is envisaged that the processing server 2004 may correspond to suitable functionality implemented on the same device as the client device 2006 (e.g. as a separate computer program or within the same computer program). Processing server 2004 should therefore be understood to encompass computing devices suitable for implementing the functionality herein described. It some instances, the processing server 2004 may correspond to a cloud based server, such as the Amazon EC2 platform.

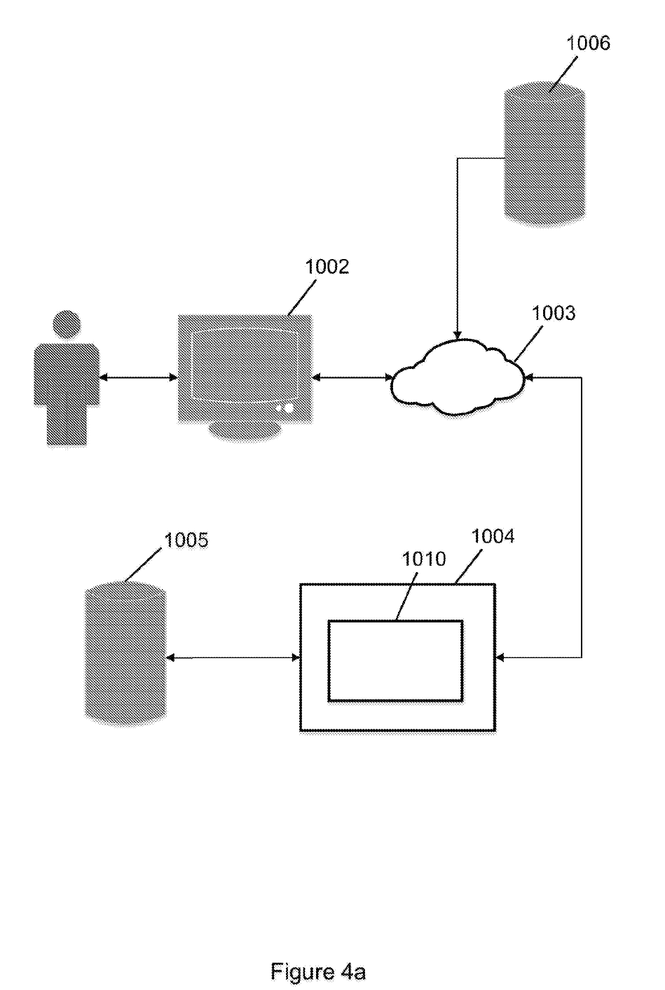

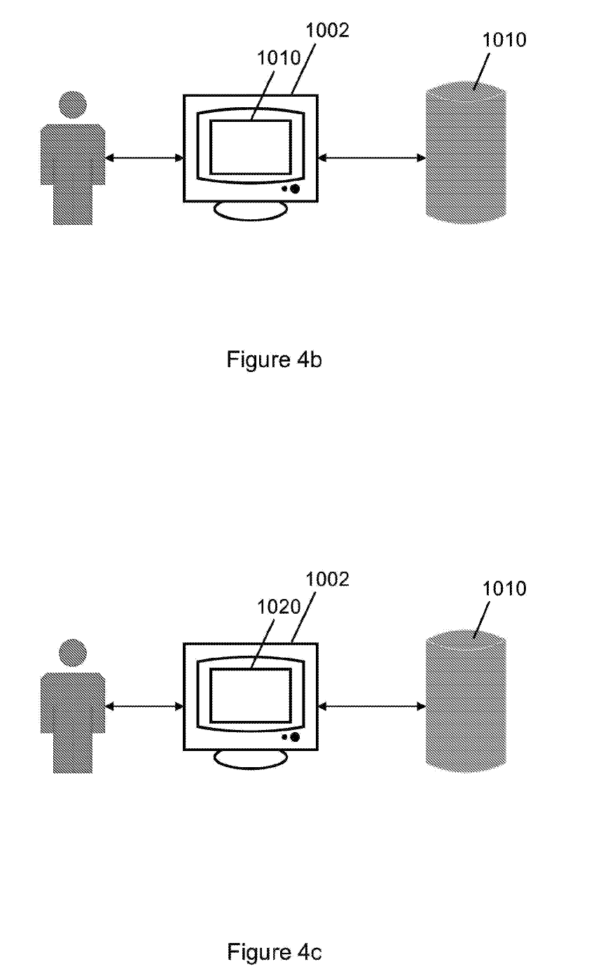

FIG. 4a illustrates a preferred embodiment of our method for producing side-by-side diffs where the diffing is done on a server and the rendering is done on the client. A user interacts with diffing service via software running on their computing device 1002 (which can be a client device 2006 shown in FIG. 1), for example a computer or mobile phone etc. In the embodiment we describe, the functionality is provided through a web browser, but the service could be embedded in any other piece of software. The user selects two files they wish to compare, which may reside on their device 1002 or may be present in a cloud storage system 1006 such as Dropbox. If these files reside on the user's computing device 1002 then they are transmitted to the server 1004 (which can be a processing server 2004 shown in FIG. 1). If these files reside in a cloud service 1006, then their identifiers are transmitted to the server 1004 which then retrieves the files from the cloud storage service 1006 and stores them on the storage server 1005.

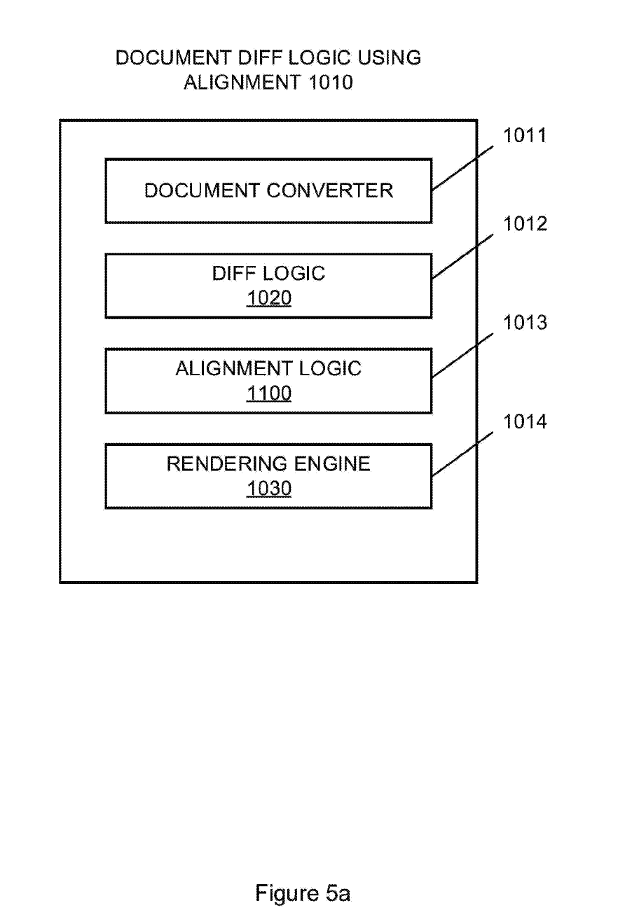

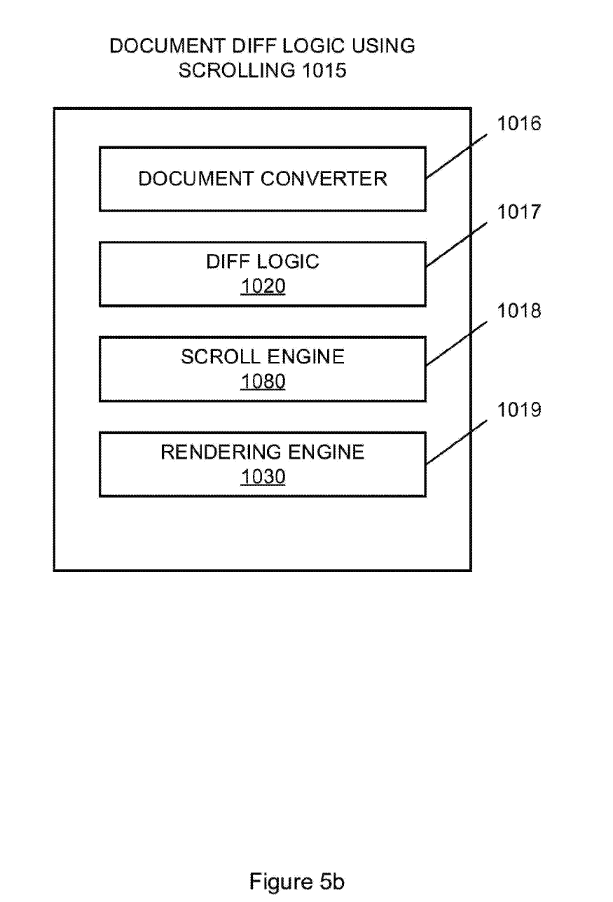

On the server 1004 the document diff logic 1010 runs. FIG. 5a provides an overview of the steps required. First the files are converted 1011, if necessary, to a suitable file format. In the preferred embodiment this format is HTML. This conversion can be accomplished for a great variety of document formats using readily available commercial such as Microsoft Sharepoint. The converted documents are stored on the storage service 1005.

Next, the diff logic 1012 and alignment logic 1013 are run on the converted files to generate a diff or list of changes. Along with the converted files, the diff is cached on the storage service 1005. The diff and converted documents are rendered to a single HTML file on the server 1004 using the rendering engine 1030, or, in an embodiment which will be described here, the diff and converted files are sent to the client device 1002 and the rendering logic is run on the client device 1002.

The various components of the diff logic illustrated in FIG. 5a can be run on either the server or the client depending on the particular circumstances.

In another preferred embodiment illustrated in FIG. 4b, there is no server and all the software runs on a single computer, or, equivalently, the functionality of the server 1004 and the user's computing device 1002 are implemented on the same physical hardware. A user selects two files they wish to compare using a computing device 1002. The two files are fed as input into the diff logic 1010, which runs on the same computing device 1002. We implement this embodiment by miming the same software we used in the client-server embodiment but where all components run on the same computer 1002 and use local storage 1010 such as the hard disk on the computing device 1002, instead of a storage server 1005. Another change we make in this embodiment is in the document converter 1011, where we replace Microsoft Sharepoint with different readily available commercial software (such as Microsoft Word) to the convert the input files to HTML format if necessary.

We describe a third preferred embodiment. Similar to the embodiment described with reference to FIG. 4b, this is a client-only embodiment and is illustrated in FIG. 4c. The difference between this embodiment and that shown in FIG. 4b is that in this embodiment we do not align the documents by inserting extra space. Instead we display them side-by-side with their original layout (or if the documents are converted, with the original layout of the converted document). In order that the documents appear aligned to the user, we allow each to be scrolled individually by means of the scroll engine 1080, and synchronize the scrolling of other document with that of the scrolled document so that the documents are aligned. In other words, the alignment is achieved dynamically rather than being fixed at the start. An advantage of this is that the original layout of the documents can be more closely preserved.

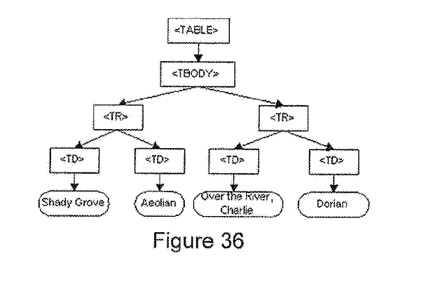

We are concerned with diffing formatted documents, such as HTML or Office Open XML (OOXML; Microsoft Word's format) or subsets of LaTeX. We can represent the structure of a formatted document as a tree. It branches out at each grammatical level, and each leaf contains text. FIG. 36 shows the tree-representation of an HTML table. It is understood that document grammar relates to the structure of the code of the document, and not the grammar of the actual text of the document.

One way to compare two formatted documents is to work directly with the two tree representations and diff the trees. But doing that requires we (and our algorithm) understand the grammar and be able to answer questions like “Can we insert this subtree here?” For example, in FIG. 36, it is necessary that we know that a <TD> (table row) can only appear inside a <TR> (table row).

A key observation, however, is that the important information for the purposes of diffing (the text) is in the leaves. We want to use a plain text diffing algorithm on formatted documents, without destroying the formatting. In order to do this, we will diff plain text derivatives of the formatted documents, and then map the results into the document's structure. This technique can be particularly suitable when presenting the diff in a side-by-side format.

Our method works preferably with file formats that have the following property: we can apply styles to leaf elements, independent of what formatting/structure is in the tree above them. This enables us to, for example, colour text red or green without fully understanding the grammar of the document. This property holds true for HTML and OOXML. In HTML, we can use a <span> tag to apply a style (e.g. a red background colour) to some text; in OOXML, we can divide the text in runs <w:r> as needed, then apply styles individually to a run.

We may need an additional property of our file format, if we want to align our side-by-side diffs nicely. For the embodiment using scrolling, this property may not be necessary. Basically what we need is to be able to insert space, in order to keep the documents in sync. For example, if we compare a document “A” to the same document with an extra paragraph at the start, “B”, we want to be able to insert space at the start of A so that the matching paragraphs line up. To do this, we need to understand something of the high-level grammar. For HTML, it's sufficient here that we know that the document is broken into paragraphs and tables and we can insert space between these.

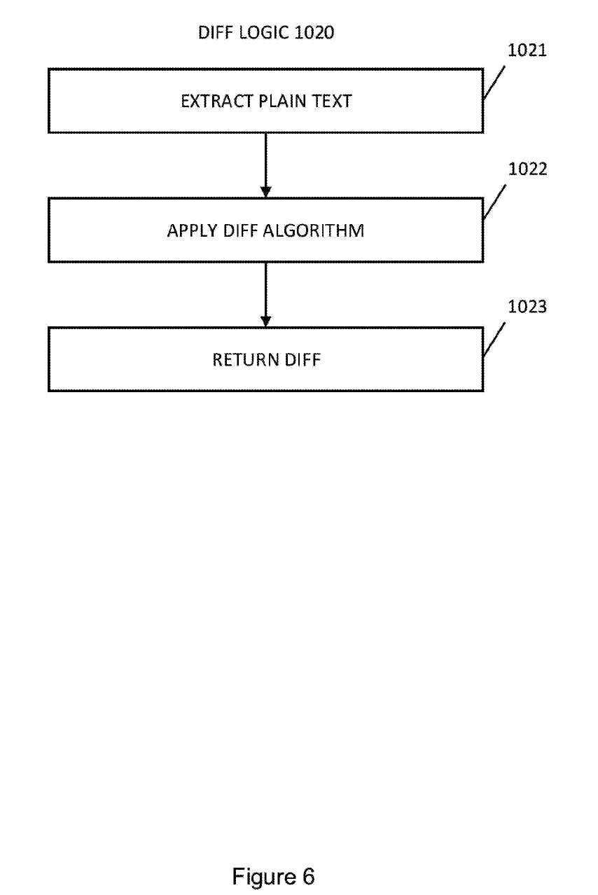

We start with a formatted document in a markup format that satisfies the required properties, for example HTML or OOXML (docx). The logic is illustrated in FIG. 6.

We derive the plain texts of each document at step 1021 by taking the text of each leaf of the tree in sequential order, i.e., we extract the text. Usefully, we insert punctuation at the end of various formatting elements, e.g., a newline “In” at the end of a table cell and table row, two newlines at the end of a paragraph or table.

Next, we use a plain text diff algorithm at step 1022 to calculate an edit script (i.e. a diff) between the plain text of the old document and the plain text of the new document. The edit script is a list of edits—each edit contains a piece of text and specifies that it was either deleted, inserted, or it remained equal. This diff of the text is then passed to the next stage of the algorithm as described below.

Optionally, depending on the embodiment, the diff also includes a list of moves: matching regions of text that are in addition to the matching “Equal” edits that generate the alignment of the two documents.

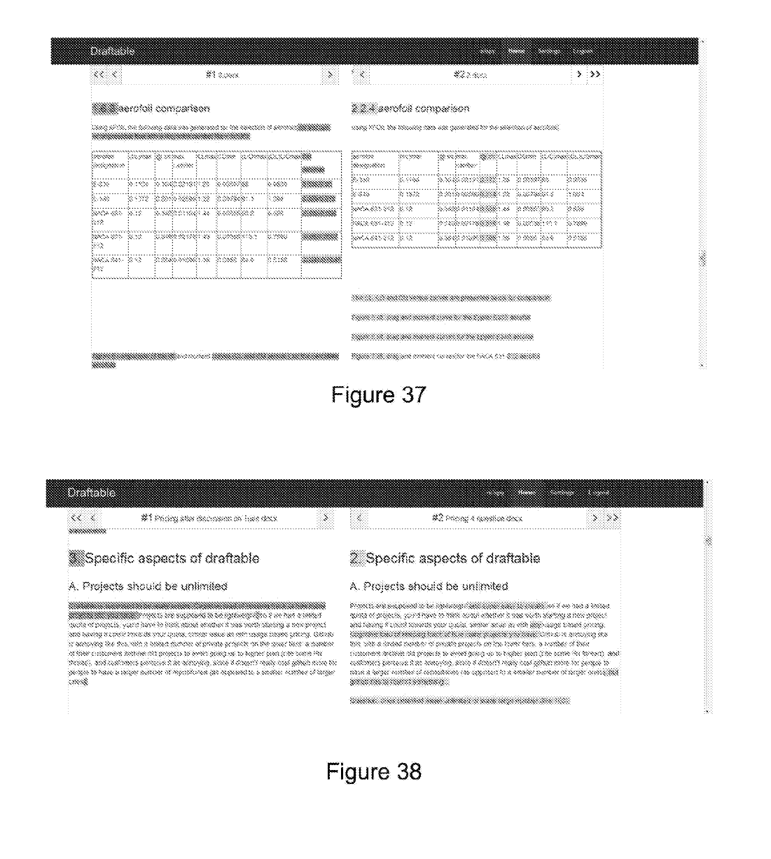

FIG. 37 shows how this method works to show the insertion and deletion of columns in a table, despite the diff algorithm having no notion of what a table is.

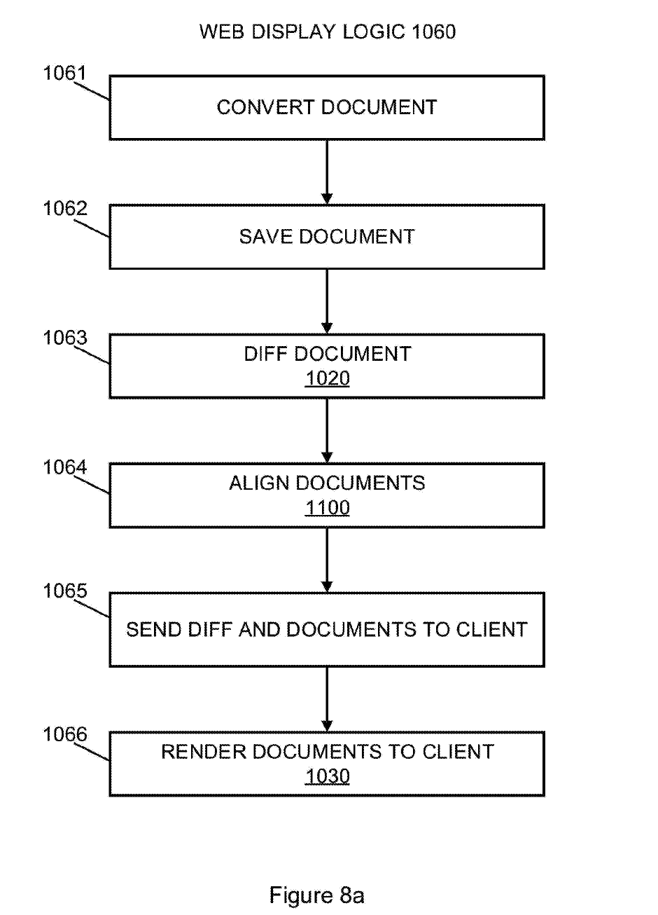

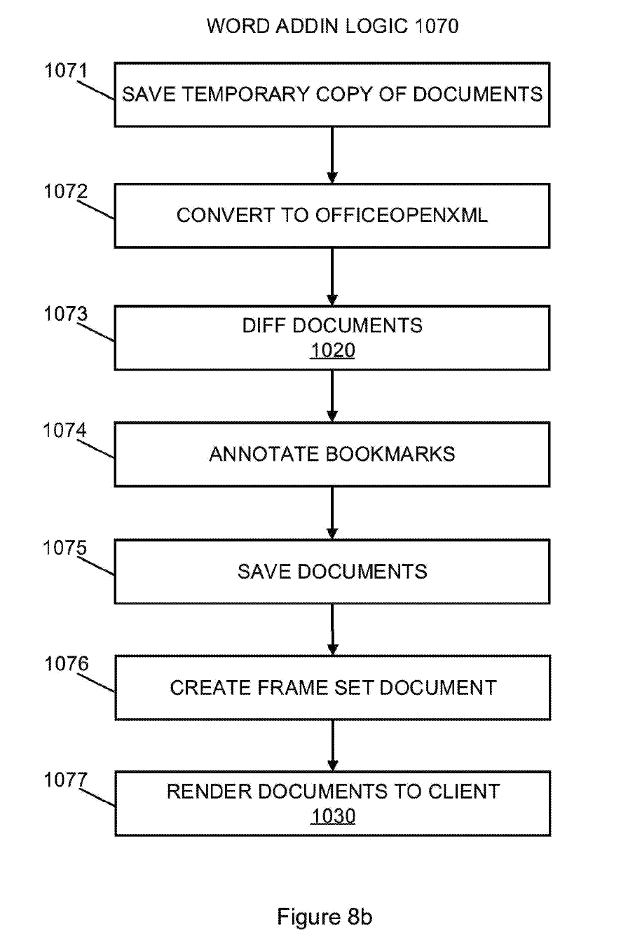

We here describe in more detail the client-server embodiment. FIG. 8a illustrates the steps. The user supplies two files which are converted 1061 to HTML and stored 1062. We then extract the plain text of the documents and diff them at step 1063 as explained above or otherwise. Next we run an alignment algorithm at step 1064 which will be described below. The purpose of the alignment algorithm is to split the diff up into “blocks,” which describe how to render the documents. The blocks will be displayed in a Web browser or other software stacked vertically. Each block comprises data describing (i) how many top-level elements to take from the left document, (ii) how many top-level elements to take from the second document, and (iii) the sub-diff (a portion of the diff that corresponds to the text within those top-level elements). Here ‘top-level element’ means paragraph or table or similar structures in HTML, or the equivalents in other mark-up languages. After the diff has been divided into blocks, we send 1065 the HTML documents and aligned diff to the client device for rendering 1066. As mentioned above, this step could also be done on the server.

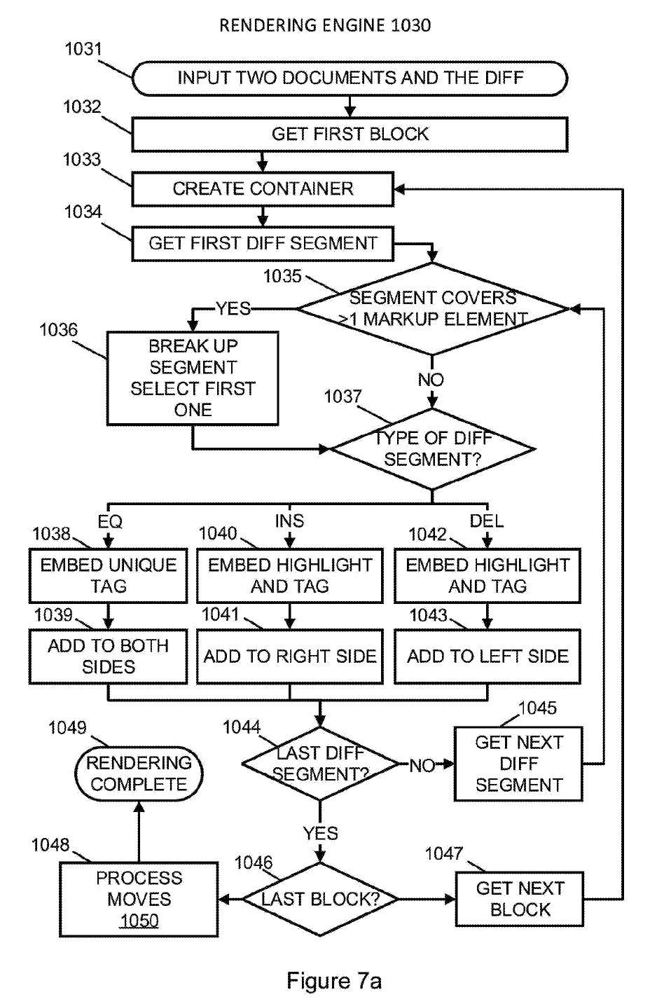

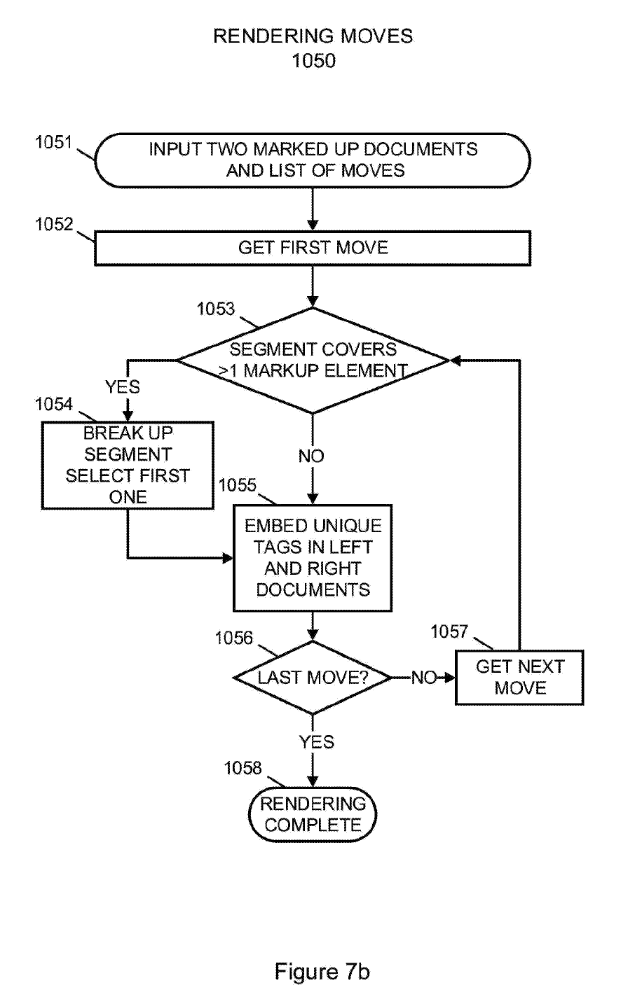

The process of rendering the documents is illustrated in FIG. 7a. We receive 1031 from the server the two documents and the aligned diff. We then process each block in turn starting with the first, at step 1032. We layout the documents using a HTML table with two columns (each corresponding to a sub-block of the block) with the left document (in this example, it is the older of the documents) in the left column and the right document (in this example, it is the newer of the documents) in the right column, and with each block generated by the alignment algorithm in a table row <tr> (step 1033). Within each block, we process the diff.

To apply this diff information to the formatted document, we step through the tree of the document in sequential order, while simultaneously stepping through the diff, marking up the text as we go with a “delete”, “insert” or “equal”<span> tag. In particular, at step 1035 we take an edit from the edit script, and determine if it covers more than one HTML markup element in either of the documents. If it does, we break off only so much as will not cover more than one HTML markup element (step 1036), and we leave the remainder for processing in the next step. If the edit is an “Equal”, we markup both documents using a <span> tag and give this tag a unique name at step 1038 to enable us to highlight the corresponding parts in each document on, e. g., mouseover. If the edit is a “Delete” or “Insert”, we markup the document with appropriate <span> tags which colour the corresponding parts of the formatted document as desired (1040-1043). We repeat 1045 this procedure until we've processed the whole block (step 1044). We then repeat this procedure for each block.

We now have a version of the old document with deleted text marked up, and a version of the new document with inserted text marked up.

Optionally, if the diff algorithm generates a list of moves, we render those 1050. Moves are matching segments of text that are separate and in addition to matching Equal regions that we use to produce the alignment. This means that a region where text has been moved from will not be aligned with the position where it is moved to, except by coincidence. Moves are preferably differentiated from deletions and insertions, for example we can colour moves in a different colour, say, orange. It is useful to the user to be able to compare side-by-side the regions where moved text came from and where it went. We accomplish that according to the logic in FIG. 7b.

We start 1051 with two the two marked-up documents generated by the logic illustrated in FIG. 7a and a list of moves generated by the diff algorithm. We process each move in order starting with the first (step 1052). As we did for the deletes and inserts, if a move covers more than one markup element in either document, e.g. two paragraphs, or a paragraph and some table cell, or multiple table cells etc., we break it up at step 1054. We then embed <span> elements in the two documents that are labeled by the move at step 1055. A single move can therefore be broken up into multiple <span> elements each of which has the same tag. We do this for each of the moves at step 1057. The <span> tags are styled so that they have higher priority than the <span> tags corresponding to Inserts and Deletes, which means moves will be in a different colour.

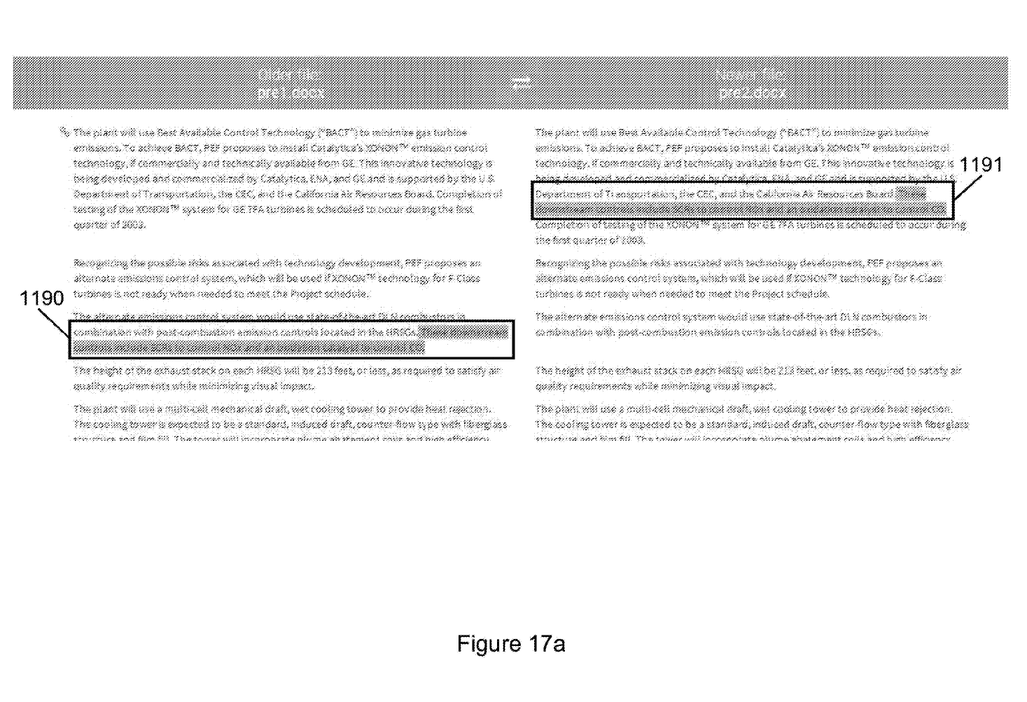

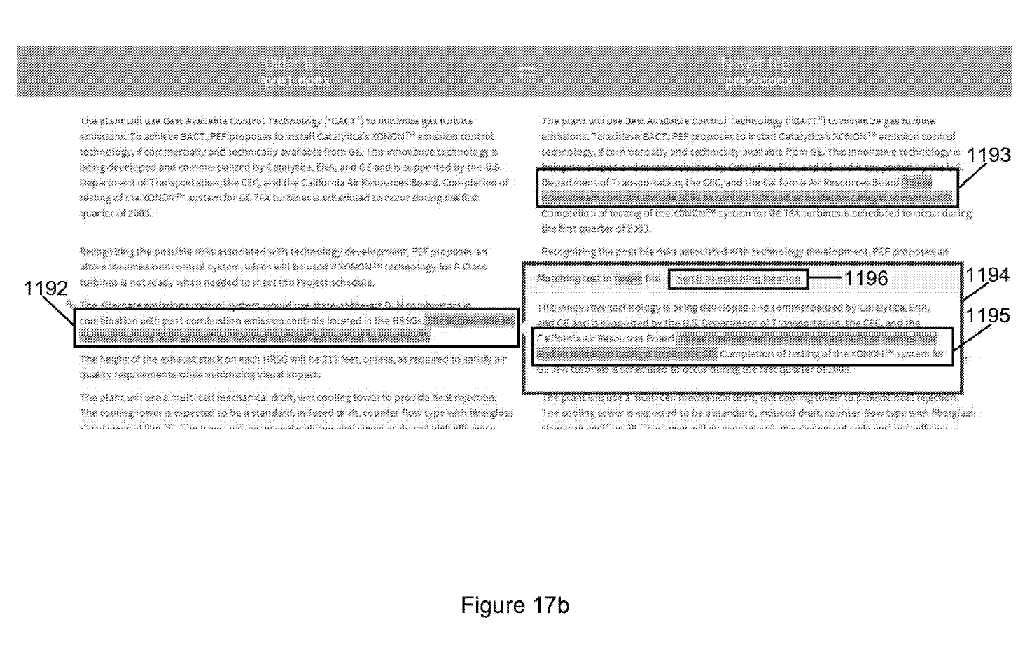

FIGS. 17a and 17b illustrate the interface for moves. Referring first to FIG. 17a, the text 1190 has been moved earlier in the document 1191. We add a Javascript “onHover” event to the moved text. When the user hovers over moved text, the corresponding text, which can be located using the tags we added at step 1055, together with some surrounding text to provide context, is copied to a popover and displayed to the user. FIG. 17b shows what happens when the user hovers over the moved text 1192. The popover 1194 appears, showing the moved text 1195 and providing a link 1196 to scroll the document to the corresponding position in the right document. It should be noted that in this particular short example the moved text was already visible on the screen 1193, but this will not in general be the case in a longer document, hence the purpose of the popover.

We can do a variety of other things that would be apparent to a person skilled in the art, for example, hiding unchanged regions, letting you jump to the next changes, etc.

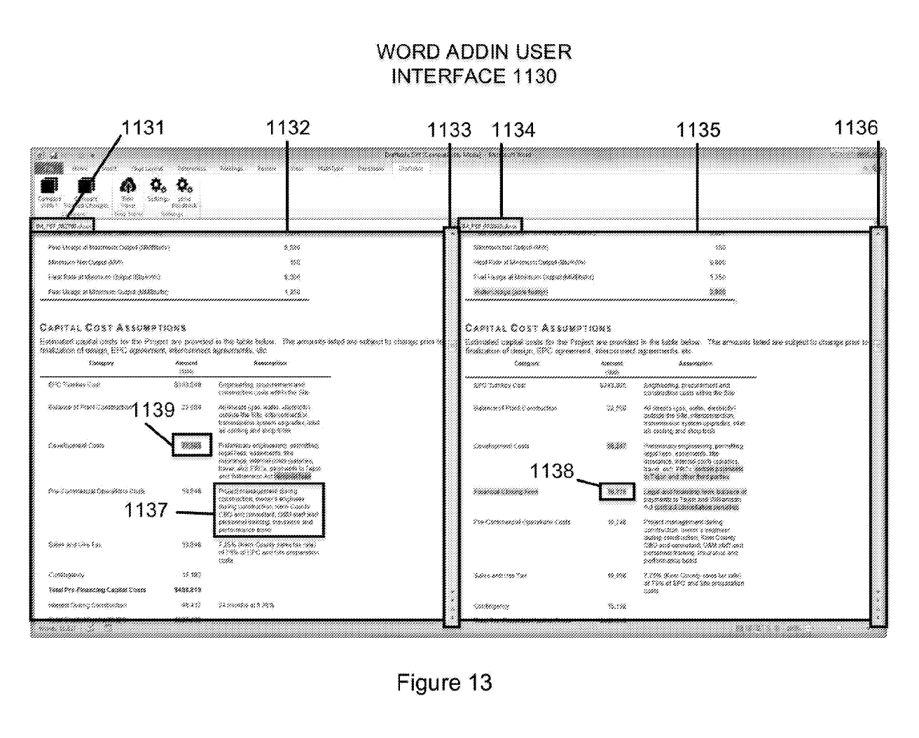

We describe an alternative UI for viewing the side-by-side comparison. In this alternative, instead of aligning paragraphs by grouping the document into blocks (“UI with alignment”), we just render the two documents side-by-side with their original formatting. Each document can be scrolled independently via a separate scroll bar (1133 and 1136 in FIG. 13) but when one document is scrolled, the other document is synchronously scrolled to the same position.

For pedagogical purposes, we'll describe a client-server HTML embodiment of the invention but the method could equally well be used on an individual computer and/or with different document formats, for example with docx files. Some of our Figures (e.g., FIG. 13) show an embodiment of the invention implemented as an Add-In for Microsoft Word.

This method is similar to that described in the previous section and illustrated in FIGS. 8a, 7a and 7b for UI with alignment, so we'll just describe the differences. First, we don't need to perform the step of aligning the documents 1064. The client receives the diff and documents at step 1065 and renders them at step 1066. We do rendering 1030 just as we did for displaying the diff with alignment except that we imagine the entire diff and both documents to be contained in one block. Similarly, marking up moves 1050 in this case is identical to what we did for the UI with alignment.

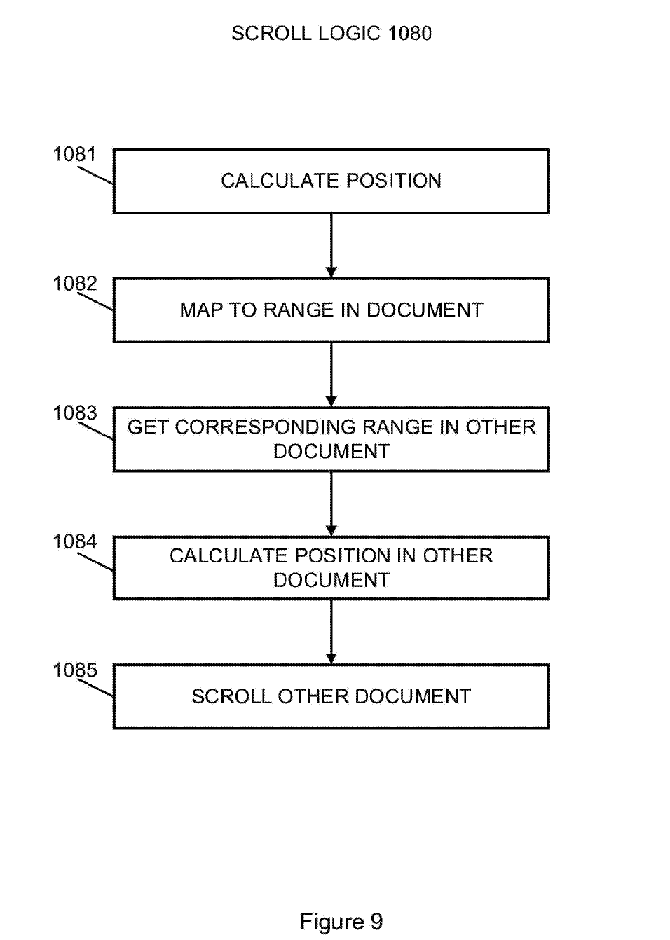

We construct an array of the top and bottom positions of each diff segment 1037 that we tagged during rendering of the documents, using the jQuery function offset( ). There are separate arrays for the left document and right document: these encode the mapping from a position in one document to the position in the other document. The method is illustrated in FIG. 9. We hook the scroll position (step 1081) of one document, e.g., the left document and when it changes, we update the scroll position of the right document by (i) looking up the position in the array corresponding to the left document (step 1082), (ii) looking up the corresponding position in the array corresponding to the right document (step 1083), and (iii) updating the scroll position of the right document to that position (step 1085). We do the same for when changes occur in the scroll position of the right document.

The position of say the left scroll will typically be midway through some diff segment of the associated left document, and we can arrange that the right scroll position be the same proportion through the corresponding diff segment of the right document (i.e. at step 1084). If there is a large inserted or deleted region within one of the documents, then the scrolling will skip over this quickly (because there isn't a corresponding diff segment in the other document), so we want to smooth out the scrolling around large inserted (and large deleted) regions. This can be achieved by considering the position in the left document as the average of a range of a number of nearby positions, mapping each of these positions to the corresponding positions in the right document, and then scrolling the position in the right document to the average of the corresponding positions.

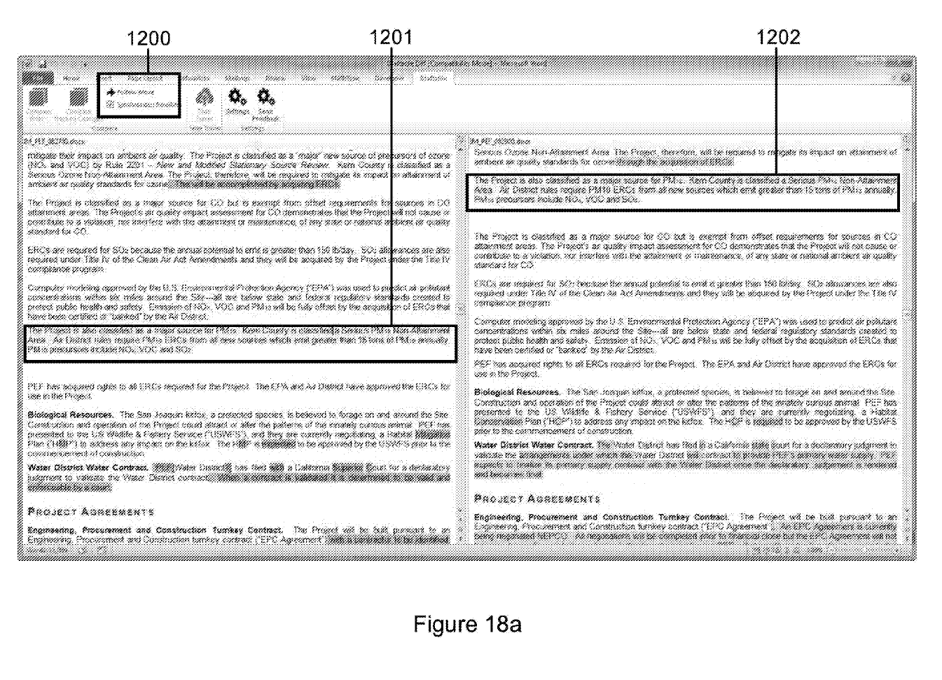

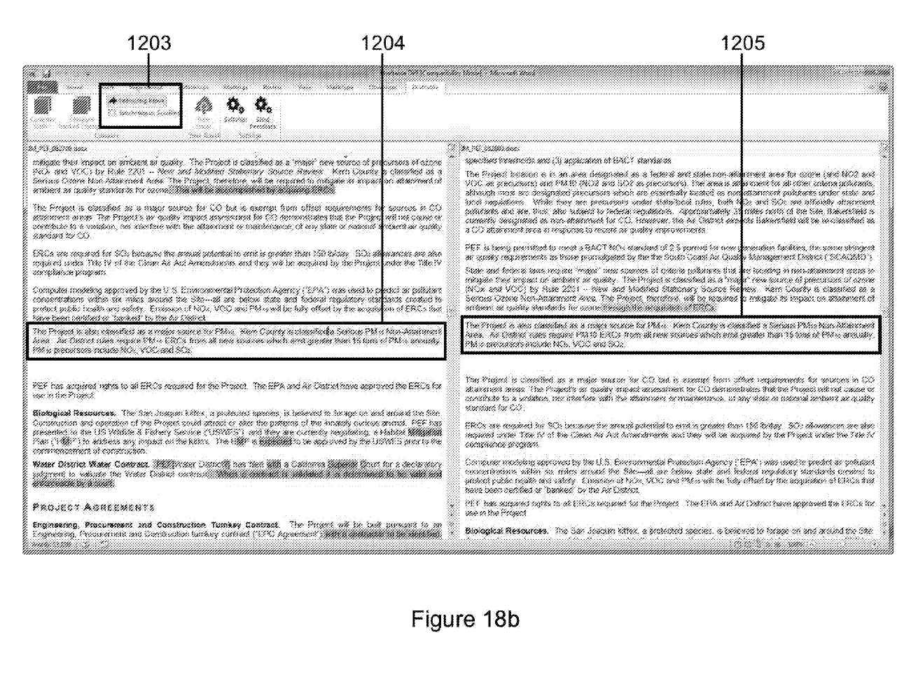

The interface for navigating moves is illustrated in FIG. 18a and FIG. 18b. The text at 1201 has been moved to 1202 and this is indicated, for example, by colouring this text a particular colour. There is functionality 1200 to follow a move, which is activated when the cursor is inside a region of moved text. For example, in FIG. 18a, the user's cursor is inside the region 1201. When they hover the mouse over a region of moved text, the right side scrolls so that the corresponding moved text 1202 is aligned with the moved text 1201. This is illustrated in FIG. 18b. The two regions of moved text, 1204 and 1205 are now aligned. The user restores the normal synchronous scrolling by moving their mouse off the moved region. It should be noted that for the purposes of illustration, the moved text was already visible on the screen, but in general this need not be the case.

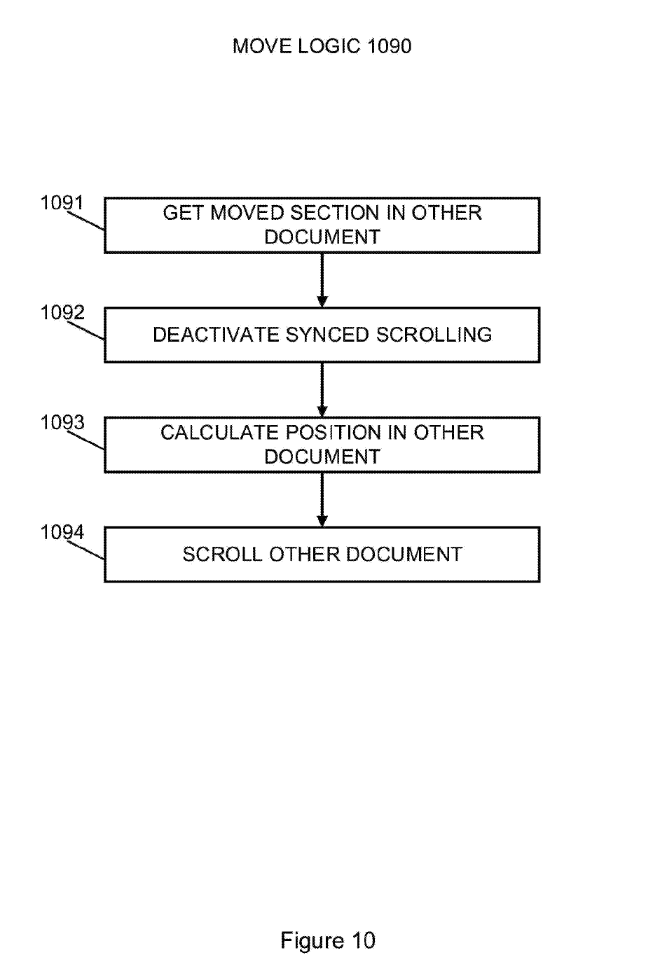

The logic used to achieve this functionality is illustrated in FIG. 10. We detect whether we the mouse is inside regions of moved text by hooking divs that contain moved text using the jQuery function hover( ). If so, we look up the corresponding region in the other document via the mark-up we placed in the documents. We calculate the position to scroll to in the other document at step 1093 in the same way we did for synchronized scrolling. We then scroll the other document to the appropriate position at step 1094.

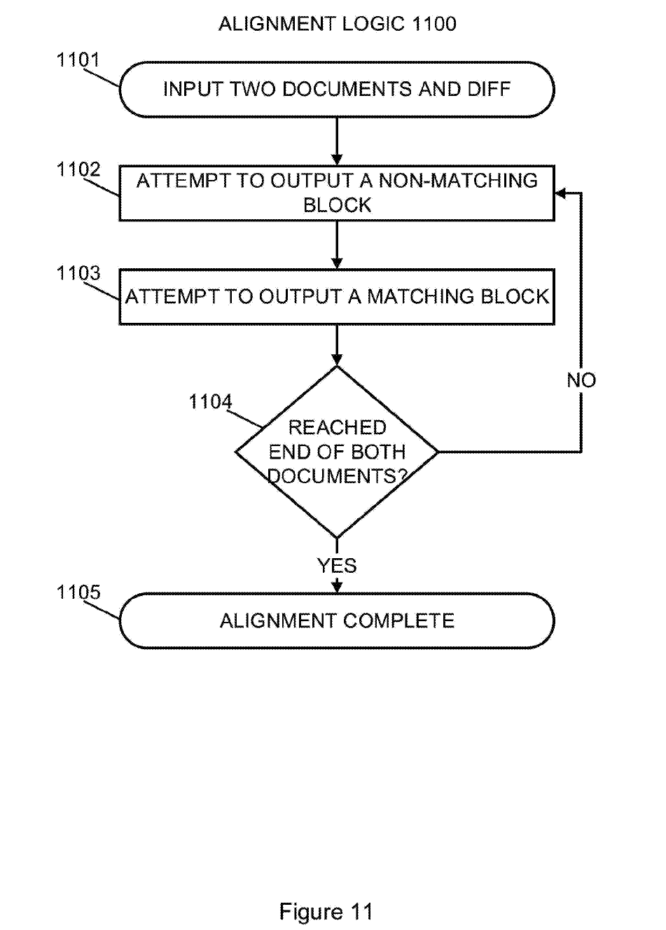

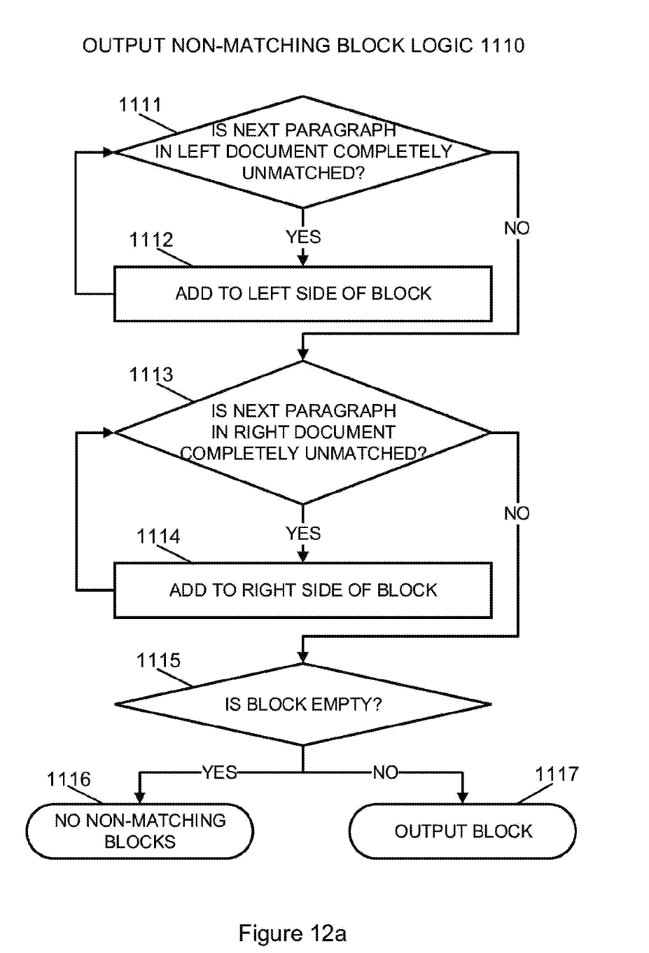

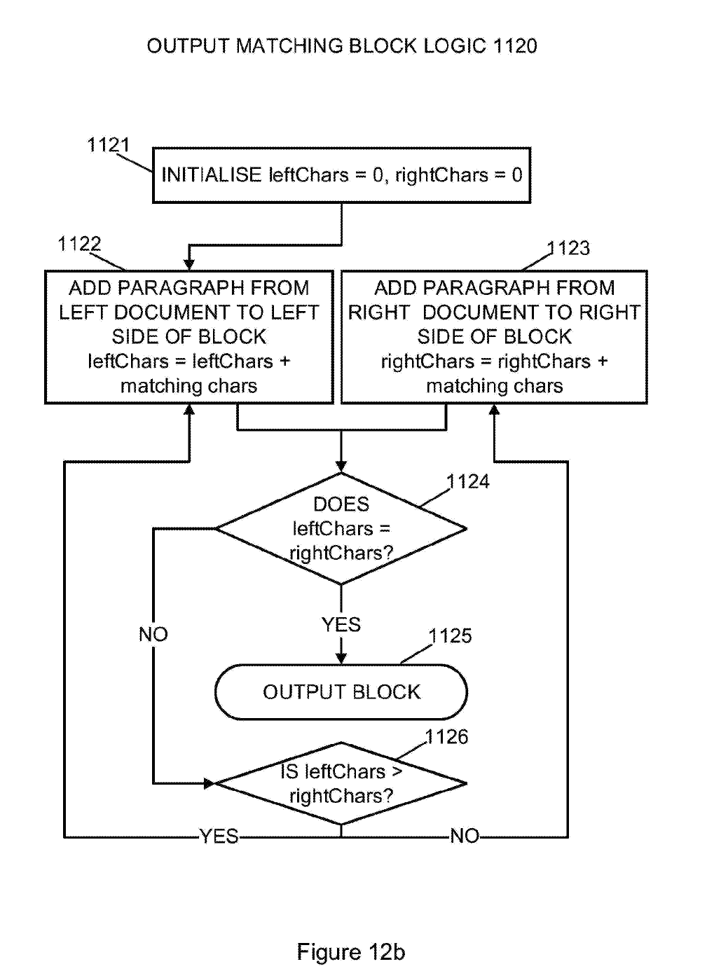

Now we describe the alignment logic referred to above and illustrated in FIGS. 11, 12a and 12b. We start with a high-level overview. First we consider the left document. It contains deleted text, which is not present in the right document, and matching text, which is present in the right document. For deleted text, we don't know anything about what it should be aligned with in the right document, so we may have to be conservative. On the other hand, we want any matching text to be aligned with the corresponding matching text in the right document. We will proceed by outputting blocks which contain a set of paragraphs from the left document, and a set of paragraphs from the right document. It is understood that the term “paragraphs” is used in a generic sense, and typically we can associate blocks with any number of different document divisions such as: paragraphs; tables; and other document elements (preferably, we decide on the division type before outputting the blocks). We want our algorithm to have the following properties: (i) if a paragraph on the left of a block contains some matching text, then that text is also in a paragraph in the right in the same block; (ii) all blocks are minimal, i.e., we can't split a block into multiple blocks. Property (i) states that matching text should be in the same block; property (ii) says that we should split into as many blocks as possible subject to (i), because this will result in better alignment.

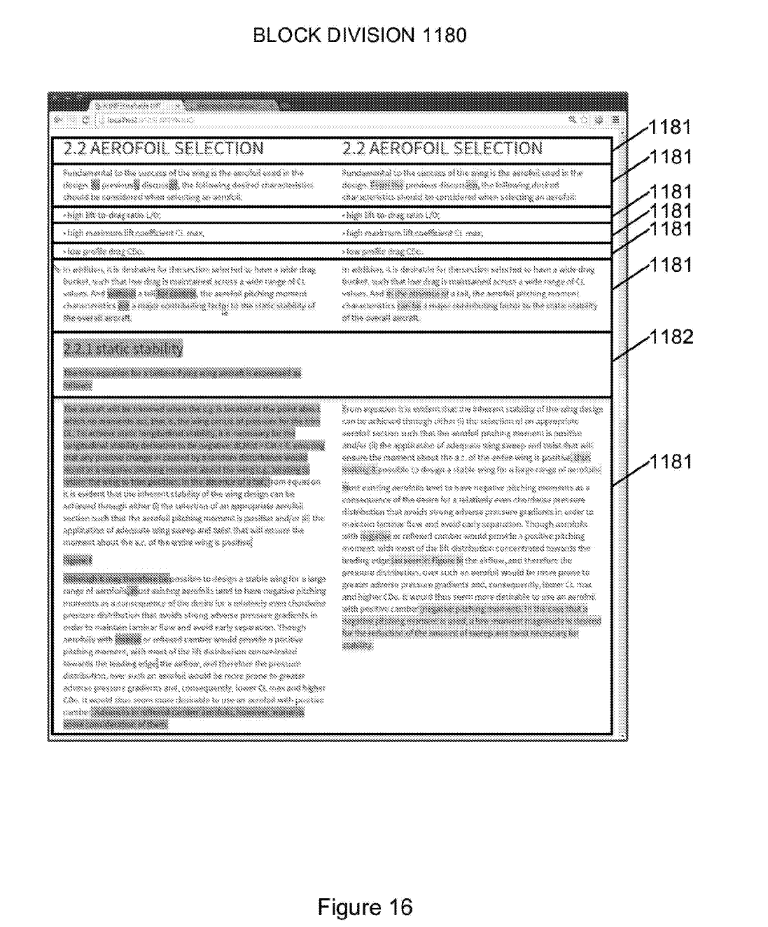

Start with FIG. 11. The input to the procedure is two documents together with a diff of them (step 1101). We start by attempting to output a block with no matching text at step 1102. This is illustrated in FIG. 12a. Blocks with no matching text are whole paragraph insertions and whole paragraph deletions. Because we are dealing here with blocks with no matching text, we can treat the left and right sub-blocks separately. We start with the left document. We check 1111 if the next paragraph in the left document consists entirely of deleted text. If so, we add it to the left sub-block of the block at step 1112. We repeat this procedure so long as there are paragraphs consisting only of deleted text. Note that at the point we stop, the next paragraph in the left document will contain some matching text (unless we are at the end of the document). We do the same procedure for the right document (steps 1113, 1114), instead putting the paragraphs with no matching text into the right sub-block. These paragraphs together make up the block to display, so if is non-empty (step 1115), we output it at step 1117. In the presented example illustrated in FIG. 16, the blocks are illustrated by drawing horizontal lines between them. In this example, there are some blocks with some matching text 1181 and a single block with no matching text 1182. In the unmatched block 11132 there is only text on the left. It is also possible to have text on the both left and right sub-blocks provided all the text on left is marked “Deleted” and all the text on the right is marked “Inserted”.

Returning now to FIG. 1.1, we attempt to output a block with matching text (at step 1103). The procedure is illustrated in FIG. 12b. We initialize 1121 two counters leftChars=rightChars=0. We then (at step 1122) take a paragraph from the left document and add it to the left sub-block and increase the counter leftChars by the number of characters in that paragraph marked “Equal” in the diff. We then add paragraphs to whichever side has fewer ‘equal’ characters, until both numbers are the same (at step 1124). This procedure will ensure that any matching text is in the same block.

Once the counters are the same, we have found a minimal, grammar-preserving pairing of paragraphs and we output this block (at step 1125).

Returning once again to FIG. 11, unless we've reached the end of both documents (see step 1104), we again attempt to output a non-matching block (at step 1110), then a matching block (at step 1120) and continue this iterative procedure until we reach the end of the document. At this point the alignment is complete (at step 1105).

It may be that the alignment within a block with matching text is not yet optimised, as the documents can get out-of-sync with each other within an aligned block. See the example in FIG. 38, where the highlighted text “Projects are supposed to be lightweight” is on different rows on both sides. The reason is that we've deleted the first sentence in the old document. In an embodiment, we do further alignment within a block by using a dynamic programming algorithm inspired by Knuth's dynamic programming algorithm to do line-breaking for LaTeX documents. We define for each row of text a “badness”, which depends on how full the line is and also on how close the matching text is to the corresponding matching text in the other column. We then use dynamic programming to minimize the badness. In this case, such an algorithm would decide to start the paragraph on the right one line down, which would result in better in-block alignment. Such an algorithm could also be used to align the whole documents.

Note that none of our examples have graphics or equations etc. shown, but such additional non-textual document elements can be included in the display of the diffs because the alignment algorithm we have described naturally spaces out the text to make room for them: if there is an image or an equation or some other non-textual element we display it in the position it occurs at in the document. It will lie within some particular block and may affect the alignment within that particular block, but the alignment will become correct again in the following block.

A diffing algorithm is now described. Although we describe the algorithm for plain text, it is understood that the algorithm may be applied with straight-forward modification more widely, for example, to computer code. The algorithm runs in three parts.

First, we attempt to get the global alignment of the two documents right, without worrying too much about whether things look right locally. We then go in and fix things locally. Finally, we search for text that is moved.

We describe the algorithms in this section as working on plain text. We described earlier how to extend them to formatted files. These algorithms will also give good results on computer code (which is line based) and in other areas.

### Part 1: Global Alignment

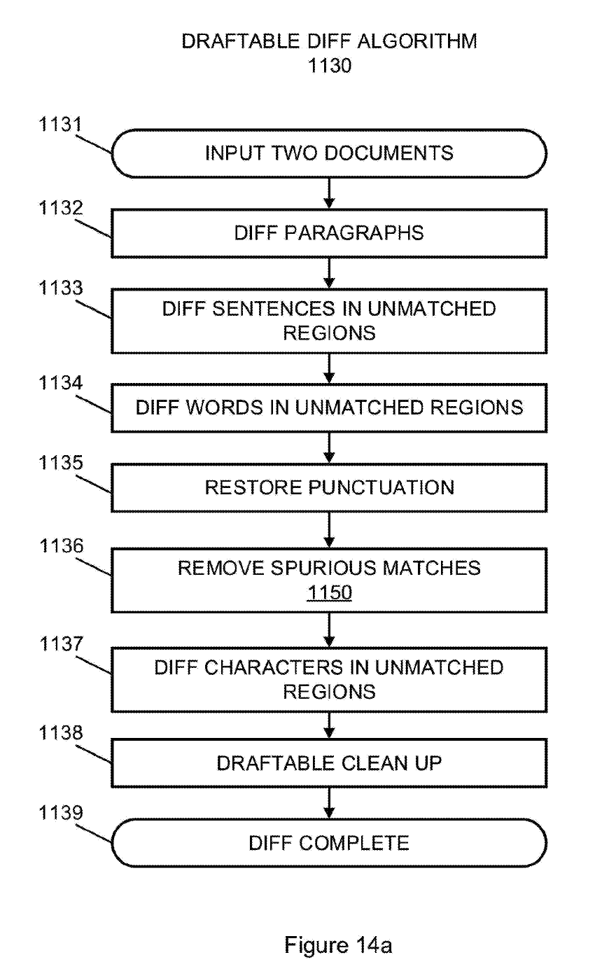

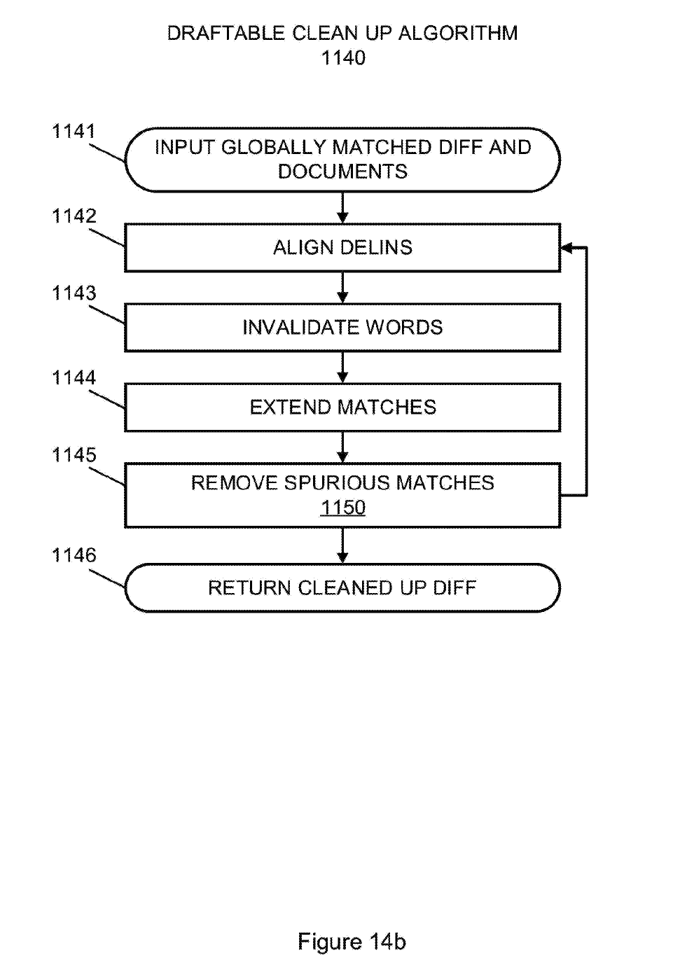

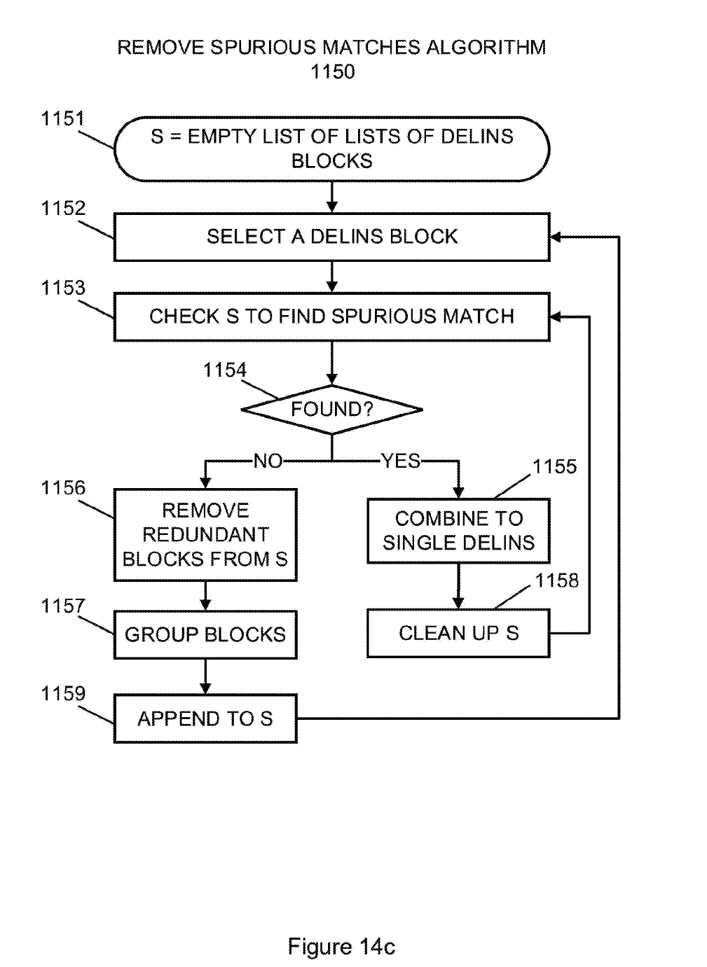

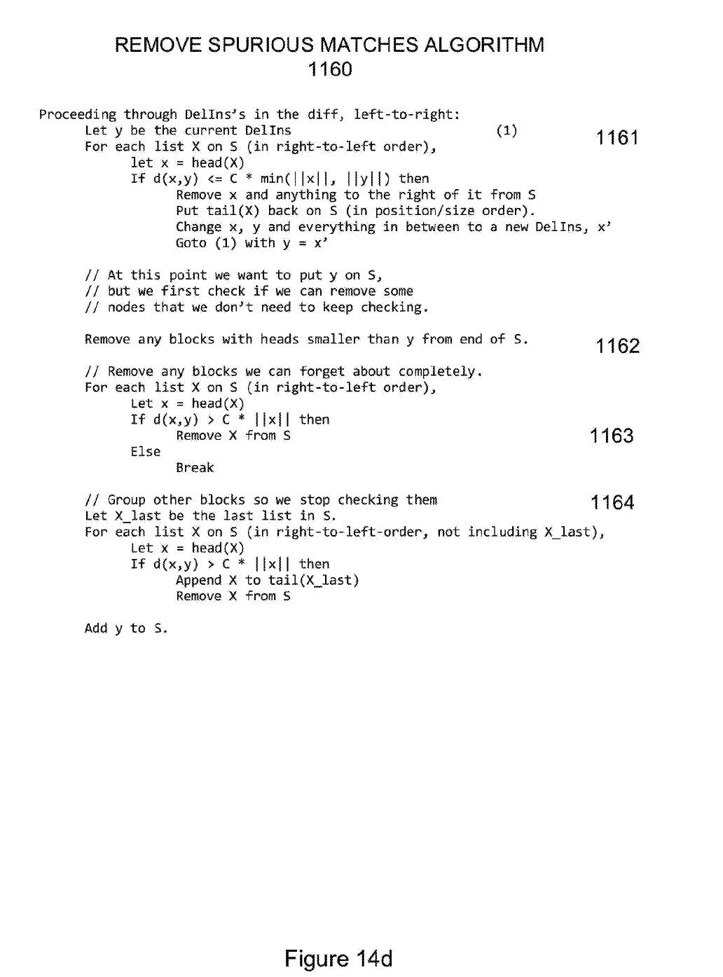

The process is illustrated in FIG. 14a. We take our two input texts A and B, at step 1131. We split them into paragraphs, strip off any trailing newline characters, and we hash each paragraph to a 32 bit integer. We use linear probing to make sure that distinct paragraphs hash to distinct hash values by maintaining a list of which paragraphs hash to a given value. If a paragraph P hashes to a value h(P) that is already occupied, i.e. there is a paragraph Q such that h(Q)=h(P), then we check that paragraphs P and Q are actually identical. If not, we try hashing P to value h(P)+1, and so on.

We then diff the resulting sequences of paragraph hashes using a standard diff algorithm at step 1132. We use Myers' algorithm if the lengths of the input texts are within a ratio of 2 of each other and we use the Smith-Waterman algorithm with affine gap penalties (with a gap opening penalty of 3 and gap extension penalty of 1) otherwise. This gives us a partial alignment of the two texts. Any paragraphs that are aligned in the diff of paragraph hashes will be aligned in our final diff.

At this stage we have partial diff: we know which paragraphs we want to match up in the final diff (i.e. we have identified matching paragraphs in each document) and we have to fill in the rest of the diff. To do this, we apply the next level of our diffing algorithm to unmatched regions between matching paragraphs.

We divide up these unmatched regions into sentences, where a sentence is defined using a predetermined definition, such as a string of at least 25 characters followed by a one of ‘.!?’. We strip off any trailing spaces and we hash each sentence to a 32 bit integer with collisions resolved using linear probing, as for paragraphs. We then run a standard diff algorithm over the sentences at step 1133. Any sentences that are aligned in the diff of sentence hashes will be aligned in our final diff (i.e. we have identified matching sentences in each document which are not within matching paragraphs). This fills in the diff even more.

The diffs within the unmatched regions are independent of each other, so we can do this step of dividing into sentences, hashing and diffing for multiple unmatched regions at once, in parallel.

Proceeding in a similar manner, we divide the remaining unaligned regions into words, strip off any trailing punctuation and space, hash them and diff the resulting sequence of hashes at step 1134 (in parallel, again).

We then restore the punctuation at step 1135 and run the Remove Spurious Matches algorithm at step 1136 illustrated in FIG. 14c and to be described below.

Finally, we run a character-based on diff on the non-matching text regions that remain at step 1137. If the DelIns is not too large, we run a character-based diff on the whole region. Specifically, if the length of the deleted text (the still unmatched text in the left document) is 1_del and the length of the inserted text (the still unmatched text in the right document) is 1_ins, then we run a full character based diff if 1_del 1_ins<40000. We know from our previous step that any remaining DelIns don't have any non-spuriously matching words. So if the DelIns is larger than our threshold of approximately 2000 characters, it's likely that the text within doesn't match and so there's no need to do a character-based diff.

After this step, we typically have a diff that looks pretty good. The global alignment will be right. The diff will look locally wrong (through the eyes of a typical user) though because in the final step we compared the text character-by-character and so there will many spurious matches and other undesirable aspects of the diff. We therefore proceed to the next stage at step 1138, clean up.

Note: The algorithm as described only works if the text is divided into paragraphs and sentences. If the paragraphs are of widely different sizes or there is no consistent or defined paragraph structure, the above algorithm may perform poorly. We can use similar methods to handle this case by breaking the text up at characters that occur frequently such as “the”, and a similar hierarchical diff algorithm is possible.

### Part 2: Making the Diff Look Correct Locally

The functional unit of English is the word, and so meaningful diffs should be diffs on words rather than characters. But just matching on words is often too severe a criterion. For instance, we may still want to show typo correction. The problem is to correct typos, but not actual changes between words which are spelt similarly, for example how can we correct typos like “Pumxpkin” to “Pumpkin” but not changes such as “though” to “through” (or vice versa depending on the user requirements)?

The following steps are described as separate steps but one skilled in the art will recognize that that methods described can be threaded together with each done in alternation so that you only have to proceed through the diff once. The other reason to code these methods in a threaded manner is that changes can cascade; fixing one thing might cause you have to have fix another thing, and so on.

We note that we can rely on the fact that we've already done a word-based diff and then do the character based on small regions, if two words are near to each other by the time we get to the character-based diff, and they almost match, it's really likely we're correcting a typo rather than that the match is spurious. Doing the paragraph, sentence and word-based diffs first dramatically reduces the probability of spurious matches at the character level.

We perform the following clean-up steps: (i) we fix semantic alignment by moving isolated Del's and Ins's around to align edits with word boundaries at step 1142, such as described at https://code.google.com/p/google-diff•match-patch/; and (ii) we invalidate matches in words with insufficient matching characters at step 1143.

We step through the original and new texts word by word and check whether each word passes a test. If the text is in English, then detecting word boundaries is straightforward: e.g., just split the text at whitespace (although this could be refined to deal with dashes etc.). In other languages, however, detecting word boundaries can be less trivial. For example in Japanese, we can use the software “MeCab: Yet Another Part-of-Speech and Morphological Analyzer” available at http://mecab.googlecode.com.

There are a number of possible tests that can be utilised to determine whether or not a word should be invalidated. An example tests is to invalidate matching characters in a word if less than or equal to half the characters in the word are matching, or if there are nonmatching characters in the word that are not contiguous. For example, for the diff:
Eq(“I am the very model of a”). DelIns(“m”, “carto”), Eq(“o”)DelIns(“der”, “ ”),
Eq(“n”), DelIns(“Major Ge”, “i”), Eq(“n”), DelIns(“er”, “dividu”), Eq(“al”)

we can apply this test to the first DelIns to get:
Eq(“I am the very model of a”). DelIns(“modern”, “cartoon”). DelIns(“Major Ge”, “i”), Eq(“n”), DelIns(“er”, “dividu”), Eq(“al”)

We continue to test check the remaining words and we find that the matches in General should also be invalidated. The final diff after this step is:

Eq(“I am the very model of a”), DelIns(“modern Major General”, “cartoon individual”)

The result of performing this step is a diff which more accurately represents the likely edit which was actually made.

We mention that things are a little complicated by the fact that invalidating one word in the original text may cause a word in the new text to become invalid, even though it previously passed the test. For example, consider the diff Eq(“a”), DelIns(“_mi”, “ ”), Eq(“te”). The text in the original document is “a_mite” and in the new document is “ate”. Let's start with the inserted text. Assume we invalidate matching characters in a word if less than or equal to half the characters are matching. Start with the inserted text. 3/3 characters match so it passes. We then consider the deleted text. In “mite”, 2/4 characters match, so it fails and we should invalidate the match. The diff becomes “Eq(a), DelIns(“_mite”, “te”). Now look at the inserted text again. It is now “ate”, and only 1 out of 3 characters match. So now we have to invalidate the word “ate” even though it passed before. The diff becomes DelIns(“a_mite”, “ate”).

Next, we find extra matching characters in matching words at step 1144.

The previous step can leave you with a diff that is obviously non-minimal, which looks wrong. For example it can leave you with a diff Eq(“mat”), DelIns(“e”, “e”), which should be corrected to Eq(“mate”). The reason is that one of the “e” letters could have mistakenly matched a different “e” and this match then got invalidated in the previous step. So each time we invalidate a word, we look at the words in the opposite text that are affected, and we check if we can extend matches to longer matches within the same word.

We then remove spurious matches at step 1150. We use the same algorithm we used in step 1136, which we'll now describe.

In order to eliminate the regions between “big” DelIns that are too “close,” we need to define what that means.

Each DelIns carries with it four character-based indices: (a) the position at which it begins in the old text, (b) the position at which it ends in the old text, (c) the position at which it begins in the new text, and (d) the position at which it ends in the new text.
Definition: Let x and y be two DelIns's, with indices (a,b,c,d) and (a′,b′,c′,d′), respectively where b<b′ and d<d′.

(This last condition, just says that x is “to the left” of y in the diff.)

We define the distance between x and y to be d(x,y)=max(a′−b,c′−d). We also define the length of x to be ∥x∥=max(b−a,d−c). With these definitions, we eliminate the region between x and y if d(x,y)≦f(min(|(|x|),|(|y|)|)), where f is an increasing function, say, a linear function (f)c=Ce, where C is a constant or f(c)=50c/(c+20).

The method we describe here just looks at lengths and distances but it's straightforward to include other considerations. For example, one relevant factor to whether a match is likely to be spurious is how unusual the matching words are, either within the document or within the language etc. For example, there are likely to many uses of the word “the” in an English document, so if the matching text consists only of the word “the”, we should be very ready to mark it as spurious. On the hand, if the matching phrase consists of the name of an entity, for example “Watermark”, that only occurs once in each document, then we should be reluctant to mark a match as spurious. We can accomplish this by looking at the words in the matching text between two DelIns's x and y and determining a “word commonness score” g(x,y) for the matching text segments between those two edits, with common words being scored low and uncommon words high, and changing our test as to whether to eliminate the region to, e.g., d(x,y)+g(x,y)≦f(min(|(|x|),|(|y|)|)), i.e., if the matching text contains uncommon words then g will be large and it will be harder for the inequality to be satisfied and we will be less likely to eliminate the region.

An overview of the algorithm is illustrated in FIG. 14c and pseudocode of the algorithm is shown in FIG. 14d.

We maintain a list S which is initially empty (at step 1151). S is a list of DelIns edits and lists, each of which is a list of DelIns edits and lists, and so on. Formally S has abstract data type
X=|DelIns
         |DelIns*(X list)*
S=X list

We proceed through the DelIns elements in the diff left-to-right. For each DelIns y (steps 1152 and 1161), we check it against each list X on S in right-to-left order at step 1153. For each list X, let x=“head”(X) be the first element in X. We check our elimination criteria for each such x and y. If d(x,y)≦C min(|(|x|)|,|(|y|)|) for some x (step 1154), we convert the region between x and y in the diff to a single DelIns x′ at step 1155, removing any DelIns that were in this region from S at step 1158. We then return to step 1153 with y=x′.

If it is not true that d(x,y)≦C min(|(|x|)|,|(|y|)|), then we do not want to eliminate the region between x and y and we want to put y on S so we can check it against later DelIns. But first we remove DelIns regions from S that will never cause eliminations (step 1156) and group blocks (step 1157) to save on checking.

Referring now to FIG. 14d, the test at step 1162 is included for the following reason: a DelIns x failed to join y because the distance between the two was too great, and x was too small. A DelIns z to the right of y will be further still from x, and since x does not change size, x will never join with z. The test at step 1163 is included for the following reason: If x did not join y, and x would not join an infinitely long y, then x will not join any DelIns z that lies to the right of y, since z is further still from x and is of finite size. The test at step 1164 is included for the following reason: some earlier DelIns only need to be tested if x_“last”=“head”(X_“last”) changes size, so we put them in a list in with X and don't test them unless X_“last” changes size.

Finally, after removing these now unnecessary elements from S, we add the element y to S at step 1158 and continue iterating through the diff.

The particular function f(c)=50c/(c+20) that we gave as example has the addition property that f(c)<50 for all c. If f has the property f<A for some constant A, then a match of ≧A characters will never be eliminated. It is not necessary that f have this property but is useful for two reasons: (i) if, when we detect moves in the next step and require them to be ≧A characters, we will never recover a “move” that the remove spurious code had already marked as spurious, and (ii) whenever a region of at least A matching characters can never be eliminated, so when we cross such a region we can empty the stack S in the algorithm at step 1151. It also means we split the document at matching regions of at least A characters and execute the remove spurious algorithm in parallel on the sections between such regions.

It is possible to do all the above four steps at once, stepping through the diff just one time. This is more efficient, because it only requires one pass through the diff. This is straightforward: we proceed through the diff once and when one test results in a change to the diff, we restart the other tests from the location changed.

### Part 3: Detecting Moves

We here describe how to detect moves.

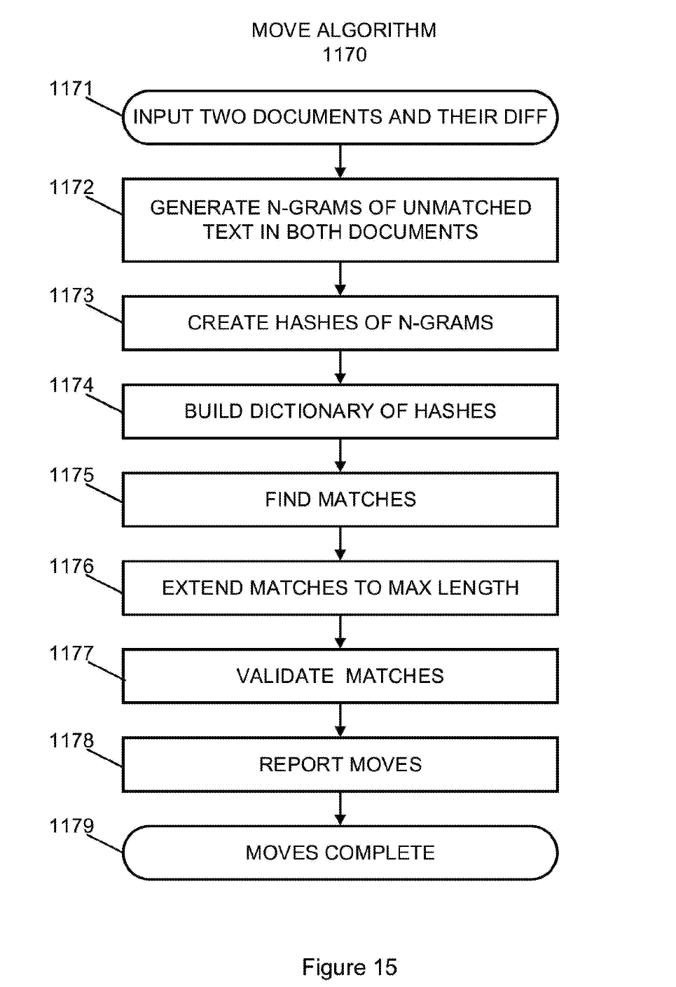

The procedure is illustrated in FIG. 15. We locate moves after first performing a diff on the two documents, so the input to the move algorithm (step 1171) consists of the two documents and a diff of them. We take all the deleted text in the left document and consider the hashed n-grams resulting from taking a hash of each possible set of n contiguous words (steps 1172, 1173). For example if the text is “This is a patent application” then the hashed 3-grams are hash(“This is a”), hash(“is a patent”), hash(“a patent application”). In our application, n≈8 works well, so as to avoid showing trivial moves. We do the same for the inserted text in the right document. We construct a dictionary of hashes at step 1174 in order to find instances at step 1175 where the deleted text and inserted text have a hashed n-gram in common, which implies that that the deleted and inserted text has text in common, i.e., we have detected moved text. For each match found, we extend it backwards and forwards as far as possible at step 1176, while staying within text marked Deleted and Inserted in the diff and while making sure that it does not overlap with a previously reported move at step 1177. A match of m>n words will result in there being m-n common hashed n-grams, so after we find a match we remove those n-grams from the dictionary and look for another match, repeating until there are no further common n-grams. At this point we report a list of the moves found at step 1178.

A related procedure can be used to detect copied text or, alternatively, redundant (previously copied) text that got removed from a document. To identify copied text, the inserted text within the right document is compared to the matching text of the left document. If identical inserted text is found compared to the matching text, then the inserted text can be marked as being copied text. Similarly, to identify redundant text, the deleted text within the left document is compared to the matching text within the right document, and if identical text is found it is marked as redundant text.

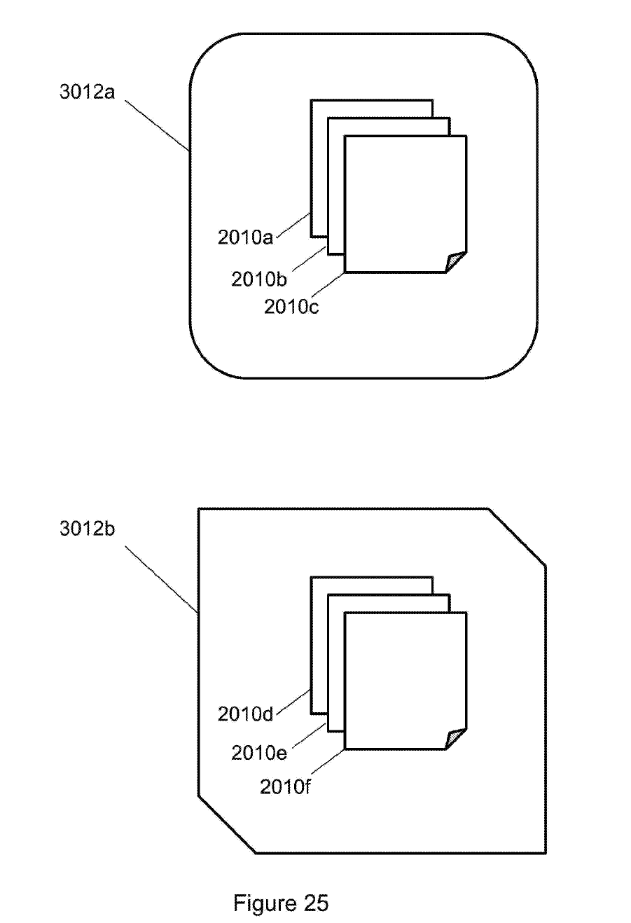

Referring to FIG. 3, a further embodiment is shown, wherein a collection of documents 2010 is made available to the processing server 2004. Referring to FIG. 25, each of the documents 2010a-2010f belongs to a document family 3012, selected from one or more document families 3012. In FIG. 25, and as described herein except where otherwise stated, there are two document families 3012a and 3012b (it is not necessary that each document family 3012 contains the same number of documents 2010). However, in general, for a given collection of N documents 2010, there are between 1 and N possible unique document families 3012.

The documents 2010 can be made available to the processing server 2004 in a streaming fashion, for example, where the processing server 2004 is implemented as a web service, a client device 2006 communicates each document 2010 sequentially via an attached network, such as the Internet. In this case, the processing server 2004 is configured for storing each of the documents 2010a-10f within a memory 2091, 2092 directly accessible to the processing server 2004, such as a volatile memory 2091 or non-volatile memory 2092. Alternatively, each or some of the documents 2010 can already stored within the memory 2091, 2092 of the processing server 2004, for example due to a previous network communication or through use of a physical data transport device, such as a portable USB memory stick. In yet another alternative, the processing server 2004 shares memory 2091, 2092 with a client device 2006, for example due to the client device 2006 and the processing server 2004 being the same physical computer.

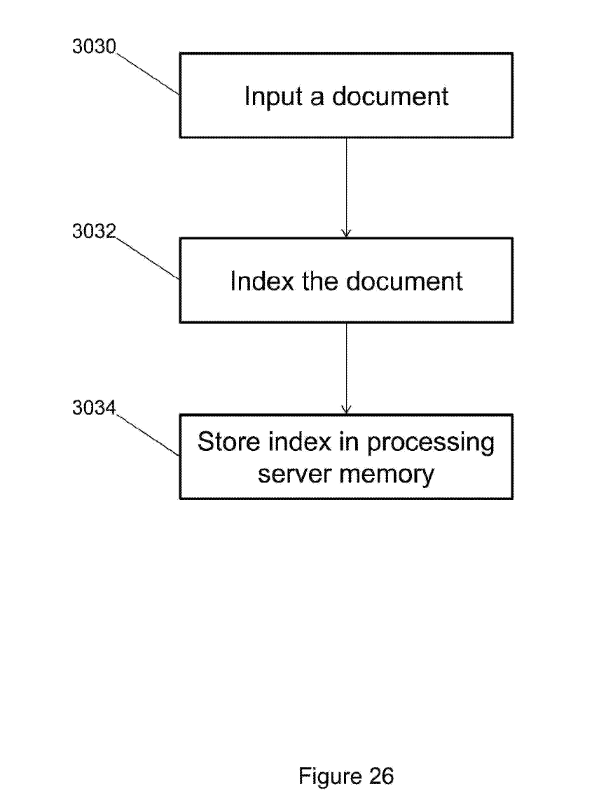

In embodiments, referring to FIG. 26, each document 2010 is provided to the processing server 2004 at input step 3030. The processing server 2004 then indexes each document 2010 at indexing step 3032, producing an index data structure (herein simply referred to as an “index”) for each document 2010. The index of a document 2010 includes information derived from the document 2010 which is information suitable for determining (as discussed below) the document family 3012 of the document 2010. Each index is then stored within a memory of the processing server 2004. Each document 2010 may be input 3030 and indexed 3032 sequentially, or in parallel.

An index of a document 2010 includes information about the document 2010 which is unique for the particular document 2010, or at least sufficiently unlikely to be common to two or more different documents 2010. The purpose of an index is to provide computationally more efficient and/or more accurate data for allowing comparisons between documents 2010. In instances, the index is, or includes, a copy of the original document 2010.

When documents 2010 are described herein as being compared for the purpose of identifying related document families, it is preferable that the comparison is between the indexes of the documents 2010.

An index can include one or more of: fingerprints of the full text of the associated document 2010, for example a bag of words representation of the document 2010, or a bag of n-grams of the document 2010, or hashes of the document 2010, or locality sensitive hashes of the document 2010, or hashes of subcomponents of the document 2010; and metadata about or associated with the document 2010. Such metadata can include information stored within the document 2010, e. g, for a Microsoft Word document, the last modified time, the author, the creation date etc., and/or information about the document 2010 that is not stored within it, e. g, if the document 2010 is stored on a file system, the creation time, last modified time etc. or if the document 2010 is within a document management system, the properties of that document 2010 in the document management system, or if the document 2010 is an attachment to an email, the headers and other properties of the email to which it was attached.

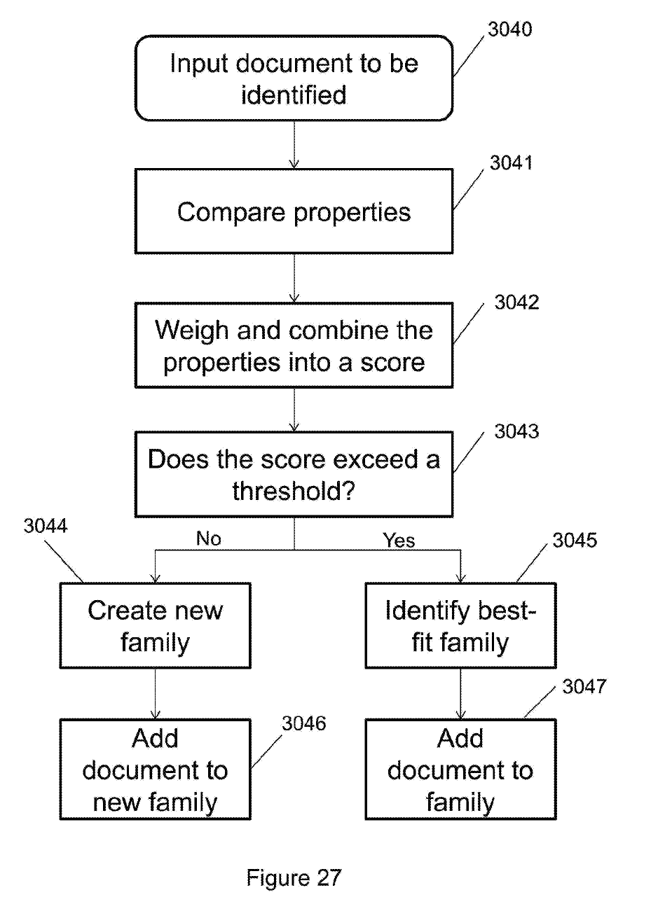

FIG. 27 shows a method for sorting the documents 2010 into the one or more document families 3012. The method of FIG. 27 is implemented by the processing server 2004 after a first document 2010a (the choice of first document can either be arbitrary or random, or based on a predefined rule such as the document with an earliest creation date) has been assigned to a first document family 3012a. Placing the first document 2010a in a first document family is relatively trivial, as it does not require comparison of the first document 2010a to the other documents 2010b-2010f.

A document 2010 is selected which has not previously been assigned to a document family, at selection step 3040. At comparison step 3041, the processing server 2004 compares the selected document 2010 to the documents 2010 that have already been assigned to a document family 3012. The comparison(s) is preferably based on data stored within the indexes associated with the various documents 2010.

Scores are determined representing the similarity of the selected document 2010 to each document 2010 already placed within the document family 3012. Alternatively, or in conjunction, a score is determined representing the overall similarity of the input document 2010 to the document family 3012. In an embodiment, this corresponds to aggregating the scores of each input document 2010 to existing document 2010 comparisons.

Each score can be determined based on a comparison between one predefined property of the documents 2010, or a plurality of predefined properties. For documents 2010 including text, such a Microsoft Word documents, the score can be calculated based on a diff (for example diffs produced by methods previously described) of the input document 2010 and each existing document 2010. Other scoring algorithms can be utilised, providing that they are suitable for accurately scoring the similarity of documents 2010.

When more than one property is compared to determine a score, it can be useful to apply a weighting to the result of the comparison of each property such that properties which are more likely to indicate that two documents 2010 are the same or different are given a higher weight than properties which are less likely to do so. Some weightings may be binary in nature, for example if two documents 2010 have a different file and/or content type (e.g. one is a text document, the other an image), the score is fixed at minimum similarity, even if other comparisons suggest a higher level of similarity.

Some examples of which properties are useful for determining the score include: the document text (in general, document content); document file names, e.g, “Funding proposal.docx” and “Funding proposal v2 final.docx”; in the case of email attachments, that the documents 2010 are sent between common email addresses; document dates; and file types, e. g, it is unlikely that a spreadsheet is a new version of a word processing document, but maybe a PDF and a Word document are in the same family.

The score is compared to a predetermined threshold requirement at threshold step 3043. A score meeting the threshold requirement will result in the input document 2010 being placed in the existing document family 3012 which the score relates (this document family 3012 can be termed a threshold document family). If two or more document families 3012 have an associated score meeting the threshold requirement (that is, there are two or more threshold document families), then a best-fit step is performed 3045 (this can be bypassed if only one document family 3012 is suitable for the input document 2010). The best-fit step 3045 can simply correspond to the input document 2010 being placed in the document family 3012 with the highest associated score. If no document family 3012 has an associated score meeting the predetermined threshold, then a new document family 3012 is created, and the input document 2010 is placed into this document family 3012.

As a further refinement, we might input the various properties into a machine learning algorithm, such as a neural network. The machine learning algorithm can be tuned by initially manually identifying one or more document families 3012 and placing a collection of documents 2010 into these document families 3012, and/or by running the algorithm on a collection of documents 2010 have already been placed into document families 3012, for example, the documents in a carefully collated document management system. The machine learning algorithm then determines the predefined properties and/or weightings utilised for determining scores.

As another further refinement, we might obtain user input about where the algorithm gives incorrect results, for instance, by having the user identify documents 2010 that are placed into incorrect document families 3012, and use this information to tune the predefined properties and/or weights utilised for determining scores. This could also be done on a per-user basis.

In a particular embodiment, the index associated with each document 2010 includes a set of hashes of all or a portion of the 7-grams of the text of the document (the documents 2010 in this embodiment are text documents, however it is clear that other documents 2010 can be used where a hashing algorithm can determine a unique signature of the documents 2010). In this embodiment, the scoring could be the ‘containment’ or ‘resemblance’ method as is described in Broder, “On the resemblance and containment of documents” (IEEE Computer Society, Compression and Complexity of Sequences (SEQUENCES'97), pp. 21-29, 1997), incorporated herein as reference.

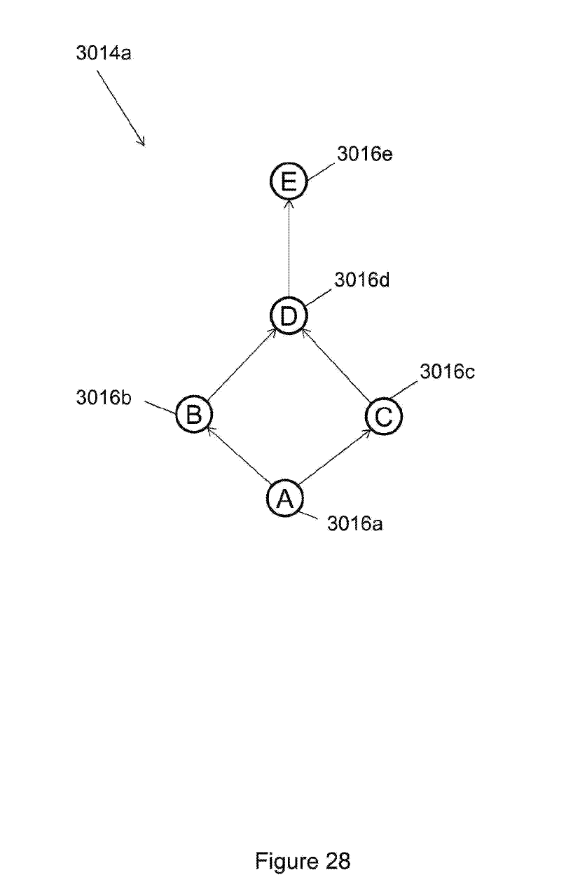

One or more structured document families 3014 can be identified based on the collection of documents 2010 provided to the processing server 2004. An example structured document family 3014 are illustrated in FIG. 28. The structured document family 3014a includes an initial document (3016a) (document A). The initial document 3016a is separately edited to create document B (3016b) and document C (3016c). Documents B (3016c) and C (3016c) are then merged to create document D (3016d). A further edit is made to document D (3016d), resulting in document E (3016e). A structured document family 3014 therefore includes both the individual documents 3016 (which is also true for a document family 3012), and information regarding how each document 3016 depends on the other documents 2010 in the structured document family 3014.

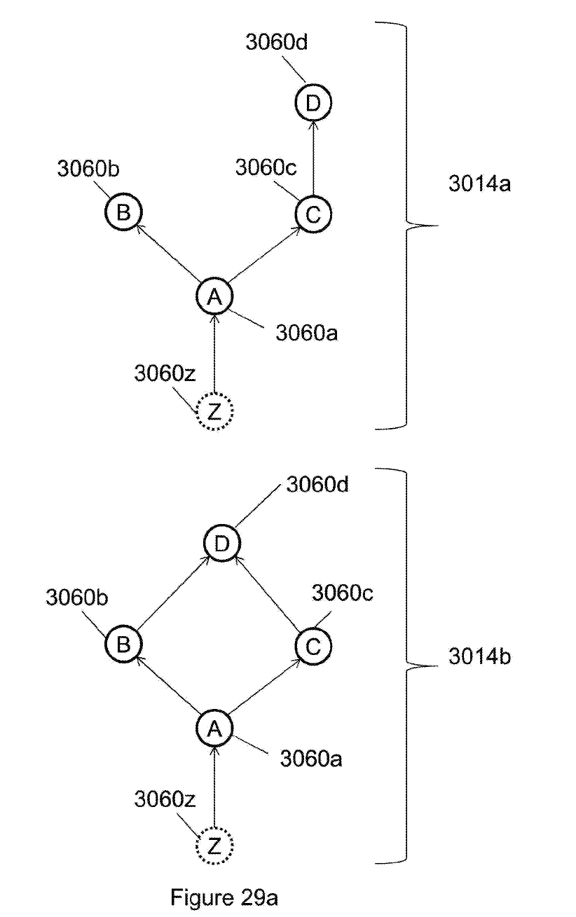

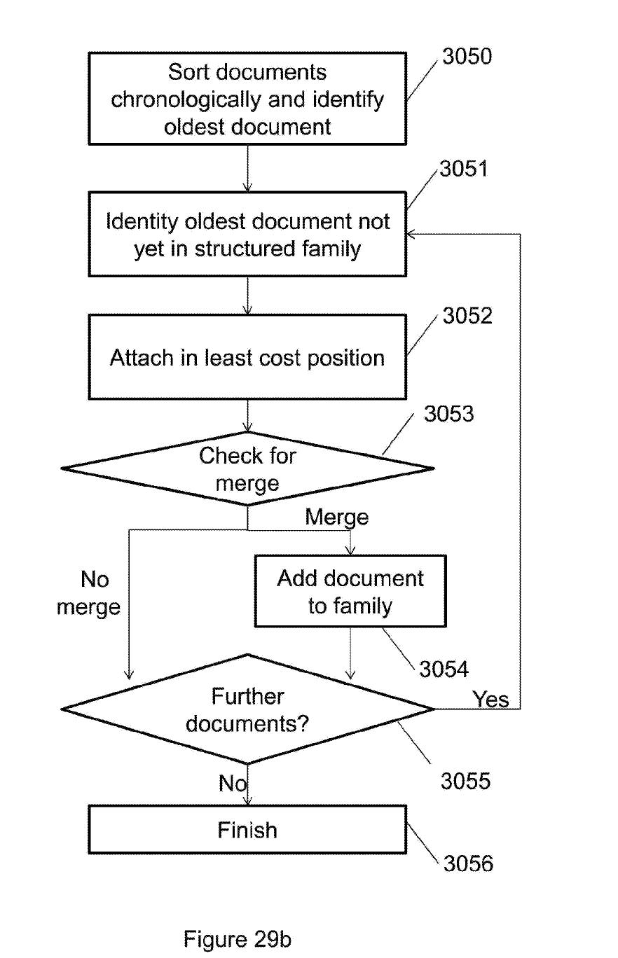

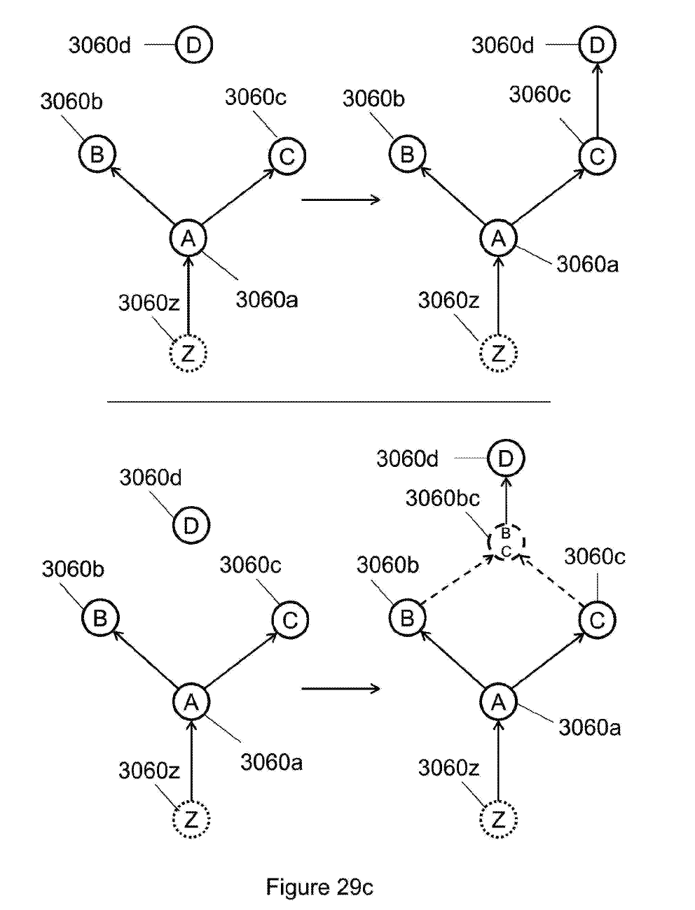

FIGS. 29a to 29c show a technique for sorting documents 2010 (represented as nodes 3060) into one or more structured document families 3014. For the purposes of exposition, it is assumed that the document creation and/or most recent modification date and/or time is accurately known for each document 2010, such that the documents 2010 can be sorted chronologically.

Referring to FIG. 29a, we represent the documents 2010 of FIG. 3 as nodes 3060 on a directed acyclic graph (DAG), where edges connect documents 2010 that were edited into one another. Arrows indicate which node 3060 was edited (tail of the arrow) into a new node 3060 (head of the arrow). We start with an empty node (3060z). To assist with describing the implementation, we define two different example document families 3014a and 3014b, each containing four documents 2010a-2010d, which are different versions of a contract, corresponding to nodes 3060a to 3060d. In general, a node 3060 corresponds to a document 2010, and the terms are used interchangeably herein. It is noted that a node 3060 may correspond to a temporary or virtual document 2010.

For the first document family 3014a, Alice (A) creates the first contract at node 3060a (joined to the empty node 3060z), and then sends it out to Bob (B) and Charlie (C) for review. Bob and Charlie each make edits to the first contract, corresponding to nodes 3061b and 3061c, respectively. Bob and Charlie send their versions of the first contract back to Alice, who decides to make edits only to Charlie's version, creating Alice's second document (D) at node 3060d.

For the second document family 3014b, Alice creates the first contract at node 3060a (joined to the empty node 3060z), and then sends it out to Bob and Charlie for review. Bob and Charlie each make edits to the first contract, corresponding to nodes 3060b and 3060c, respectively. Bob and Charlie send their versions of the first contract back to Alice, who decides to take some or all of Bob's version, and some or all of Charlie's version, and combine it into a new version of the second contract (corresponding to Alice's second document at node 3060d). Alice may or may not add her own further content to the version at node 3060d.

It is necessary to determine the structured document family 3014, in each example. Referring to FIG. 29b, we take the collection of not yet structured documents 2010 in each case and we sort the documents 2010 chronologically at step 3050. We also create a DAG with a single empty node 3060z. At this step, we also attach the oldest document 3060a to the empty node 3060z. We then create the structured document family 3014 by identifying the next oldest document 2010 not yet placed into the structured family 3014, at step 3051. We use a costing algorithm at step 3052 to identifying the “least cost” position to attach the identified document 2010 to within the DAG—that is, the existing node 3060 which corresponds to a document 2010 that is most similar to the identified document 2010 (it may be that the empty node 3060z is the closest matching node 3060). It is then necessary to determine, at step 3053, whether it would be more appropriate to merge two or more existing nodes 3060 and add the identified document 2010 as a merger of the two or more existing nodes 3060. If a merger is more appropriate, the node 3060 corresponding to the identified document 2010 is disconnected from the least cost node, and attached to each of the existing nods 3060 which correspond to the merge, at step 3054. At step 3055, if there are still documents 2010 remaining not yet placed within the structured document family 3014, steps 3051 to 3054 are repeated.

The costing algorithm is configured using predefined parameters to maximise the probability that the correct node 3060 will be identified to which to attach the document 2010 presently being considered. The costing algorithm can be similar to the previously described scoring algorithms, where a high score corresponds to a low cost.

Referring back to our examples described with reference to FIG. 29a, FIG. 29c shows the ways in which we can extend a partially structured document family 3014 to include the fourth document 3060d. In the example of FIG. 29c, we have already determined the correct least cost position for the original document 3060a, Bob's version 3060b, and Charlie's version 3060c.

In the first example, Alice's second document 3060d should attach existing node 3060c. In the second example, Alice's second document 3060d should attach to both existing nodes 3060b and 3060c, and therefore is a merger of these nodes 3060b, 3060c.

We model a merge event as follows: we imagine there is a virtual document 3060bc that is a combination of all the changes in the documents being merged. As an example, assume that Bob edited the second paragraph of Alice's first document 3060a and Charlie edited the fifth paragraph of Alice's first document 3060a. In this case, the virtual document 3060bc would comprise Alice's first document 3060a with Bob's edits to the second paragraph and Charlie's edits to the fifth paragraph. It is not, in embodiments, necessary to actually create the virtual document 3060bc.

In the figures, a node 3060 corresponding to a virtual document is represented by a broken circle, and is labelled with a suffix including the all the suffixes of the merged nodes 3060. For example, in FIG. 29c, the node 3060bc represents a virtual document corresponding to a merger of nodes 3060b and 3060c.

In the case of conflicts, for example if Bob and Charlie both edited a same region of Alice's first document 3060a, we concatenate both Bob and Charlie's changes to the same region. Alice's second version 3060d is therefore an edit of the virtual document 3060bc, the edit corresponding to the necessary amendment to remove the conflict. The same situation can occur if Alice not only merges documents 3060b and 3060c, but performs her own edits afterwards.

In general, a merge can include the merger of any number of nodes 3060, so long as each node 3060 being merged is not an ancestor of any other of the nodes 3060 being merged (for example, we cannot merge Alice's first document with either of Bob or Charlie's documents 3060b and 3060c). If we are merging more than two nodes 3060 and some number of them have changes that conflict, we are able to concatenate all the conflicting changes in an arbitrary order. For example, if we wish to create the virtual document corresponding to the merge of three documents B, C, and D, which have A as their youngest common ancestor, we first perform a three-way merge of B, C with A as ancestor to obtain a merged virtual document BC. We then perform a three-way merge of virtual document BC and D with A as ancestor to obtain a merged virtual document BCD, which can then be costed to determine if this merger actually occurred.

As previously described, it is necessary to provide a suitable costing algorithm which will maximise the probability that the structured document family 3014 identified will correspond to the actual document history.

In general, the idea is to assign a cost to each possible DAG that can be created by the addition of the new document 2010, and then determine the DAG with minimal cost. An edge is assigned a cost corresponding to the differences between the two documents as measured by performing a diff and the cost of the DAG could be the sum of the costs of its edges. A diff is a list of changes required to turn one document 2010 into another. Therefore, the size of a diff will generally inversely correlate with the similarity between the two documents 2010, as a smaller diff will generally imply that the two documents are more similar. In this way, the cost of a diff could be its size, or a function of its size. Some useful techniques for generating diffs are discussed in Australian Provisional Application Number 2013901300.

Referring to FIG. 29c, the costing algorithm determines whether document 2010d best attaches at node 3060b, node 3060c, node 3060a, or the empty node 3060z, without considering merges. For example one, Alice's second version 3060d includes some or all of the unique content of Charlie's version of the first contract, and this common content will be absent from the diff of these two documents 2010. In contrast, in order to move from Bob's version 3060b to Alice's second version, in addition to the content within the diff between 3060c and 3060d, the changes made by Bob must be undone (represented adding the diff between Bob's version 3060b and Alice's first version 3060a to the previously calculated diff), followed by the changes made by Charlie to Alice's first version 3060a being added to the previously calculated diff, resulting in a larger diff for moving from 3060b to 3060d, than moving from 3060c to 3060d. Also, in order to move from Alice's first version 3060a to her second version 3060d, the changes made between 3060a and 3060c must be added to the diff between 3060c and 3060d. Therefore, the diff between 3060b and 3060d, as well as the diff between 3060a and 3060d, must necessarily be larger than the diff between 3060c and 3060d, and therefore the costing function will identify node 3060c for attaching node 3060d (that is, Alice's second version attaches to Charlie's version).

In the case of attaching to the empty node 3060z, the cost will be equivalent to adding to the empty node 3060z all the content of the incoming document (e.g. Alice's second document 3060d). In an embodiment, a further cost is incorporated for adding to the empty node 3060z, which can optionally be based on other properties of the documents, such as filenames. The purpose is to, as required, increase or decrease the probability of attaching to the empty node 3060z.

The cost function used to assign costs to edges may depend on various other methods of document closeness, either in conjunction with the diff sizes or alternatively to the diff sizes. Examples of such other methods have previously been described in reference to placing documents 2010 into document families 3012. For example, if each document 2010 has a filename including a suffix indicating version number, this can be utilised to assist in determining the structured document family 3014. The cost function may be a weighted sum of various properties, using predefined fixed weightings. Alternatively, dynamic or learning weightings can be used, for example through the use of machine learning algorithms.

It may be that performing a diff on all document pairs is computationally expensive. In embodiments, therefore, the index associated with each document 2010 includes a signature, which is a representation of the document 2010 utilising less data than that contained in the document 2010, and/or represented in a manner better suited for document 2010 comparisons.

In an example, the signature comprises a set of hashed n-grammes, where the set of hashed n-grammes is some subset of the hashes of consecutive sets of n words in the document. We then obtain a course variant of a diff between a first document and a second document by differencing the signature of the first document and the signature of the second document. The cost of the diff is the size of the difference.

Likewise, we can construct a set of hashed n-grammes corresponding to a virtual document by performing a three-way merge on the signatures of documents, rather than on the documents themselves. Suppose that we wish to construct the signature of a virtual document BC obtained by merging B and C with base document A. Let S_X denote the set of the signature of a document X; let S_X\S_Y be the hashes in the signature of X that are not in the signature of Y. Then the signature of the virtual document BC is (S_B intersection S_C) union S_B\S_A union S_C\S_A. This is chosen to be approximately the same as what one would get if one actually created the virtual document BC and computed its signature. Note that this method generalizes naturally to more than two documents. An advantage of using this method instead of performing a diff is that we only need to store the document signatures, and not the full-text of the documents, and this has benefits in terms of user privacy, because this method then allows indexing and structuring the users' documents without having to retain the users' documents.

We now describe how to check whether a merger of two or more documents 2010 better fits what actually occurred than directly attaching an incoming document 2010 to an existing node 3060. In the present embodiment, merges are given a cost of zero (or free). This only applies to edges incoming to a virtual node (such as 3060bc). In addition to determining the cost of each DAG corresponding to the addition of a document 2010 to an existing node 3060, we consider the cost of each DAG corresponding to the addition of the document 2010 to any of the possible unique virtual nodes (such as 3060bc), each corresponding to the merger of two or more existing nodes 3060 (as described previously).

We consider all possible merges, compute the virtual document representing each merge, and calculate the difference between each virtual document and the incoming document 2010. If there is a merge scenario that results in lower cost than attaching the document directly to a node 3060, then we instead extend the DAG with a merge.

If the DAG is large, there may be a large number of merge scenarios and it will be computationally expensive to compare the incoming document with all possible virtual documents. In an embodiment, in order to reduce the computing cost, we use the following greedy algorithm. As before, we compute the distance between the incoming document 2010 and existing nodes 3060 in the DAG. We attach it in the least cost position. We then consider the node 3060 in the DAG that has the next-lowest distance to the incoming node 3060. We then attempt to reduce the cost of the DAG by computing and adding a virtual node AB and attaching the incoming document to node AB. If this reduces the cost, then instead of attaching the incoming document to the lowest cost node 3060, we introduce a merge between the two nodes 3060 and attach the incoming node 3060 to node AB. Continuing on, we consider adding further nodes to the merge in order of their distance to D, until we are unable to reduce the cost further.

A diff used to calculate the cost of an edge preferably allows for the possibility of low-cost moves. This is due to the way in which we deal with conflicts. For example, suppose Alice is writing a thesis and she creates a document A consisting of chapter 1 and a document B consisting of chapter 2. She then concatenates the documents to obtain her thesis C which consists of chapter 1 followed by chapter 2. We want to show this a merge of document A and document B. Let us walk through the method described here given documents A, B, and C. Documents A and B are presumably quite different so would both be attached to the empty node 3060z. We want to think of C as a being closest to a virtual document AB generated by merging A and B. The virtual document comprises either (i) the text of A followed the text of B, or (ii) the text of B followed by the text of A, depending on which way round the merge put the text. In case (i), the virtual document is precisely C, so C will be correctly structured as a merge of A and B. In case (ii), the texts from A and B are ordered the wrong way around, but C will still be close to AB if it is a low cost operation to move the text from B from the start of AB to the end of AB.

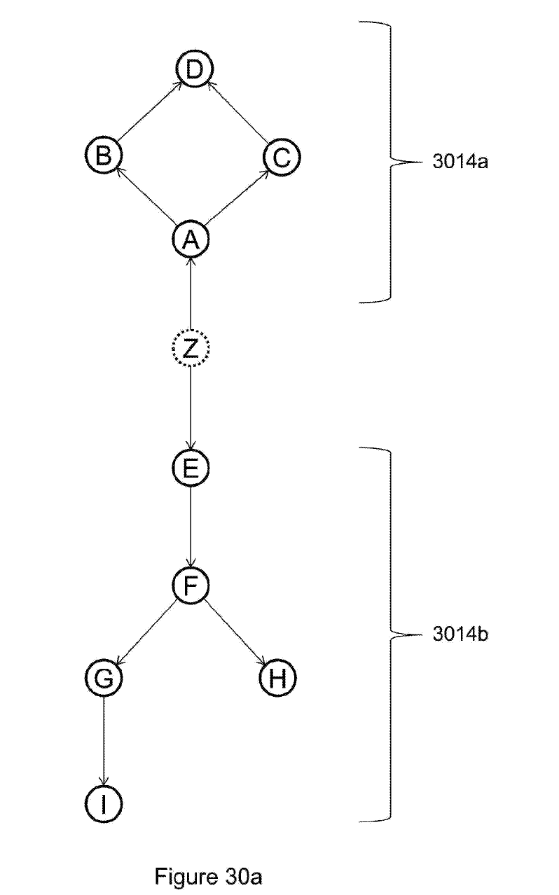

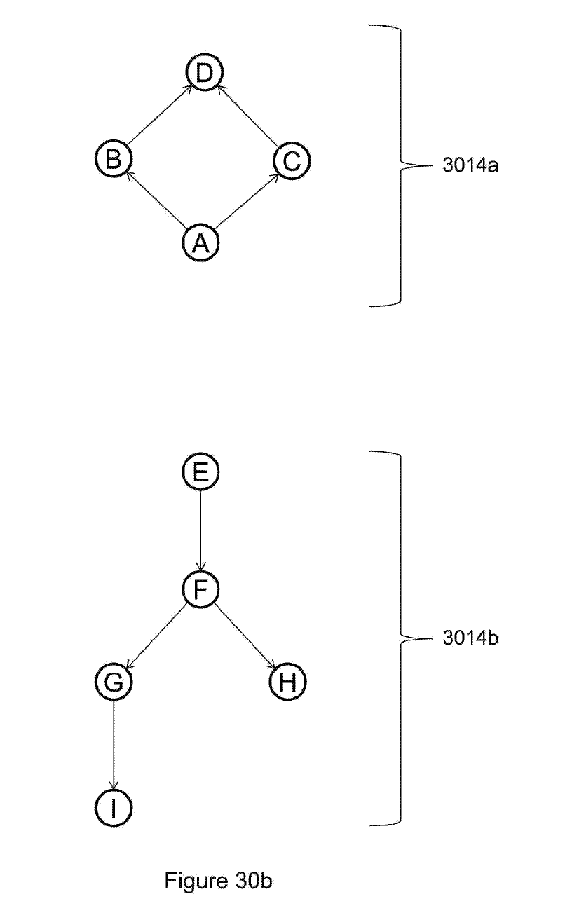

The result of the method of FIG. 29b may be a structured document family 3014 actually made up of two or more separate structured document families 3014, for example the two structured document families 3014a and 3014b shown in FIG. 30a. In order to reduce to the two or more structured document families 3014, all that is required is to remove the empty node 3060z (shown in FIG. 30b). Thus attaching a document 2010 to the empty node 3060z corresponds to placing the document 2010 in a new structured document family 3014; attaching the document elsewhere corresponds to placing it into an existing structured document family 3014.

In embodiments, the empty node 3060z is omitted, and instead we start with an empty DAG and, if a document 2010 does not meet a predefined threshold to be joined to an existing node 3060, it is added as disconnected node 3060 in the DAG. The predefined threshold can be determined in a similar manner as described with reference to placing a document 2010 into a document family 3012.

In embodiments, account is taken of common documents, such as standard templates, which are common to documents 2010 which otherwise should be placed in different document families 3012. Document templates for example are often found in the knowledge management systems of a law firm. In order to avoid documents 2010 derived from common documents incorrectly locating into the same document family 3012, we treat the common documents as intermediate documents 2010 which are typically attached to the empty node 3060z, and we remove these intermediate documents 2010 along with the empty node 3060z.

In the above we have described how to structure a collection of documents 2010 assuming that the documents 2010 have timestamps and can be chronologically ordered. In general, the methods described above can be utilised with collections of documents 2010 where chronological ordering is not possible. In an example, we utilise known techniques for constructing a minimum cost tree representing an ordering of the documents 2010 (such as techniques utilised in phylogenetic tree reconstruction). An ordering induced by the minimum cost tree, for example a breadth-first ordering, can then be utilised in place of a true chronological ordering in the methods described previously.

In embodiments, once we have determined the structured document family 3014 relating to a particular document 2010, we automatically generate a comparison of the particular document 2010 with one or more previous versions of the document. The one or more previous versions may be parents of the document 2010. Alternatively, the previous version is the immediately preceding version of the document 2010. In another alternative, the previous version can be determined based on properties of a user viewing the document 2010, for example the previous version can be the immediately preceding version created by the particular user.

In further embodiments, use of the method described above to reconstruct a structured document family 3014 means that we can detect when there are multiple unmerged versions of a document 2010. We can automatically merge these, or allow a user to authorise such a merger.

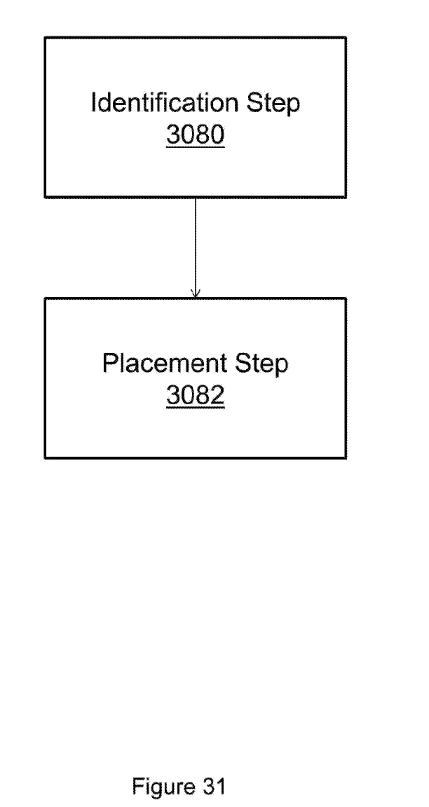

Referring to FIG. 31, a method is described wherein a watch is maintained to record newly edited versions of documents 2010, and also newly created documents 2010. In essence, the processing server 2004 is configured to identify such newly edited or created documents 2010 at identification step 3080. In response to a document 2010 being identified, the processing server 2004 utilises methods previously described to place to document 2010 into an existing document family 3012 (preferably a structured document family 3014), or as necessary a new document family 3012, at placement step 3082. The processing server 2004 can maintain a database within its memory for recording the document families 3012. The processing server 2004 can optionally also store copies of each document 2010 that is identified at step 3080.

We can add this functionality to the file system. For example, in an embodiment that's implemented in Microsoft Windows, we add right-click items like “Show history”, “Go to latest version”, etc. Furthermore, we can alert the user if they start editing an old version of a document. For example, in Microsoft Word, we hook the document open event and, whenever a document is opened, we look up the document in the database and check it is the latest version. If it is not, we display a message warning the user that they are not editing the latest version of the document.

In further embodiments, the documents include attachments to email messages, and/or email messages themselves. The email is stored either in a cloud email service such as Google's Gmail, locally on a user's computers, or on the network, for example on a Microsoft Exchange server. When used in a cloud email system, such as Gmail, the user interacts with Gmail through their web browser. Installed in the web browser is a browser extension, which interacts with the processing server 2004. The method of FIG. 31 is utilised, with the processing server 2004 configured to identify attachments, corresponding to new documents 2010, within incoming and outgoing emails.

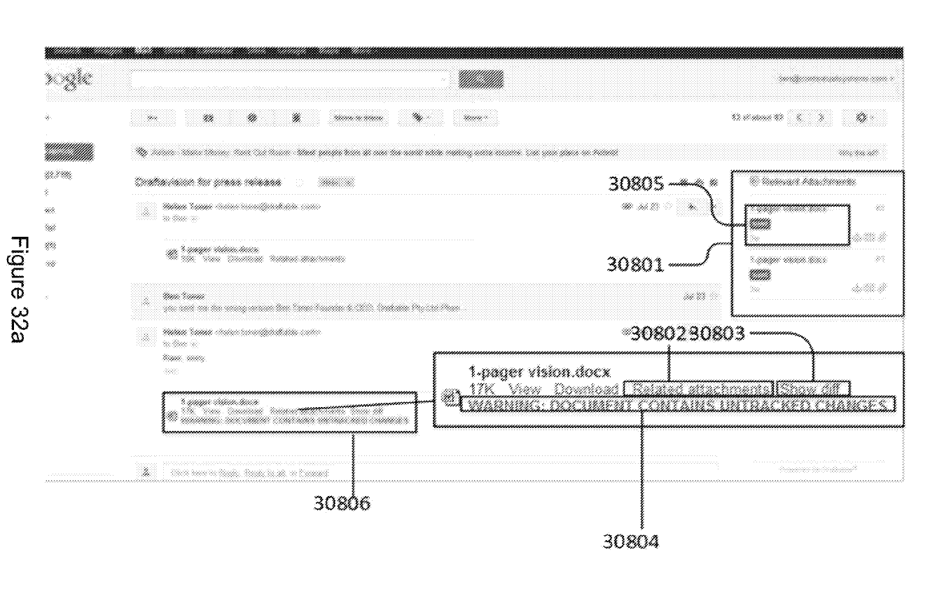

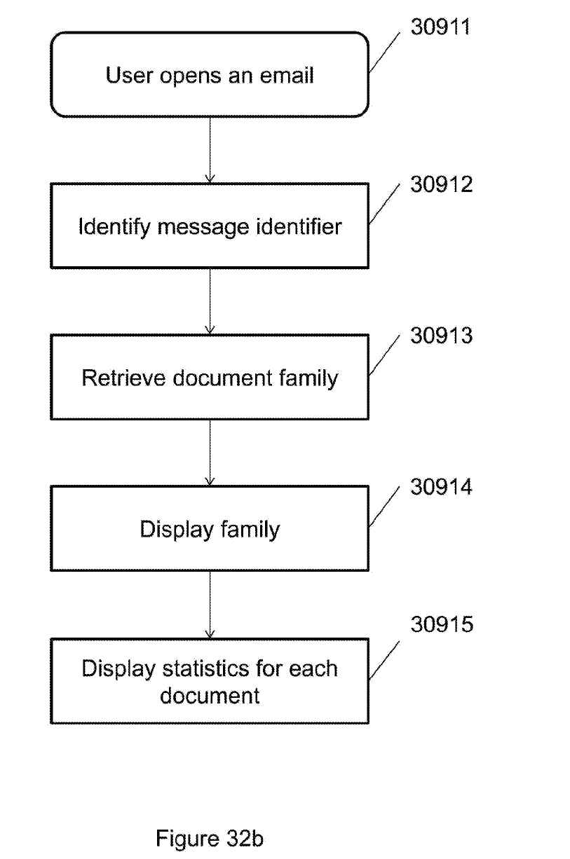

FIG. 32a illustrates the user interface of the web browser extension when used with Google's Gmail. When the user selects an email message in a thread that has one or more attachments, the browser extension displays a sidebar 30801. The user can select a document of interest from the set of attachments in that thread, after which the document family of that document is displayed. A document in the document family is shown on a card 30805, together with a selection of the metadata about that document, such as whether the document was sent or received by the user, when it was sent/received, how many pages/words it contains etc. etc. On hovering over a card, further metadata of the document is displayed in a modal windows, as well as preview of the message that the document was attached to, in order to enable the user to quickly locate a particular document within the document family. We identify if the document is a duplicate of another document. Also on the card are buttons to enable the user to download the document, navigate to the email message to which the document was attached, and to create a new message that contains the document.

We also modify the region of an email where the attachments are displayed 30806. We add a link 30806 that shows the family of the document in the right-hand sidebar and a link 30803 that launches a comparison of the document with the previous version in a modal window.

The logic of how this works is illustrated in FIG. 32b. When the user opens an email 30911, the browser extension identifies an identifier of the message 30912, which in the case of Gmail is an integer encoded into the URL, and requests details of the document family from the server 2004. The server looks up the email in the database 2095, and returns details of any document families that contain an attachment in the same thread as the message at step 30913. We then display details of the attachments in the thread in the sidebar 30801. If the user selects an attachment, we display its document family at step 30914 and statistics about the document at step 30915 as described above.

Having identified a document family, we can display various statistics about it, for instance, we can display a graph that illustrates the word count over time, or the contribution of the various contributors to the document over time. To do the latter, we add an extra step after identifying a structured document family. We diff any documents that are connected by edges in the DAG and store the diffs. Alternatively, if we had computed diffs to determine which edges to include in the structured family, we could have stored the diffs at that time and just reuse them now. We can compute from the diffs statistics such as number of characters/words added or deleted and display these on the document card 30805. We can use the statistics for all documents in a family to plot a graph of the work done by each contributor to a document family over time.

In further embodiments, once we have a structured document family 3014 and corresponding diffs between the documents 2010 within the family, we can trace individual words through a particular document 2010 to construct a document 2010 where each word is coloured based on who wrote it.

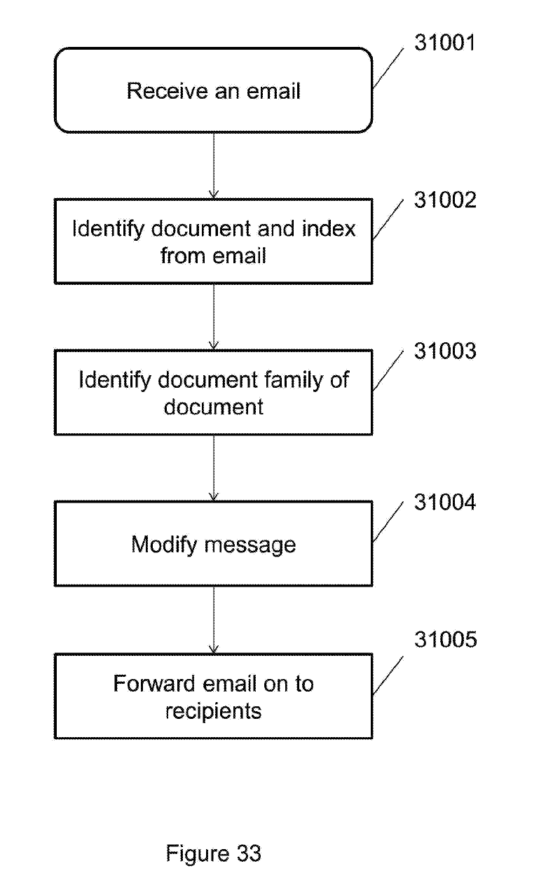

In FIG. 33, we describe a further embodiment. Described is a method to provide an email mailing list that keeps track of the documents that are attached to messages sent to the list. The method may be implemented by an SMTP mail server. On receiving a message for the list at step 31001, we extract and store the attachments and index them at step 31002 as in the email embodiment described above. We identify a document family of each document at step 31003. We do this while holding the email message in the SMTP server. We then modify the email message at step 31004 by adding information about the document, the information comprising a link to diff of document with the previous version (or we attach the diff to the message as an extra attachment), and possibly statistics, such as how many words changed etc. We then forward the modified message to the recipients at step 31005.

In various embodiments, we use our knowledge of the grouping of the documents 2010 into document families 3012 or structured document families 3014 to improve search on the documents 2010, for example searching for a document 2010 by filename and/or full-text search. We can select only the latest versions of documents 2010 (for example, only the latest file chronologically from each document family 3012; alternately, those elements in a structured document family 3014 that do not have any outgoing edges) to be returned as search results, or alternatively we can return document families 3012 or structured document families 3014 instead of documents. Either of these alternatives allows the user to avoid looking through old versions and/or duplicate items in the search results. Note that we may utilise the index that we maintain to identify document families as an index for search, or we may use a separate index.

In a further embodiment, a document 2010 is a directory of files on a file system. The directory may be copied onto more than one computing device and the files therein may be modified by multiple people. The documents to be structured are snapshots of the directory taken at a particular moment in time and on a particular computing device. The method described above to reconstruct a structured document family 3014 could then be used to reconstruct the branching and merging history of the directory.

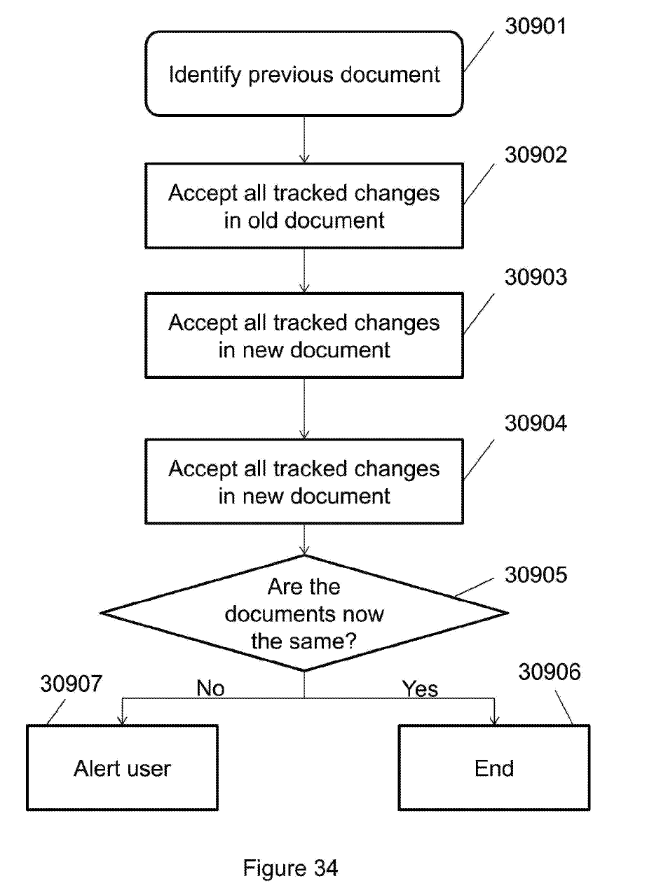

FIG. 34 shows a further embodiment. Suppose a user works with Microsoft Word documents that contain tracked changes (or some other file format with explicit change tracking embedded in the document). As track changes have to be manually turned on, there is always the risk that some changes that are not recorded as tracked changes will be present in a document. This is a risk because a user may overlook these changes and mistakenly, for example, agree to modified terms of a contract of which they were unaware. The method of FIG. 34 reduces the risk of modifications being overlooked. For an incoming document, the first step is to identify the previous version of the document at step 30901, the “old” document. We proceed by accepting all tracked changes in the old document at step 30902, and if those tracked changes have not yet been accepted in the new document, to accept them in the new document as well (step 30903), i.e., to accept tracked changes in the new document that date from the old document or earlier. We then reject any tracked changes that remain in the new document at step 30904. If all changes from the old document to the new document are tracked, then it should be the case these two documents produces are the same or at least that they have the same content. We check this at step 30905 and if there are any differences, we alert the user at step 30907. In the embodiment implemented in Gmail, we might do this next to the attachment, as illustrated in FIG. 32a at 30804.

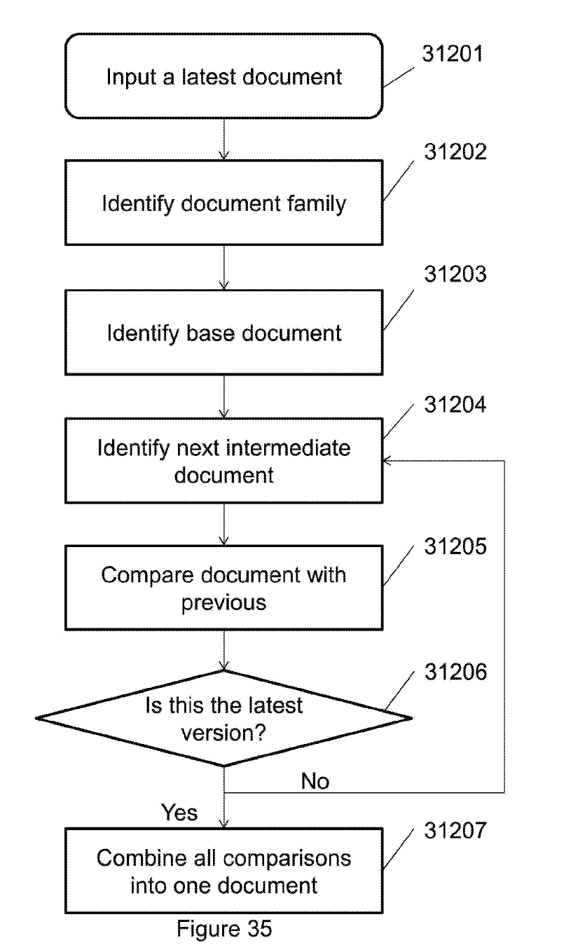

FIG. 35 illustrates another aspect of the invention, namely a method to generate an extended diff of two documents. Suppose a law firm is drafting a contract for a client. A senior associate at the law firm might create a first version and email it to their client, who sends back some changes and raises some issues. The senior associate might then pass the contract to a junior lawyer, who works on the contract and returns it to the senior associate. The senior associate fixes the junior's work and sends it to a partner at the firm for review. This cycle may repeat a number of times. Ideally the document being reviewed by the partner would show the changes since the partner last reviewed it, marked up in a way that shows which changes were made by the other individuals at the partner's firm and which were made by the client. Instead, what typically happens is that document the partner reviews is marked up with whichever changes have occurred since someone last accepted the changes, which may not correspond to the changes since the partner last saw the contract, so instead of just reviewing what changed, the partner has to read the entire document again.

We describe a method to construct a document where the tracked changes in the document correspond to those changes made since the partner last opened or reviewed or emailed the document. Given a latest document at step 31201, we identify the document family at step 31202, which may be explicit if for example, the document is stored in a document management system, or which may be determined utilising the document family identification or structured document family identification methods described herein. We then identify a base document, being the document that the partner last looked at, for example because they opened or emailed or reviewed it (step 31203). If the documents are stored in a document management system we might do this by looking at logs of the document management system; if they receive the document via email, we might add hooks to the partner's email client to monitor when the partner opens a document. Alternatively, rather than automatically identifying the base document, we might provide a list of all previous documents in the same document family for the partner to select from, or we might provide an annotated list of previous documents in the same document family for the partner to select from, where the annotations include suggestions as to which document should be the base document, e.g., by indicating that document has previously been opened by the partner. Once we have identified the base document, we consider all intermediate documents between the base document and the latest document (step 31204). Taking them in chronological order we compute the changes between the base document and the first intermediate document (step 31205), and then the changes between the first intermediate document and the second document (step 31205), and so on, until we reach the latest document (step 31206). We then playback the changes sequentially on top of the base document, until we obtain the latest document at step 31207. More precisely, we accept the changes in the base document, and then use the comparison with the first intermediate document to add those changes to the base document as tracked changes with the correct author. We take the resulting document and use the comparison between the first intermediate and second intermediate documents to mark up those changes as tracked changes on top of the tracked changes that are already present. Eventually we are left with the latest document with all changes made, starting with the base document, marked up.

Referring to FIG. 3, there is shown a collection of documents 2010 made available to the processing server 2004, and stored within a memory 2091, 2092 of the processing server 2004. The documents 2010 are related to one another, in the sense that each document 2010 is an earlier and/or later version of another document 2010. In the present embodiment, each document 2010 has an associated ordering property, for example document version indication or last modification time indication. For the purpose of illustration, the earliest document 2010 is document 2010a, with subsequent documents 2010 labelled in alphabetical order. Therefore, it can be thought of that document 2010b is an edited version of document 2010a, document 2010c of document 2010b, etc. For various embodiments described herein, reference will be made to the collection of documents 2010 shown in FIG. 3. It is understood that the content of the documents 2010 need not be consistent for different embodiments and examples. It is also understood that embodiments and examples referring to only a subset of the documents 2010 may be generally applicable. It is further understood that the methods described herein are applicable to the case where the documents 2010 are represented as nodes 3060 on a directed acyclic graph (DAG), where edges connect documents 2010 that were edited into one another, as shown in FIG. 29a.

A comparison between any two of the documents 2010 can be created, which allows for differences between the documents to be displayed to a user. A data structure for recording the comparison may be referred to herein as a “diff” and the process of creating the diff may be referred to as “diffing”. One useful algorithm for diffing is disclosed in Australian provisional patent application number 2013901300, incorporated herein by reference. The prior art diff data structures comprise a list of alternating data elements (“diff elements”) selected from “equal regions” (Eq) and “deletion/insertion regions” (DelIns). The data structure can be utilised to create a comparison document, which displays changes (differences) between the two documents 2010. Such a comparison document can be created by analysing each data element of the associated diff in sequence from beginning of the diff (corresponding to the beginning of the comparison document) to the end of the diff (corresponding to the end of the comparison document). Equal regions correspond to regions in each document with the same content, and deletion/insertion regions correspond to regions in each document where content has been removed and/or inserted.

A diff according to embodiments is now described. The diff data structure described is modified to include position information indicating the corresponding positions within the two documents 2010 for each Eq and each DelIns. Without loss of generality, reference will be made to an “original” document 2010a and a “modified” document 2010b. As will be apparent, a diff does not require the original document 2010a to have been created or last modified earlier than the modified document 2010b, and such labels are merely convenient. Rather, the diff will record changes between the original document 2010a and the modified document 2010b as deletions from the original document 2010a and insertions into the modified document 2010b. In each case, the changes are merely regions of each document 2010a, 2010b that are not present in the other document 2010a, 2010b.

For illustrative purposes, the text of two documents and the associated diff is described below.

Original Text (Document 2010a)
Evidence from other markets suggests that generating units have a strong commercial interest to bid capacity competitively in the spot market.
Modified Text (Document 2010b)
The evidence from the England and Wales power markets is that generating units have a strong commercial interest to bid capacity at marginal cost, in the spot market.

### Corresponding Diff Data Structure

TABLE 1
Example diff

| | Position | Position | | | |
|---|---|---|---|---|---|
| No. | (Original) | (Modified) | | | |
| (i) | Pₒ | Pₘ | Type | String 1 | String 2 |
| 0 | 0 | 0 | DelIns | “E” | “The e” |
| 1 | 1 | 4 | Eq | “vidence from“ | “” |
| 2 | 14 | 17 | DelIns | “other” | “the England |
| | | | | | and |
| | | | | | Wales power” |
| 3 | 19 | 45 | Eq | “markets“ | “” |
| 4 | 28 | 54 | DelIns | “suggests” | “is” |
| 5 | 36 | 56 | Eq | “that generating | “” |
| | | | | units have a strong | |
| | | | | commercial interest | |
| | | | | to bid capacity” | |
| 6 | 109 | 129 | DelIns | “competitively” | “at marginal |
| | | | | | cost” |
| 7 | 122 | 146 | Eq | “in the spot | “” |
| | | | | market.” | |

(note:
position 0 corresponds to the first letter in each document, and the column “No.” indicates the diff element number, which may or may not be recorded explicitly in the diff).

As Eq data elements correspond to the same content present in each document, there is no requirement for two strings associated with an Eq data element. However, DelIns data elements do correspond to either one or both of content deleted from the original document 2010a (string 1 in Table 1) and content inserted in the modified document 2010b (string 2 in Table 1). Generally, it is not a requirement that each of the two strings of a DelIns data element include content. For example, a deletion of the word “Evidence” from the original document without a corresponding insertion into the modified document can be expressed as (noting the generalised position variables Pₒ and Pₘ):

TABLE 2
Example of a DelIns corresponding to only deleted text.

| Position | Position | | | |
|---|---|---|---|---|
| (Original) | (Modified) | Type | String 1 | String 2 |
| Pₒ | Pₘ | DelIns | “Evidence” | “” |

An insertion of the word “Evidence” into the modified document without a corresponding deletion in the original document can be expressed as

TABLE 3
Example of a DelIns corresponding to only inserted text.

| Position | Position | | | |
|---|---|---|---|---|
| (Original) | (Modified) | Type | String 1 | String 2 |
| Pₒ | Pₘ | DelIns | “” | “Evidence” |

Regarding notation, Pₒ corresponds to position information indicating the relative position of the deletion string (String 1) or equal string (also String 1) in the first (or “original”) document 2010. Pₘ corresponds to position information indicating the relative position of the insertion string (String 2) or equal string (String 1) in the second (or “modified”) document 2010. Pₒ and Pₘ are recorded within the diff data structure.

The described diff is suitable for identifying a corresponding region within one document 2010 associated with a selected region of another document 2010, when a diff has already been created for these documents 2010. The position information recorded within each diff element allows for the position in each document 2010 associated with a particular Eq or DelIns to be quickly identified.

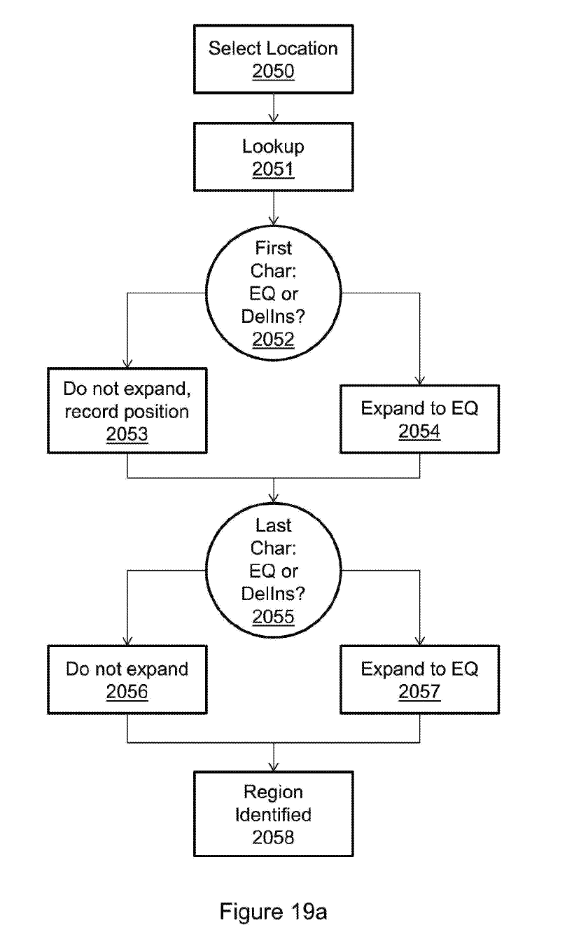

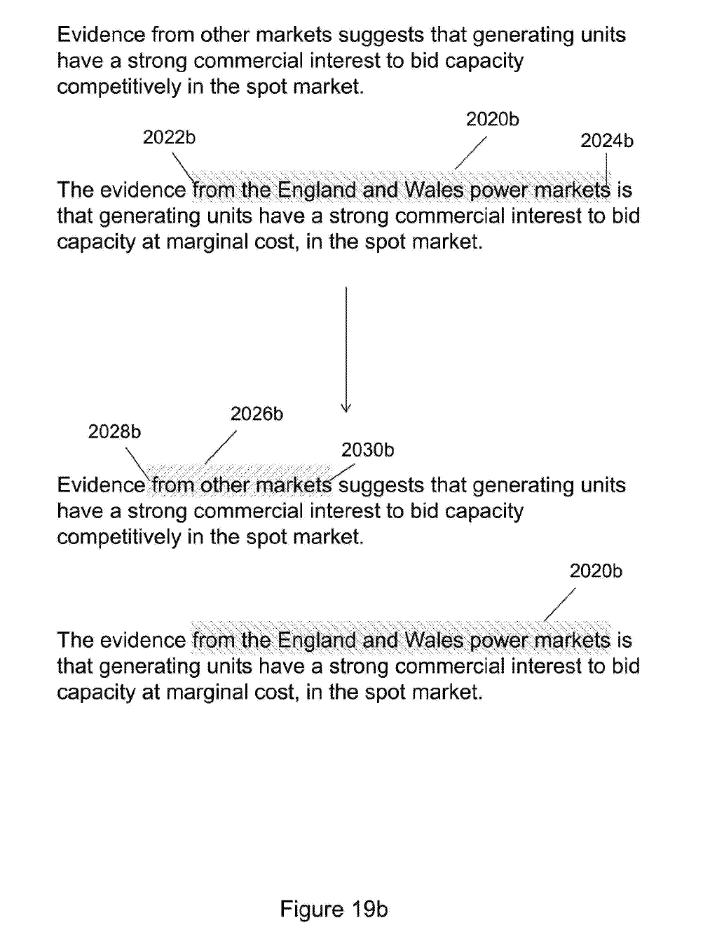

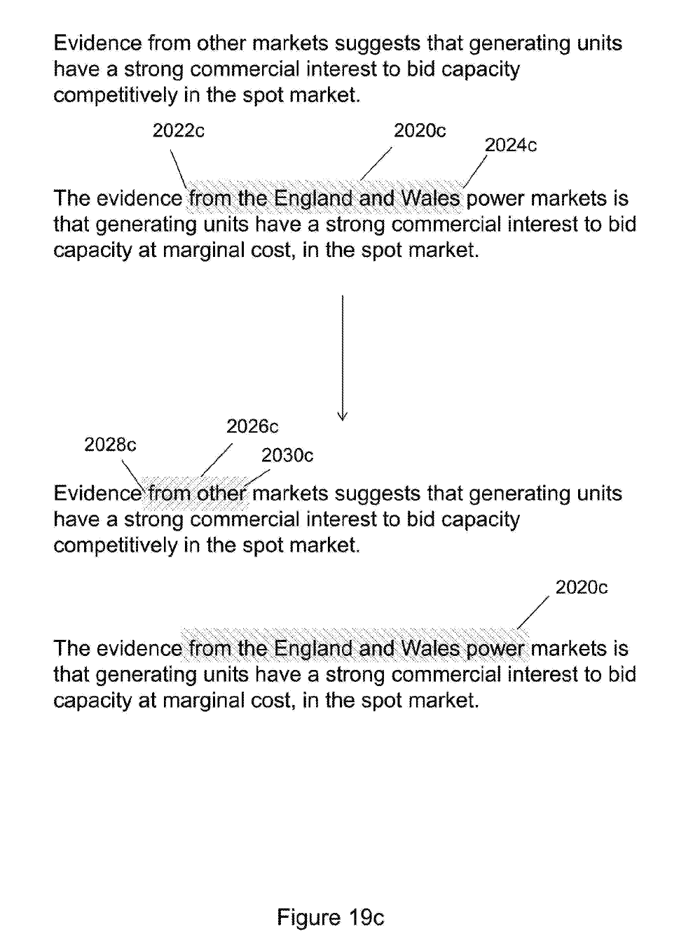

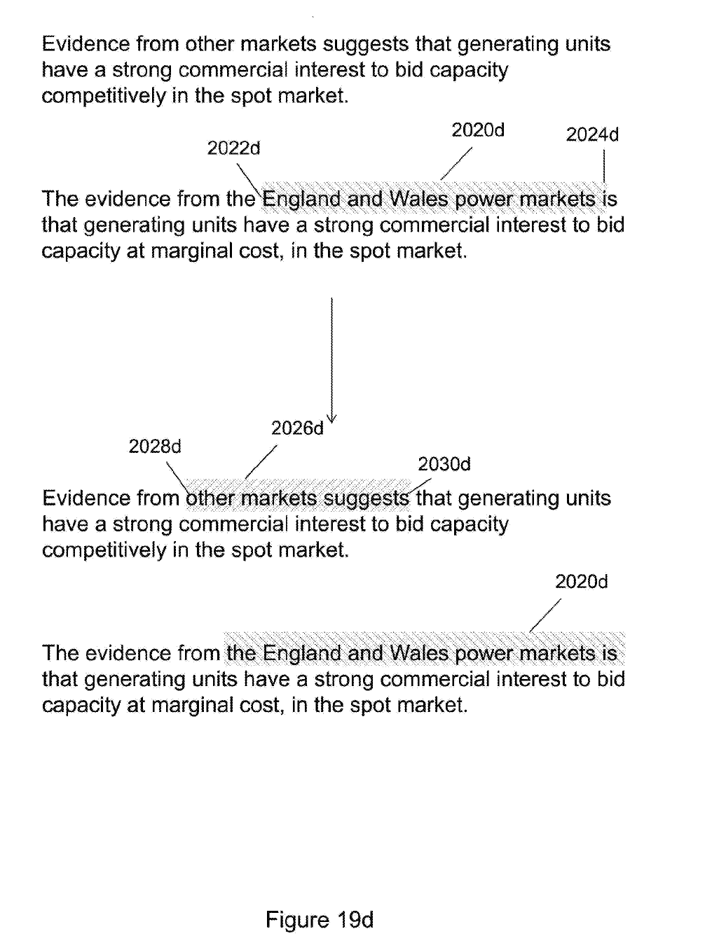

The following describes a method for identifying a corresponding region in one document 2010, according to an embodiment. The method is described with reference to FIG. 19a, and further reference is made to FIGS. 19b to 19d to assist in illustrating the method. The documents 2010 are text-only documents, however it is understood the method is applicable to other document types.

A region (2020 in FIGS. 19b to 19d) in one of the documents 2010 is selected (for the purpose of illustration, the selected region 2020 is in modified document 2010b), at location selection step 2050. The selected region 2020 corresponds to a continuous range of information (in the present example, information corresponds to characters of the text document), and is defined by a first character 2022 and a last character 2024. It is understood that the range (and therefore selected region 2020) can correspond to one character, in which case the same character constitutes the first and last characters 2022, 2024. It is also understood that the selected region may correspond to a “closest” character to a particular position within the modified document 2010b. It can be that the selected region 2020 includes more than one sub-region, and therefore the selected region 2020 can correspond to a non-continuous range of characters. In any case, for the present embodiment, the selected region 2020 is still defined by a first character 2022 and last character 2024.

Next, a lookup step 2051 corresponds to identification of the diff elements of the already created diff associated with each of the first and last characters 2022, 2024. In general, the first character 2022 is associated with either an Eq diff element or a DelIns diff element. Furthermore, the last character 2024 is also associated with either an Eq diff element or a DelIns diff element.

FIG. 19b show a selected region 2020b corresponding to both the first and last characters 2022b, 2024b associated with Eq diff elements, FIG. 19c shows a selected region 2020c corresponding to the first character 2022c associated with an Eq diff element and the last character 2024c associated with a DelIns diff element, and FIG. 19d shows a selected region 2020d corresponding to both the first character 2022d and the last character 2024d associated with a DelIns diff element.

Eq diff elements are directly comparable between the two documents 2010a, 2010b. As shown in FIG. 19b, the first character 2022b (‘f’) and the last character 2024b (‘s’) are each located in an Eq diff element (that is, diff elements 1 and 3 in Table 1, respectively). Therefore, the corresponding first character 2028b and corresponding last character 2030b of the corresponding region 2026b in the original document 2010a can easily be identified by utilising the Pₒ information contained within the diff element. If the selected region 2022b does not begin at the beginning of the string stored in the diff element, it is relatively straightforward to identify the correct first character 2022b in the original document 2010a simply by moving to the same character. As can be seen, it is possible to select the corresponding region 2026b despite the presence of differences within the corresponding region 2026b and selected region 2020b.

Now, referring to FIGS. 19c and 19d, at least one of the first character 2022 and last character 2024 does not correspond to an Eq data element (i.e. corresponds to a DelIns data element). In order to identify a useful corresponding region 2026 in the original document 2010a, it is necessary to identify suitable Eq data elements roughly corresponding to the characters 2022, 2024 that are associated with DelIns data elements. As shown in each of FIGS. 19c and 19d, the selected region 2020c/2020d is “expanded” until a character is encountered corresponding to an Eq data element.

In the example of FIG. 19c, the selected region 2020c comprises the text, “from the England and Wales”, without spaces at the beginning or end of the selected region 2020c. The first character 2022c, “f”, is located in Eq data element 1, and is therefore present in each document 2010a, 2010b. The last character 2024c, “s”, is located in DelIns data element 2. In this case, the selected region 2022c is expanded towards the right (that is, towards the end of the modified document 2010b) until Eq data element 3 (being the next Eq data element) is encountered. Next, the corresponding region 2026 is identified as starting from the “f” of data element 1 and extending until the beginning of Eq data element 3. Therefore, the corresponding region 2026 comprises the text “from other”. In the present embodiment, the corresponding region 2026c ends at the character immediately before Eq data element 3. Also in the present embodiment, the extended selected region 2020c ends at the character immediately before the Eq data element 3.

The process described in reference to FIG. 19c can be generalised as shown in FIG. 19d, where the selected region 2020d comprises the text, “England and Wales power markets i”. The first character 2022d, “E”, is located in DelIns data element 2, and is therefore not present in original document 2010a. The last character 2024d, “i”, is located in DelIns data element 4. In this case, the selected region 2022d is expanded both towards the left (that is, towards the beginning of modified document 2010b) and the right until Eq data elements 1 and 5 are encountered. Next, the corresponding region 2026 is identified as starting from the last character of Eq data element 1, being a space (“ ”), and extending until the beginning of Eq data element 5. Therefore, the corresponding region 2026d comprises the text “other markets suggests”. The corresponding region 2026d begins after the end character of Eq data element 1, and ends before the initial character of Eq data element 5.

Therefore, subsequent to lookup step 2051, a first test 2052 is made to determine whether the first character 2022 corresponds to an Eq or DelIns data element. If the first character 2022 corresponds to an Eq data element, then the corresponding position in the other document 2010 (in the example, original document 2010a) is identified (at step 2053) without expanding the region 2020. If the first character 2022 corresponds to a DelIns data element, then the region is expanded to the left (that is, towards the beginning of the document 2010b) until an Eq data element is encountered, and this position is identified within the original document 2010a (at step 2054).

The process is repeated with the last character 2024. A second test 2055 is made to determine whether the last character 2024 corresponds to an Eq or DelIns data element. If the last character 2024 corresponds to an Eq data element, then the corresponding position in the original document 2010a is identified (at step 2056) without expanding the region 2020. If the second character 2024 corresponds to a DelIns data element, then the region is expanded to the right (that is, towards the end of the document 2010b) until an Eq data element is encountered, and this position is identified within the original document 2010a (at step 2057).

Finally, the corresponding region in the original document 2010a is presented or recorded, or otherwise utilised at step 2058. It is understood that the method applies whether the selected region is in the original document 2010a or modified document 2010b.

The purpose of extending the selected region 2020 is to identify a useful starting point for comparing similar areas of the two documents 2010a, 2010b. That is, when the selected region 2020 begins and/or ends at a character which is not present in the other document 2010a, 2010b, it is necessary to optimally search for a corresponding starting and/or ending point in the other document 2010a, 2010b.

The method illustrated in FIG. 19a with reference to FIGS. 19b to 19d can be utilised to display the corresponding region 2026 graphically. In embodiments, the selected region 2020 is displayed on a display simultaneously with the corresponding region 2026, preferably in a side-by-side arrangement. In an embodiment, if the selected region 2020 is expanded in the process of identifying the corresponding region 2026, the displayed selected region 2020 is changed to reflect the expanded selected region 2020. In an alternative embodiment, the displayed selected region 2020 is not changed. Methods for displaying selected and corresponding regions 2020, 2026 are discussed further below.

### Identifying Data Elements

A method is described for identifying data elements corresponding to particular characters within the documents 2010. The present method can be utilised within the method of FIGS. 19a to 19d.

First, the position P of a selected character (such as the first character 2022 or last character 2024) within the document 2010 it is located is determined (for the purposes of illustrating the method, reference will be made to the first character 2022 of a selected region 2020 within the modified document 2010b). Referring to Table 1 for illustration, the position will either equal one of the Pₒ or Pₘ values (in the present case, the analysis is with respect to Pₘ values though it is understood the same methodology applies where the first character 2022 is located in the original document 2010a, and therefore the analysis is with respect to P), or it will lie between two adjacent values.

A suitable algorithm for determining the corresponding data element to the first character 2022 includes the steps of: (i) in sequential order, comparing the character position to value Pₘ for each data element; (ii) identifying the first data element for which P≦Pₘ; (iii) if P=Pₘ, the correct data element is the identified data element; and (iv) if P<Pₘ, the correct data element is the immediately preceding data element. It is understood that this algorithm is suitable when each value of Pₒ and Pₘ is determined as the position value of the first character in the associated string (Eq) or strings (DelIns). Other embodiments may utilise difference values of Pₒ and Pₘ, which therefore require corresponding alterations to the described algorithm.

As can be seen, the algorithm requires each data element preceding the correct data element to be tested. In an embodiment, the speed of the algorithm is improved through utilisation of a data structure that, given a position in the original document or a position in the modified document, enables efficient navigation to the corresponding position in the diff. Suitable choices for such a data structure include (i) a skip list or (ii) a binary search tree, or (iii) a linked list together with a separate table mapping from character positions in the original document or the modified document to pointers into the linked list. The one subtlety of implementing such a data structure as a linked list or binary search tree is that the search key is simultaneously an index on positions in the original document and in the modified document. In the example text of FIGS. 19b to 19d, it is not immediately apparent that the identification of the corresponding region 2026 may be computationally slow, as the text string is relatively small. Commonly, however, compared text can be extensive, with a large number of data elements comprising the diff. We describe an embodiment which uses a skip list. A skip list affords for improved performance which beneficially reduces or eliminates a user's perceived delay between executing a comparison, and being provided with a result (that is, a corresponding region 2026).

The data structure of Table 1 is modified, thereby creating a modified data structure, represented schematically in FIG. 20. Each data element continues to comprise Pₒ and Pₘ, which herein is referred to as a “primary pair”, and is represented as A_{i,0}. In addition, each data element can include one or more further secondary pairs A_{i,j}. Subscript “j” refers to the pair number for a particular data element “i”. As is clear, “j” must take on a value greater than or equal to 1, as j=0 corresponds to the primary pair for a particular data element “i”.

Each data element includes a primary pair with probability 1, that is, each data element includes a value for Pₒ and Pₘ. Each data element then includes no, or one or more, secondary pairs, with reducing probability. In the present embodiment, a single probability is selected (for the purposes of example, 0.5 is chosen). Then, a test is made for a particular data element against the selected probability (for example, a successful test is where a randomly, or pseudo-randomly, generated number between 0 and 1 is less than 0.5, and an unsuccessful test is where the number is greater than or equal to 0.5). If the test is successful, a further test is performed. The tests continue until an unsuccessful test results. The number of successful test is equal to the number of secondary pairs associated with the data element.

Based on the above description, the probability of a particular data element having only a primary pair is 50%, one primary and one secondary pair is 25%, one primary and two secondary is 12.5%, etc. The resulting structure is represented in FIG. 20, as a number of “levels”. The bottom level (level 0) is the “trivial” level, for which there exists an entry for each data element. Each entry in the bottom level comprises Pₒ and Pₘ of the corresponding data element, and either implicitly or explicitly a pointer to the next data element (implicit means that no data in this respect is stored, however it is known the next entry is the immediate entry to the right).

The next level (level 1) corresponds to secondary pairs with j=1, as discussed above. The entries at this level correspond to data elements with at least one successful “test”. An entry at this level will comprise the value of Pₒ and Pₘ of the next level 1 entry (being the entry to the right in FIG. 20), as well as implicit or preferably explicit information identifying the next data element with a level 1 entry.

Similarly, the next level (level 2) corresponds to secondary pairs with j=2, as discussed above. The entries at this level correspond to data elements with at least two successful “tests”. An entry at this level will comprise the value of Pₒ and Pₘ of the next level 2 entry (being the entry to the right in FIG. 20), as well as implicit or preferably explicit information identifying the next data element with a level 2 entry.

In the present example, there are four levels in total including the trivial level. In theory, there can be any number of levels, with the highest level corresponding to the data element (or elements) with the largest number of successful “tests”. In an embodiment, the maximum level is capped at a predetermined maximum. As can be seen, at least the first data element has a number of levels equal to the maximum number of levels, that is, the first data element does not undergo the “tests” applied to the other data elements. Also, the right-most (last) entry for each level refers to the last data element.

In practice, in order to determine a data element corresponding to an arbitrary character position P, the value for Pₘ (or for Pₒ) of the “top” entry of the first data element is compared to P. If P is greater than or equal to Pₘ, then P is compared to the next data element with an entry at the same level (this is referred to as “moving along” a level). If P is less than the value of Pₘ (which represents the value of Pₘ of the next data element with an entry at the same level), then P is next compared to the value of Pₘ associated with the current data element at the next level down (referred to as “moving down” a level). Again, if P is greater than or equal to Pₘ, then P is compared to the next data element with an entry at the same level. If P is less than the value of Pₘ, then P is next compared to the value of Pₘ associated with the current data element at the next level down.

Eventually, P will be compared to Pₘ values of the trivial level, at which point the previously described algorithm is employed. By only moving along or down levels, the overall effect is to relatively quickly move to a position close to the correct position within the data structure, before identifying the correct data element.

As will be understood, different values of probability may be utilised depending on desired search speed. Further, it is not necessary that the probability decrease in a geometric fashion.

To select and/or display a comparison, a first document 2010a is shown displayed on a graphical user interface (GUI), such as a computer display, mobile phone display, or tablet display. The first document 2010a comprises text, a portion or all of which is displayed on the display at any one time. The user then selects, for example through utilisation of a user interface device such as a mouse, to compare the first document 2010a to a second document 2010b. In one embodiment, the user selects a region of the first document 2010a with particular starting and ending characters. In other embodiments, the user clicks on a single location within the first document 2010a and a region (for example, a sentence, a paragraph, or a clause within a legal contract) is selected automatically. In an embodiment, selecting a region of the first document 2010a provides an input instructing the processor to determine a corresponding position within the second document 2010b, and to subsequently display said position. A wide variety of different techniques for displaying the comparison of the first document 2010a and the second document 2010b are envisioned. According to one technique, the first document 2010a is removed from display (for example, the first document 2010a may be closed or minimised), and the second document 2010b displayed at the corresponding position. Another technique results in a side by side comparison of the two documents 2010a, 2010b. According to yet another technique, only a portion of the second document 2010b is displayed in a “pop-out” manner next to the first document 2010a.

In each case, it is preferable to indicate to the user the corresponding region in the second document 2010b to that selected by the user in the first document 2010a. There are well known display techniques for achieving this result, for example: the corresponding region in the second document may be highlighted; the particular text coloured; a border placed around the region; the non-selected text is greyed; or any other suitable technique. When a “pop-out” display technique is used, the corresponding region may be solely displayed in the pop-out, or centred within the pop-out with further information located to one or both sides of the corresponding region 2026.

The region displayed in the second document can simply be the corresponding region 2026 identified through utilisation of the method of FIGS. 19a to 19d. Alternatively, the corresponding region 2026 may be expanded to include a predetermined section of text—for example, one or more entire sentence or paragraphs. Alternatively, the corresponding region in the second document 2010b can be displayed in place of the corresponding region of the first document 2010a, using a display technique such as highlighting to distinguish it from the remainder of the first document 2010a. In a preferred embodiment, there exist more than two documents 2010, for example the six documents shown in FIG. 3. For the present example, document 2010a is the original document, document 2010b an edit to document 2010a, and each subsequent document 2010 (identified alphabetically by subscript) corresponds to an edit of the immediately preceding document. Adjacent documents 2010 are two documents 2010 where one is a direct edit of the other.

A diff as described herein is created or provided for each adjacent pair of documents 2010. In an embodiment, the latest document 2010f is displayed in an editor, such as Microsoft Word, and another document 2010e is the most recently saved version of the document 2010. As the document 2010f is edited, a diff 2070ef between documents 2010e and 2010f is maintained by detecting and recording characters being inserted and deleted within the document 2070f. Each diff accurately allows for changes between its associated documents to be identified, and through use of position information, allows for a corresponding region 2026 in one document 2010 to be identified based on a selected region 2020 in the other document 2010. According to the present embodiment, it is desirable to identify a corresponding region 2026 in a document 2010 non-adjacent to the document 2010 including the selected region 2020. Trivially, it is possible to simply create a further diff between these non-adjacent documents 2010. However, it has been found such a process can require an amount of time noticeable to a user. Therefore, the present embodiment utilises the existing diffs between adjacent documents 2010 to provide quick and useful means for identifying the corresponding region 2026 in the non-adjacent document 2010.

A “chain” 2099 or sequence of documents 2010 is then determined which “link” the two non-adjacent documents 2010. The chain 2099 comprises at least one intermediate document 2010. A diff exists between each document 2010 in the chain, linking the two non-adjacent documents. The present embodiment will be described in terms of documents 2010a, 2010b, and 2010c, with document 2010b being the sole intermediate document. The selected region 2020 is contained within document 2010c, and the corresponding region 2026 is to be located in document 2010a. Preferably, the chain comprises a minimum number of documents 2010 necessary to link the two non-adjacent documents 2010.

Starting at the document 2010c having the selected region 2020, an intermediate corresponding region is determined within the adjacent intermediate document 2010b. Where there is more than one intermediate document 2010, this process continues down the chain until the last intermediate document 2010, with the intermediate corresponding region determined for one intermediate document 2010 used as an intermediate selected region for the next adjacent document 2010. Finally, once the intermediate corresponding region is determined for the document 2010b adjacent to the desired document 2010a, this is used as the selected region for determining the required corresponding region.

The end result of the method is a selected region 2020 and an identified corresponding region 2026 in a non-adjacent document 2010. The benefit of the method is that existing adjacent document 2010 diffs can be utilised, thereby minimising the time and data required to identify corresponding regions in non-adjacent documents.

### Creating Diffs Between Documents

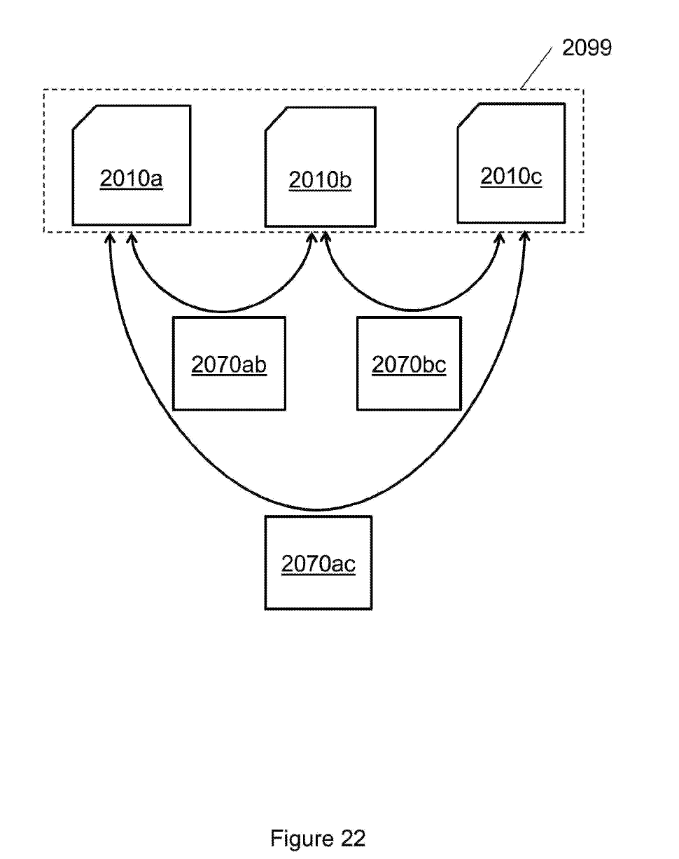

In an embodiment, a method is provided to determine a diff between two documents 2010 based on existing diffs between those documents 2010 and other documents 2010. Referring to FIG. 22, an example is shown where diffs 2070 exist between adjacent documents 2010, and it is desired to determine a diff between two non-adjacent documents 2010. For the purposes of illustration, the creation of a diff between documents 2010a and 2010c will be described, utilising diffs 2070ab (the duff between documents 2010a and 2010b) and 2070bc (the diff between documents 2010b and 2010c). In the particular embodiment described, the diffs can correspond to prior art diffs or the modified diffs herein described.

In one embodiment, the diff 2070ab is a diff between the whole of documents 2010a and 2010b and the diff 2070bc is a diff between the whole of document 2010b and 2010c. In another embodiment, we only obtain a diff on parts of documents 2010a and 2010c: in this case, a region 2020 of document 2010c may be selected by the user and we only create the diff 2070bc to the extent necessary to (i) identity the corresponding region 2026 in document 2010a and (ii) identify the diff 2070ac between the selected region 2020 of documents 2010c and the corresponding region 2026 of document 2010a. Note, as before, that this may require expanding the selected region 2020 in document 2010c. In large documents this can give a speed-up because the amount of computation required depends on the size of the selected region rather than the size of the documents. In an embodiment, it is advantageous to use the skip list data structure described above to identify the relevant part of the diff 2070ab and the relevant part of the diff 2070bc.

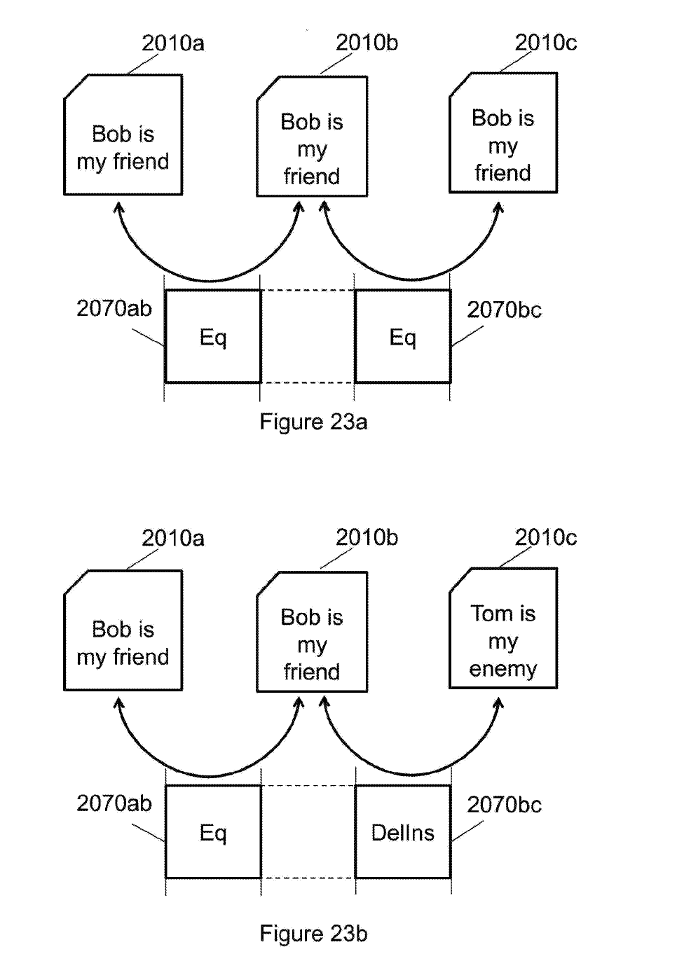

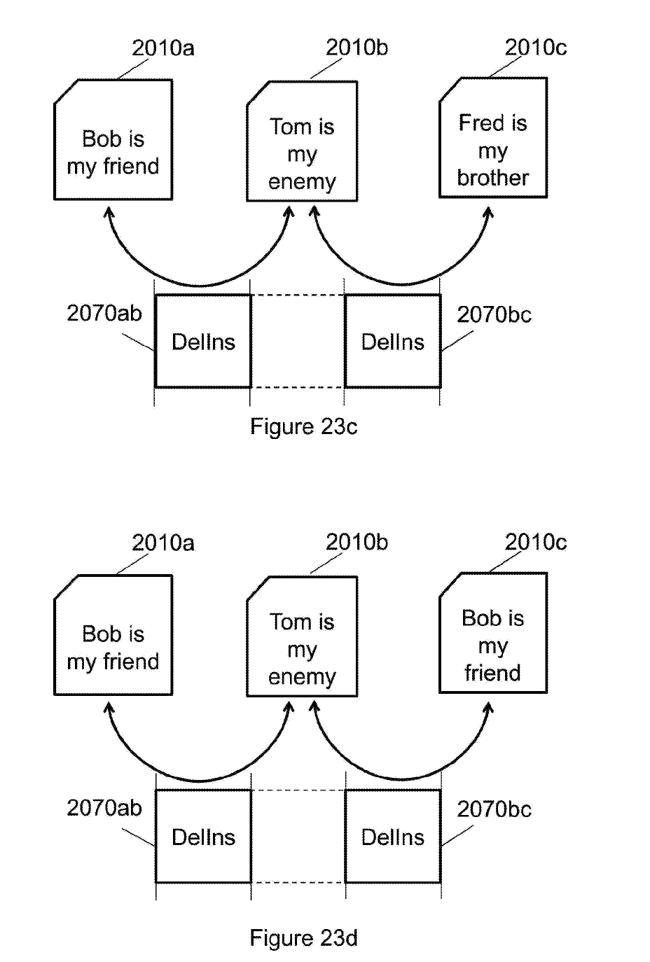

Each of the diffs 2070ab and 2070bc consist of alternating Eq data elements and DelIns data elements. Referring to FIG. 23a, the case is shown where an Eq data element in diff 2070ab and an Eq data element in diff 2070bc correspond to the same text. In this situation, the resulting diff will have a corresponding Eq data element comprising the same information.

Referring to FIG. 23b, the case is shown where the data element of one diff (in the example, diff 2070ab) is an Eq data element, and the corresponding data element in the other diff 2070bc is a DelIns data element. This corresponds to no change in this region from document 2010a to 2010b, followed by a deletion and/or insertion when moving from document 2010b to 2010c. In this case, the resulting corresponding data element in the resulting diff is a DelIns data element showing the change from 2010b to 2010c (which is true for 2010a to 2010c). It is noted that the Eq and DelIns data elements could be reversed, that is, the Eq data element is located in diff 2070bc and the DelIns data element is located in diff 2070ab.

Finally, referring to FIG. 23c, the case is shown where both data elements are DelIns data elements. This corresponds to a deletion and/or insertion to document 2010a when creating document 2010b, and another deletion and/or insertion when creating document 2010c. In an embodiment, the corresponding data element in the diff 2070ac is a DelIns data element comprising the deleted text from document 2010a and the inserted text from document 2010c. It may, however, be the case that the DelIns in diff 2070bc is in whole or in part the reverse of the DelIns 2070ab. This corresponds to a user “undoing” the change from document 2010a to 2010b. This is illustrated in FIG. 23d. Therefore, in another embodiment, it is preferable to run a diffing algorithm solely on regions corresponding to two DelIns. Because the diffing algorithm is only run on a region of each of the two documents 2010, it can be much faster than running it on the whole documents 2010a and 2010c.

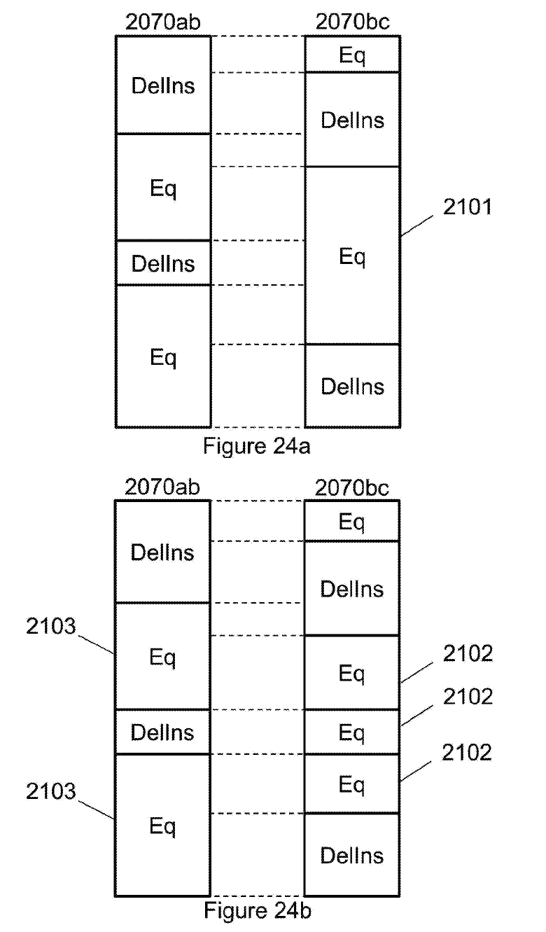

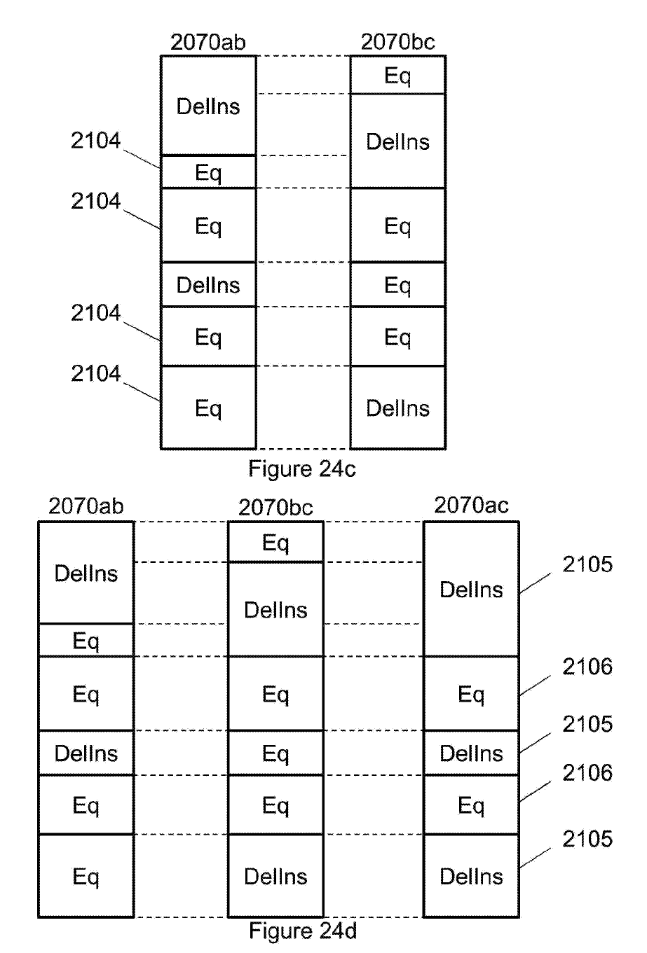

The above examples assume that there is an exact correspondence between the data elements of the two diffs 2070ab and 2070bc. It commonly occurs that the data elements of the two existing diffs 2070ab, 2070bc do not align, in which case the existing data elements must be modified in order to provide for alignment. Referring to FIGS. 24a, 24b, 24c and 24d, this is achieved by splitting existing Eq data elements into portions such that there are perfectly aligning elements in each diff 2070ab, 2070bc. Note here that we do not require that Eq and DelIns regions alternate in the diff: we may have multiple consecutive Eq regions in the diff 2070ab if this is necessary for each region to align either with an Eq or a DelIns in diff 2070bc.

In general, there will be one or more intermediate documents, corresponding to those documents 2010 involved with determining the required diff, that are not part of the required diff. In the present illustration, there is one intermediate document 2010b. It is necessary to ensure that the data elements of diff 2070ab and 2070bc are such that the same text ranges are present for the “b” component of each diff. For diff 2070ab, this is the Pₘ component. For diff 2070bc, this is the Pₒ component.

Referring to FIG. 24a, let Pₘ(1), Pₘ(2), . . . , Pₘ(kₘ) be the positions in document 2010b where the diff 2070ab transitions between data elements. Note that kₘ is the total number of transitions. The diff 2070bc is modified in the following way: for k=1, 2, . . . , kₘ, if Pₘ(k) is inside an Eq data element 2101, that Eq data element is split at Pₘ(k) into two Eq data elements 2102. If Pₘ(k) is inside a DelIns element, then nothing is done. The resulting diff 2070bc is illustrated in FIG. 24b. Similarly, let Pₒ(1), Pₒ(2), . . . , Pₒ(kₒ) be the positions in document 2010b where the diff 2070bc transitions between blocks. Note that kₒ is the total number of transitions. The diff 2070ab is modified in the following way: for k=1, 2, . . . , kₒ, if Pₒ(k) is inside an Eq data element 2103, that Eq data element is split at Pₒ(k) into two Eq data elements 2104. If Pₒ(k) is inside a DelIns element, then nothing is done. The resulting diff 2070ab is illustrated in FIG. 24c. After the procedure illustrated in FIG. 24c is performed, each Eq data element in the diff 2070ab either (i) aligns exactly with an Eq data element in the diff 2070bc, or (ii) aligns with portion of a DelIns data element in the diff 2070bc.

Referring to FIG. 24d, the diff 2070ac can now be constructed. It comprises Eq blocks where both diff 2070ab and diff 2070bc have Eq blocks 2106. In the remaining regions, where at least one of diff 2070ab and diff 2070bc have a DelIns block, it comprises DelIns data elements 2105. Depending on the embodiment, there are potentially further portions of documents 2010a and 2010c which should be recorded as Eq.

In an embodiment, the content of the DelIns data elements in the diff 2070ac are diffed and the resulting diff structure is incorporated into the new diff.

The new diff created according to this method may not be optimally minimal. This means that the new diff may represent some identical text portions as changes. However, the resulting new diff will in general be sufficiently minimal to be useful, while being created much quicker than simply diffing the documents 2010a and 2010c. Furthermore, if the goal of the diff is to indicate what changes were actually made to document 2010a to create document 2010c, the new diff may be superior to an optimally minimal diff because it makes use of the intermediate document 2010b which comprises changes that were actually made in creating document 2010e from document 2010a.

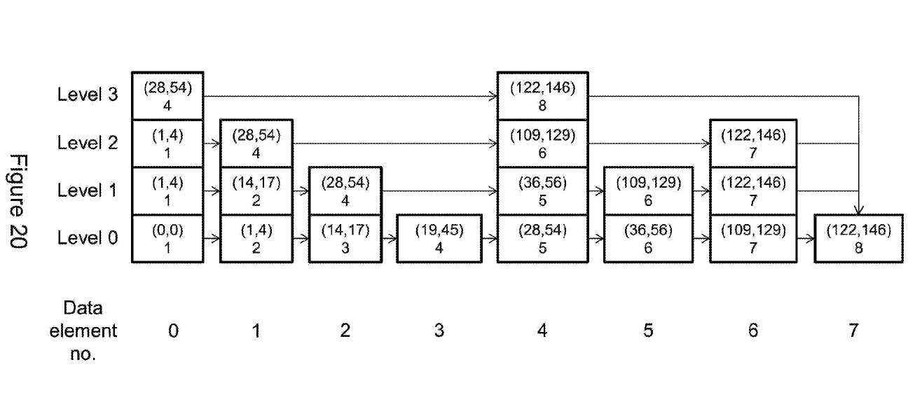

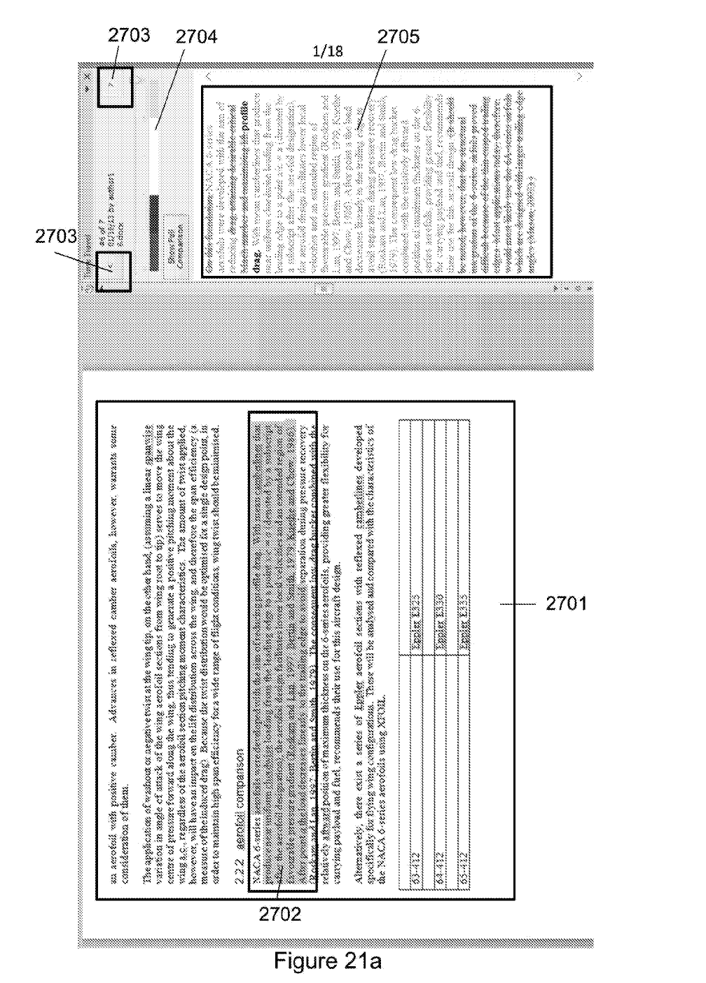

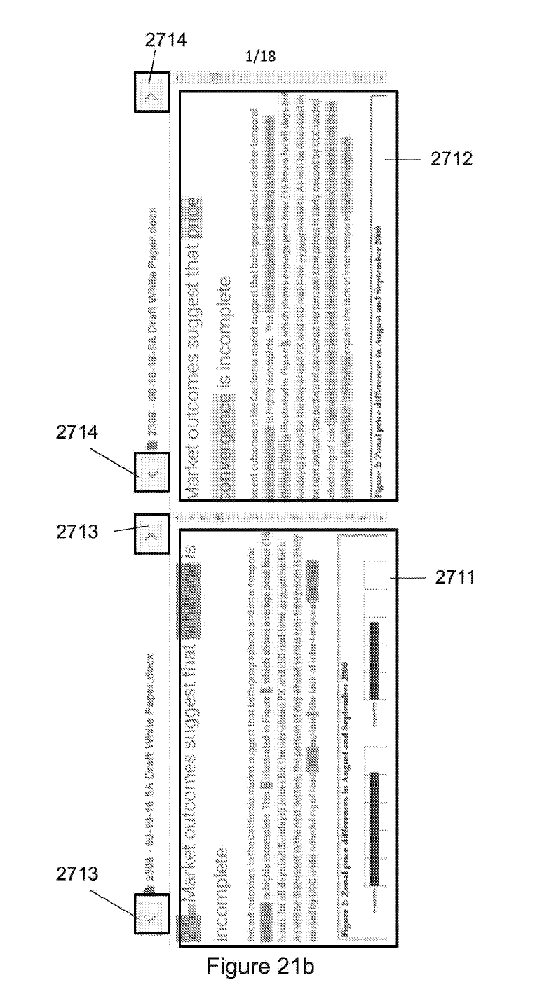

FIG. 21a illustrates the GUI of a preferred embodiment. A portion of the first document 2010a is shown at 2701. The user has selected a selected region 2020a shown at 2702. There are provided GUI controls 2703 to enable the user to select a second document 2010, which, in some embodiments, may be a document 2010 in the same document family 3012 or structured document family 3014 as the first document. A diff is created or provided for each adjacent pair of documents 2010. A graphical representation 2704 of the number of changes introduced by each document 2010 is provided: in this embodiment, darker intensities of colour represent a greater amount of change. In an embodiment, the number of characters in the diff between adjacent documents 2010 is an indication of the number of changes. The graphical representation 2704 may be computed based on diffs of whole documents 2010 or it may be computed based on diffs just of the selected region 2020a and corresponding regions 2026 in each of the documents 2010 in the document family 3012 or structured document family 3014. In the illustrated embodiment, the diff of the selected region 2020a of the first document 2010a with the corresponding region 2026 of the second document 2010 is shown at 2705. In other embodiments, the diff of the second document 2010 with an adjacent document 2010 is displayed.

FIG. 21b illustrates the GUI for another preferred embodiment. A portion or all of a first document 2010a (shown at 2711) is displayed side-by-side with a portion or all of a second document 2010b (shown at 2712). There are provided GUI controls 2713 to select which document 2010 is the first document 2010a and also GUI controls 2714 to select which document 2010 is the second document 2010b. In embodiments, the documents may be selected from a document family 3012 or structured document family 3014. As the user changes which first document 2010a and which second document 2010b is selected, a diff between the first document 2010a and the second document 2010b is generated by the methods described above.

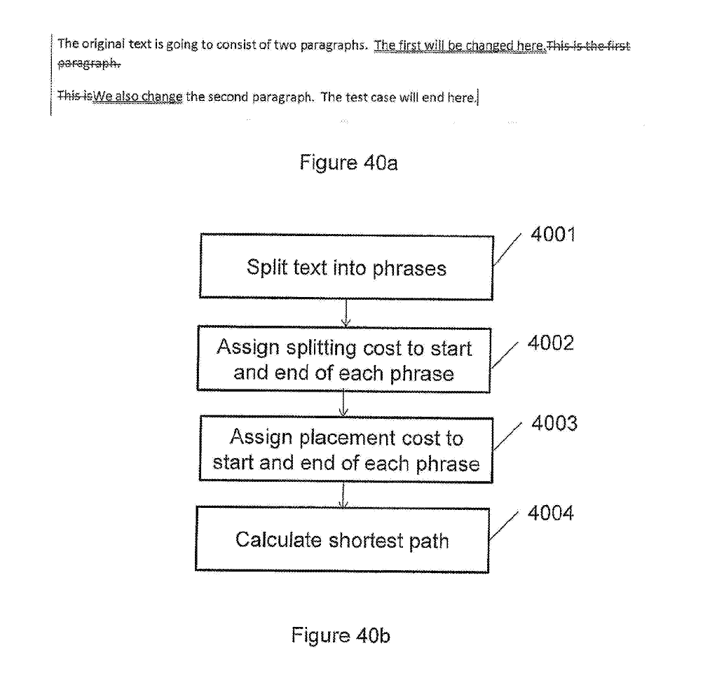

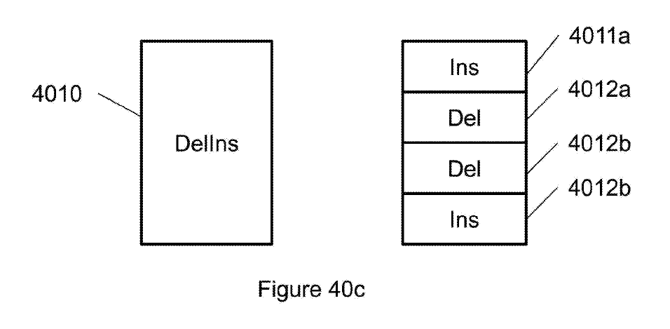

Referring again to FIGS. 14a and 14b, which illustrate a diff algorithm. In an embodiment, after a diff has been prepared, it is desirable to prepare a combined document that comprises the original document and the modified document and indicates what changed between them, for example using the Track Changes mark-up of OOXML. The result of the diff algorithm illustrated in FIG. 14a is a sequence of Eq and DelIns data elements. FIG. 40c illustrates a DelIns data element 4010. In order to display the edits in a single document, the DelIns data element 4010 should preferably be separated into separate Del 4011 and Ins 4012 data elements, to indicate the order in which the deleted and inserted text should appear in the combined document. One simple technique would be to always place any deleted text before any inserted text, but this technique may generate changes that look wrong (to a typical user), especially if the DelIns data element spans multiple sentences or paragraphs. In FIG. 40a we show an example with a single DelIns data element 4010 where it would be undesirable to show all the deleted text before all the inserted text because the changes span two paragraphs.

Therefore it is desirable to have a way to split a DelIns data element 4010 into Del 4011 and Ins 4012 data elements. An algorithm for this is illustrated in FIG. 40b.

First the deleted text in the DelIns data element 4010 and inserted text in the DelIns data element are separately split into “phrases” at step 4001. It is understood that the term “phrases” is used in a generic sense, and phrases have the property that it is undesirable to split text within a phrase. In an embodiment, text is split after newlines, periods, commas, exclamation marks, and quotation marks. Next, at step 4002, a splitting cost is assigned to the start of each phrase that captures the cost of splitting the start from other text. Similarly, a splitting cost is assigned to the end of each phrase that captures the cost of splitting the end from other text. This is achieved by inspecting the first few characters and last few characters of the phrase. Essentially, if a phrase begins with a space, then we assign a high cost to separating it from related text before it. If a phrase begins with a capital letter (i.e. it's probably the start of a sentence) we don't care as much if it's separated from the text before it, and so we assign a low cost to splitting at the start. Similarly, if a phrase ends with a period or a newline then it's a low cost to break up the region of text there, but if it ends with a letter or a space then we assign high cost because we want to encourage it to continue a sentence. In an embodiment, ‘2’ is a high cost (e.g. ends with a few newlines), ‘0’ is low (e.g. starts with a space), and ‘0.5’ is moderate (e.g. ends with a comma).

Next we assign placement costs to the start and end of each phrase, at step 4003. Given a particular ordering of the deleted and inserted phrases, the placement cost of the start of the phrase depends on the phrases that come before it in the ordering. The idea is that is it preferable if deleted text that was near the start in the original document is also near the start of the combined document. In an embodiment, the placement cost of the start of a deleted phrase is the absolute value of the difference between (i) a distance from the starting position of the DelIns data element 4010 to the start of the deleted phrase in the original document, and (ii) a distance from the start of the DelIns data element 4010 to the start of the deleted phrase in the combined document. The distance might simply be the number of characters, but or the distance might depend on the types of characters in the way (e.g. a paragraph break will confer greater distance than a space). A similar approach is used to assign a placement cost to the end of each phrase.

We represent the phrases as nodes on a graph and the costs as edges. Each node consists of a triplet (bool insertingOrDeleting, int currentInsertion, int currentDeletion). In an embodiment, the total cost on an edge is the sum of (i) the splitting costs which are incurred when splitting a phrase from its adjacent phrase, (ii) a swapping cost, which is incurred when switching from a deleted phrase to an inserted phrase, and (iii) the placement costs which are incurred when the phrases are placed in that position. Then at step 4004, we find the shortest path through the graph, which can be done using dynamic programming. The shortest path in the graph will be the minimum cost arrangement of deleted phrases and inserted phrases. Finally, we combine adjacent deleted phrases into a Del data element 4011 and adjacent inserted phrases into an Ins data element 4012.

We refer again to FIG. 14a, which illustrates a diffing algorithm. We describe an alternative way of obtaining a global alignment of document 2010a and document 2010b. We compute the k longest common substrings of the text of document 2010a and the text of document 2010b. A suitable value of k is 20. This computation can be performed efficiently using a variety of data structures, including a suffix tree, a suffix array together with associated arrays such as the longest common prefix (LCP) array, or an FM-index. We compute a first diff under the assumption that the only matching regions in the documents 2010a and 2010b are these k longest common substrings. This computation can be formulated as a dynamic program on the distances from the start of the simplified diff to the start of each of the k edges in a straightforward way. In an embodiment, the distance is defined by a cost function where we charge 1 for an inserted or deleted character and charge 0 for a matching character. Any matching regions in the simplified diff will be matching regions in the final diff.

In an embodiment, we then repeat the algorithm on the remaining non-matching regions, and continue in a hierarchical manner. It should be understood that we can also mix-and-match this procedure with that illustrated in FIG. 14a or with other procedures, using this technique just at some of the levels of a hierarchical diff algorithm.

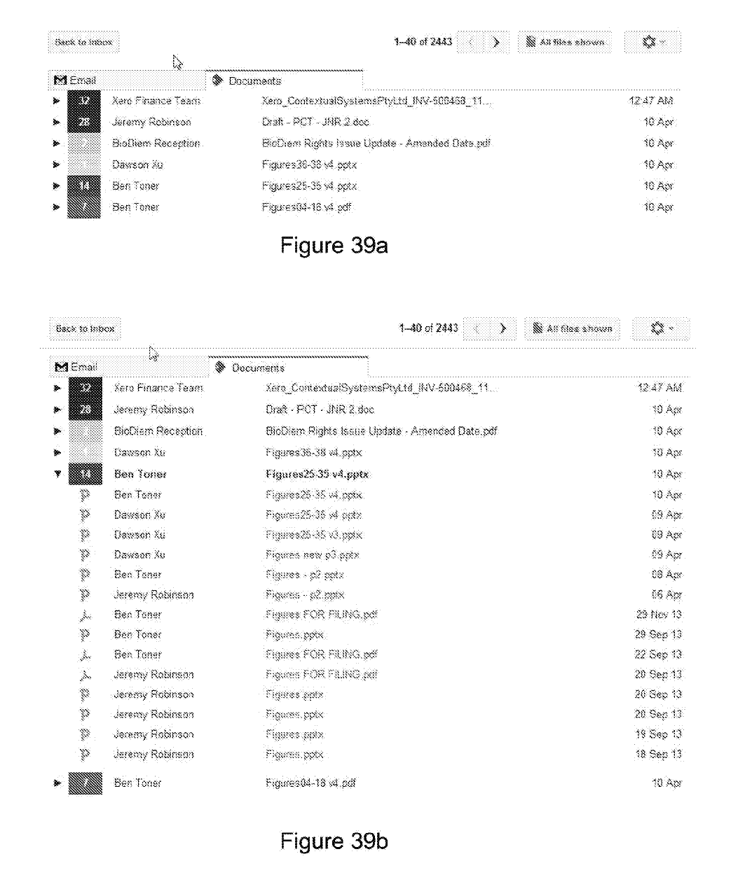

FIGS. 39a and 39b show a graphical user interface suitable for displaying document families. FIG. 39a shows a list of document families. FIG. 39b shows a particular document family having being selected.

1. A method for placing a document into a document family, the method including the steps of:
determining at least one score associated with one or more document families, each score indicating a level of similarity between the document and the associated document family;
in response to identifying at least one threshold document family, the or each threshold document family corresponding to a document family with at least one associated score meeting a predefined threshold:
placing the document into the, or one of the, threshold document families;
in response to identifying that each score fails to meet a predefined threshold:
creating a new document family; and
placing the document into the new document family.

2. A method as claimed in claim 1, wherein in response to identifying two or more threshold document families, determining a highest scoring threshold document family, and placing the document into the highest scoring document family.

3. A method as claimed in claim 1, wherein, for each document family, a document score is determined for each document already placed within the document family.

4. A method as claimed in claim 1, wherein a family score is determined for each document family.

5. A method as claimed in claim 1, wherein each score is calculated based on a comparison between a plurality of predefined properties.

6. A method as claimed in claim 5, wherein, for each score, the plurality of predefined properties are weighted based on predefined weightings and combined to determine the score.

7. A method as claimed in claim 6, wherein the predefined weightings are determined by a machine learning algorithm.

8. A method as claimed in claim 1, wherein there are two or more scores associated with each document family, and a final score for each document family is determined by aggregating the associated scores.

9. A method as claimed in claim 1, wherein the, or each, document family is a structured document family, and including the further steps of:
when placing the document into a threshold document family, identifying an existing document within the threshold document family, or a merger of two or more existing documents within the threshold document family, as being a closest match to the document; and
attaching the document to the closest match.

10. A method as claimed in claim 9, wherein a merger is modelled as a virtual document including content from each of the two or more existing documents associated with the merger.

11. A method as claimed in claim 9, wherein each existing document associated with a merger is not an ancestor of any of the other existing documents associated with the merger.

12. A method as claimed in claim 9, wherein the closest match is a merger of two or more documents.

13. A method as claimed in claim 9, wherein the closest match is an existing document.

14. A method as claimed in claim 1, including the step of determining an index for each document, and wherein a comparison between two documents is at least a comparison between the associated indexes of the documents.

15. A method as claimed in claim 14, wherein each index corresponds to a signature of the associated document.

16. A method for placing a plurality of documents into one or more structured document families, including the steps of:
placing a first document of the plurality of documents into a first structured document family;
for each remaining document, using the method of claim 1 to place the document into a structured document family.

17. A method as claimed in claim 16, including the step of in response to each document being attached to a corresponding closest match, removing one or more common documents from the one or more structured document families.

18. A method as claimed in claim 16, including the step of chronologically ordering the plurality of documents, and placing the documents in chronological order.

19. A method as claimed in claim 14, wherein each index corresponds to a signature of the associated document.

20. A method for adding newly created documents to a document family, including the steps of:
maintaining a watch for newly created or newly edited documents; and
in response to identifying a newly created or newly edited document, placing the document into a document family utilising the method of claim 1.

21. A method as claimed in claim 20, including the step of storing a copy of the newly created or newly edited document in a document database, wherein the document database includes copies of each document within the document family or structured document family.

22. A method as claimed in claim 20, wherein the watch corresponds to reviewing incoming and outgoing emails of a user, and wherein the newly created or newly edited documents correspond to attachments of said emails.

23. A method as claimed in claim 1, including the step of maintaining a family database, wherein the family database is configured for storing records associated with each document family or structured document family, said records including identifying information corresponding to each document within the associated document family or structured document family.

24. A method as claimed in claim 23, including the step of providing a processing server, said processing server including a processor and a memory, said processing server configured for maintaining the family database.

25. A method for placing a document into one of a plurality of document families, the method including the steps of:
determining at least one score associated with each document family, each score indicating a level of similarity between the document and the associated document family;
identifying at least one threshold document family, the or each threshold document family corresponding to a document family with at least one associated score meeting a predefined threshold; and
placing the document into the, or one of the, threshold document families.

26. A method for placing a document into a new document family, the method including the steps of:
determining at least one score associated with one or more document families, each score indicating a level of similarity between the document and the associated document family;
identifying that each score fails to meet a predefined threshold;
creating a new document family; and
placing the document into the new document family.

27. A processing server including:
a processor;
at least one memory device operatively associated with the processor;
interfacing means for communicating with one or more client devices, configured for receiving a document,
wherein the memory device further includes instructions which, when executed by the processor, implements the method of claim 1.

28. A processing server, including:
a processor;
at least one memory device operatively associated with the processor, and including a family database; and
interfacing means for communicating with one or more client devices,
wherein the memory includes instructions which, when executed by the processor, implements the method of:
maintaining the family database, said family database including records associated with one or more document families, each record including identifying information identifying one or more documents of the associated document family;
receiving, via the interfacing means, a document;
determining at least one score associated with one or more document families, each score indicating a level of similarity between the document and the associated document family;
in response to identifying at least one threshold document family, the or each threshold document family corresponding to a document family with at least one associated score meeting a predefined threshold:
placing the document into the, or one of the, threshold document families;
in response to identifying that each score fails to meet a predefined threshold:
creating a new document family; and
placing the document into the new document family.

29. A processing server according claim 28, wherein the processing server shares its memory and processor with a client device.

30. A processing server according to claim 28, wherein the processing server is in network communication with one or more client devices.

31. A processing server, including:
a processor;
at least one memory device operatively associated with the processor, and including a family database for storing records associated with one or more document families, each record including identifying information identifying one or more documents of the associated document family; and
interfacing means for communicating with one or more client devices,
wherein the memory includes instructions which, when executed by the processor, implements the method of:
receiving, via the interfacing means, a plurality of documents;
providing an initial document;
attaching one of the plurality of documents to the initial document;
for each remaining document:
identifying one of the initial document, a previously attached document, or a merger of two or more previously attached documents, as being the closest match to the document; and
attaching the document to the closest match,
in response to all of the documents being attached to a corresponding closest match, removing the initial document,
storing within the family database the one or more resulting structured document families.

32. A method for presenting changes between a base document and a latest document, wherein there is one or more intermediate documents, the method including the steps of:
identifying a collection of documents, said collection including the base document, latest document, and the one or more intermediate documents;
identifying the base document;
identifying the latest document;
identifying and creating a chronological sequence, wherein the first document of the sequence is the base document, and the last document of the sequence is the latest document, and the one or more intermediate documents are arranged between said base document and latest document;
identifying changes between adjacent pairs of documents;
creating a changes document including indication of changes made between each pair of documents, wherein the changes are represented in respect of the base document, such that the changes document corresponds in content to the latest document.

33. A method as claimed in claim 32, wherein the indication of changes made is a visual indication.

34. A method for notifying a user of changes between an incoming document and a previous document, wherein the incoming document is a modification of the previous document, and wherein the incoming document includes:
one or more first modified regions, corresponding to modifications of the previous document, wherein the one or more first modified regions are marked as modified; and
one or more second modified regions, corresponding to modifications of the previous document, wherein the one or more first modified regions are not marked as modified,
the method including the steps of:
comparing the incoming document to the previous document to identify changes made between the documents;
identifying the presence of the one or more second modified regions
notifying the user of the presence of the one or more second modified regions.

35. A method as claimed in claim 34, wherein the user is notified at least due to an alert being presented to the user.

36. A method as claimed in claim 34, wherein the user is notified at least due to the one or more second regions being visually indicated as corresponding to modified regions.

37. A method as claimed in claim 34, including the step of maintaining a watch for a document accessed by the user, wherein such accessed document corresponds to the incoming document.

38. A method as claimed in claim 34, wherein the previous document is an immediately preceding document.

39. A method as claimed in claim 34, wherein both the previous document and incoming document include one or more third regions, said third regions corresponding to regions marked as modified in both documents, and including the steps of:
treating the, or each, third region as an unmodified region.

40. A processing server including:
a processor; and
at least one memory device operatively associated with the processor,
wherein the memory includes instructions which, when executed by the processor, implements the method claim 34.
